(19) United States
(12) Patent Application Publication
(10) Pub. No.: US 2026/0369167 A1
(43) Pub. Date: Nov. 19, 2026

(54) METHOD, APPARATUS, AND SYSTEM OF PROVIDING A BEHAVIORAL DECISION WARNING

(71) Applicant: HERE Global B.V., Eindhoven (NL)

(72) Inventors: Grzegorz KOLARZ, Berlin (DE); Vinay KUMAR, Thane (IN); Bénédicte PIGNOL, Berlin (DE); Eric THEISINGER, Berlin (DE); Suhail ZAHOOR KOUL, Jammu & Kashmir (IN); Kaustubh NERURKAR, Mumbai (IN); Sudeesh MENON, Mumbai (IN); Raaj AHUJA, Mumbai (IN); Rakhee SABOO, Mumbai (IN)

(21) Appl. No.: 19/662,743

(22) Filed: Apr. 29, 2026

Related U.S. Application Data
(60) Provisional application No. 63/797,640, filed on Apr. 30, 2025.

(51) Int. Cl. G08G 1/16; G08G 1/01; G08G 1/052; G08G 1/0967

(52) U.S. Cl. CPC G08G 1/164; G08G 1/0116; G08G 1/0133; G08G 1/0145; G08G 1/052; G08G 1/096725; G08G 1/166

(57) ABSTRACT

An approach is provided for driving behavioral discrepancy warning. The approach, for instance, involves determining, for a given area, behavioral data representing aggregated driving behavior in the given area. The approach also involves determining, for the given area, map data comprising one or more map objects and one or more driving constraints, permissions, conditions, or requirements associated with the one or more map objects. The approach further involves detecting, based on a comparison between the behavioral data and the map data, a behavior discrepancy between the aggregated driving behavior and the one or more driving constraints, permissions, conditions, or requirements. The approach further involves generating a behavior discrepancy warning indicating the detected behavior discrepancy.

### RELATED APPLICATION

This application claims the benefit of priority to U.S. Provisional Patent Application No. 63/797,640, “METHOD, APPARATUS, AND SYSTEM OF PROVIDING A BEHAVIORAL DECISION WARNING,” filed Apr. 30, 2025, the contents of which is incorporated by reference herein in its entirety.

### BACKGROUND

As vehicles gain more autonomous capabilities (e.g., highly assisted driving, fully or partially autonomous driving, etc.), service providers face significant technical challenges with respect to implementing these capabilities in a more “humanized” manner. For example, humanized driving in the context of autonomous or highly assisted vehicles refers to the implementation of driving capabilities that mimic human behavior and decision-making. The goal is to make autonomous driving feel more intuitive and comfortable for human passengers by incorporating real-world driving patterns and preferences into the vehicle's operating system, while at the same time providing for safe and legal operation of the vehicle.

### SOME EXAMPLE EMBODIMENTS

Therefore, there is a need for an approach for determining when humanized driving (e.g., driving based on the actual driving behavior of many individuals) conflicts with legal and/or safe driving (e.g., driving that conforms with driving regulations, rules, laws, etc.).

According to one embodiment, a method comprises determining, for a given area, behavioral data representing aggregated driving behavior in the given area. The method also comprises determining, for the given area, map data comprising one or more map objects and one or more driving constraints, permissions, conditions, or requirements (e.g., collectively referred to as legal representations) associated with the one or more map objects. The method further comprises detecting, based on a comparison between the behavioral data and the map data, a behavior discrepancy between the aggregated driving behavior and the one or more driving constraints, permissions, conditions, or requirements. The method further comprises generating a behavior discrepancy warning indicating the detected behavior discrepancy.

According to another embodiment, an apparatus comprises at least one processor, and at least one memory including computer program code for one or more computer programs, the at least one memory and the computer program code configured to, with the at least one processor, cause, at least in part, the apparatus to determine, for a given area, behavioral data representing aggregated driving behavior in the given area. The apparatus is also caused to determine, for the given area, map data comprising one or more map objects and one or more driving constraints, permissions, conditions, or requirements associated with the one or more map objects. The apparatus is further caused to detect, based on a comparison between the behavioral data and the map data, a behavior discrepancy between the aggregated driving behavior and the one or more driving constraints, permissions, conditions, or requirements. The apparatus is further caused to generate a behavior discrepancy warning indicating the detected behavior discrepancy.

According to another embodiment, a computer program product may be provided. For example, a computer program product comprising instructions which, when the program is executed by a computer, cause the computer to determine, for a given area, behavioral data representing aggregated driving behavior in the given area. The computer is also caused to determine, for the given area, map data comprising one or more map objects and one or more driving constraints, permissions, conditions, or requirements associated with the one or more map objects. The computer is further caused to detect, based on a comparison between the behavioral data and the map data, a behavior discrepancy between the aggregated driving behavior and the one or more driving constraints, permissions, conditions, or requirements. The computer is further caused to generate a behavior discrepancy warning indicating the detected behavior discrepancy.

According to another embodiment, a non-transitory computer-readable storage medium carries one or more sequences of one or more instructions which, when executed by one or more processors, cause, at least in part, an apparatus to determine, for a given area, behavioral data representing aggregated driving behavior in the given area. The apparatus is also caused to determine, for the given area, map data comprising one or more map objects and one or more driving constraints, permissions, conditions, or requirements associated with the one or more map objects. The apparatus is further caused to detect, based on a comparison between the behavioral data and the map data, a behavior discrepancy between the aggregated driving behavior and the one or more driving constraints, permissions, conditions, or requirements. The apparatus is further caused to generate a behavior discrepancy warning indicating the detected behavior discrepancy.

According to another embodiment, an apparatus comprises means for determining, for a given area, behavioral data representing aggregated driving behavior in the given area. The apparatus also comprises means for determining, for the given area, map data comprising one or more map objects and one or more driving constraints, permissions, conditions, or requirements (e.g., collectively referred to as legal representations) associated with the one or more map objects. The apparatus further comprises means for detecting, based on a comparison between the behavioral data and the map data, a behavior discrepancy between the aggregated driving behavior and the one or more driving constraints, permissions, conditions, or requirements. The apparatus further comprises means for generating a behavior discrepancy warning indicating the detected behavior discrepancy.

In addition, for various example embodiments described herein, the following is applicable: a computer program product may be provided. For example, a computer program product comprising instructions which, when the program is executed by a computer, cause the computer to perform any one or any combination of methods (or processes) disclosed.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing behavioral decision warning, according to one example embodiment;

FIGS. 2A-2D are a flowchart of an end-to-end workflow for providing behavioral decision warning, according to one example embodiment;

FIGS. 3A-3E are a flowchart of determining vehicle path speed profile discrepancy against road topology, according to one example embodiment;

FIGS. 4A-4H are a flowchart of determining vehicle path discrepancy against road boundary seeded lane groups, according to one example embodiment;

FIGS. 5A-5F are a flowchart of determining vehicle path discrepancy against lane boundary seeded lane groups, according to one example embodiment;

FIGS. 6A-6F are a flowchart of determining vehicle path discrepancy against Road Boundary Observable (Road Side Detection (RSD)), according to one example embodiment;

FIGS. 7A-7F are a flowchart of determining vehicle path discrepancy against Lane Boundary Observable (RSD), according to one example embodiment;

FIG. 7G is a flowchart of a process for providing behavioral decision warning, according to one example embodiment;

FIG. 8 is a diagram of an architecture of an autonomous driving or advanced driver assistance system, according to one example embodiment;

FIG. 9 is a diagram of a high level system view of deriving behavioral decision warnings, according to one embodiment;

FIGS. 10 and 11 are flowcharts of processes for determining speed limit deviations, according to one embodiment;

FIGS. 12A and 12B are diagrams of examples of determining a behavior layer vehicle path is outside or close to a lane boundary (Lane Group), according to one example embodiment;

FIG. 13 is a diagram of an example of determining a deviation against a road boundary observable, according to one example embodiment;

FIG. 14 is a diagram of an example of determining a deviation against a land marking observable, according to one example embodiment;

FIG. 15 is a diagram of a geographic database, according to one embodiment;

FIG. 16 is a diagram of hardware that can be used to implement an embodiment of the invention;

FIG. 17 is a diagram of a chip set that can be used to implement an embodiment of the invention; and

FIG. 18 is a diagram of a mobile terminal that can be used to implement an embodiment of the invention.

### DESCRIPTION OF SOME EMBODIMENTS

Examples of a method, apparatus, and computer program for providing behavioral decision warnings, according to various example embodiments. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

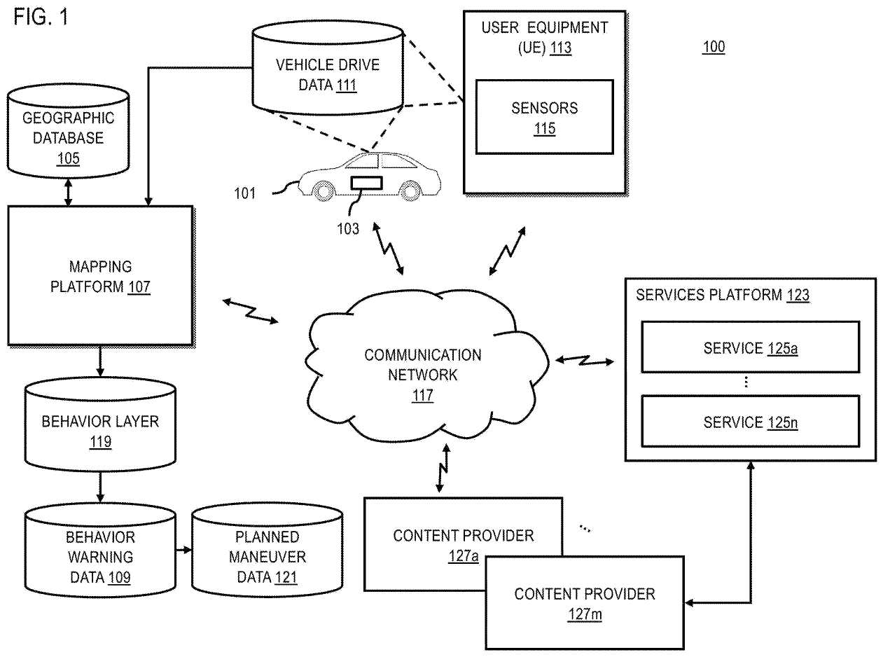

FIG. 1A is a diagram of a system capable of providing behavioral decision warning, according to one example embodiment. The system of FIG. 1A is further described with respect FIGS. 1B-1H. For driver assistance or autonomous driving, a vehicle (e.g., a vehicle 101 via onboard systems 103) generally plans vehicle controls (e.g., speed, steering) ahead of time and based on various situations (e.g., planned maneuvers, approaching intersections, etc.). Autonomous driving, also commonly referred to as self-driving or automated driving, encompasses vehicle technologies that enable the vehicle 101 to sense its environment and navigate roadways without continuous direct human input or intervention. The fundamental principle involves equipping vehicles 101 with advanced systems 103 capable of perceiving their surroundings, making real-time decisions, and controlling vehicle movements such as steering, acceleration, and braking.

Typically, autonomous driving systems rely on a combination of sensor technologies to gather information about the vehicle 101's operational environment. These sensors 115 may include, but are not limited to, cameras providing visual data, radar systems detecting objects and their relative speeds, lidar systems generating precise distance measurements and three-dimensional maps (e.g., map data of a geographic database 105), ultrasonic sensors for close-proximity detection, and positioning systems like global navigation satellite systems and inertial measurement units for localization and orientation.

The data collected from these disparate sensors 115 is processed using complex algorithms and computational systems (e.g., onboard systems 103 alone or in combination with a mapping platform 107 communicating over a communication network 117), often employing techniques from artificial intelligence and machine learning. These processing systems perform tasks such as object detection and classification (e.g., on-road and roadside objects also referred to as observables), scene understanding, fusing data from multiple sensors 115 for a robust environmental model, precise vehicle localization relative to a map (e.g., geographic database 105) or surroundings, trajectory planning to determine a safe and efficient path (e.g., planned maneuver data 121), and generating control commands.

Based on the output of these perception and planning systems, commands are transmitted to the vehicle 101's actuation systems (e.g., autonomous or highly assisted driving systems), which physically manipulate the steering wheel, throttle, and brakes to guide the vehicle 101 along the intended path while responding dynamically to traffic, road conditions, and potential hazards.

The development and classification of autonomous driving technologies are often standardized according to the framework provided by SAE International standard J3016, titled “Taxonomy and Definitions for Terms Related to Driving Automation Systems for On-Road Motor Vehicles.” This standard 1 establishes a taxonomy defining six distinct levels of driving automation, ranging from Level 0 (no automation) to Level 5 (full automation). These levels are differentiated based on the allocation of responsibilities for performing the real-time operational and tactical tasks of driving, including monitoring the surroundings and reacting appropriately, between the human driver and the automation system.

The classification begins with Level 0 (SAE L0), “No Driving Automation.” At this level, the human driver continuously performs all real-time operational and tactical aspects of driving. Any system features present are limited to providing warnings (e.g., blind spot warning, forward collision warning) or momentary intervention (e.g., automatic emergency braking) but do not provide sustained control over vehicle movement (steering, acceleration, or braking).

Moving to Level 1 (SAE L1), “Driver Assistance,” systems provide sustained assistance for either controlling speed and separation distance or steering, but not both simultaneously. The human driver remains responsible for all other aspects of the driving task and must constantly supervise the driving environment and the assistance feature.

Level 2 (SAE L2), “Partial Driving Automation,” involves systems providing sustained assistance for both controlling speed/separation and steering simultaneously, under specific operating conditions (e.g., within a defined speed range or on certain road types). Despite this combined assistance, the human driver is responsible for monitoring the driving environment, detecting and responding to objects and events, supervising the automation system's performance, and must be prepared to immediately intervene and resume full control of all driving functions at any time. The human driver performs all driving functions when the partial automation system is not engaged.

A significant transition occurs at Level 3 (SAE L3), “Conditional Driving Automation.” Here, the automation system performs all real-time driving functions within specific, predefined operating conditions under which it is designed to function. The system is also responsible for monitoring the driving environment and responding to objects and events within these designated conditions. The human driver acts as a “fallback-ready user,” meaning they are not required to supervise the driving environment while the system operates within its designed operational conditions. However, the user must remain receptive and available to take back control of the driving task upon receiving a request to intervene from the system, or when the system reaches the limits of its designed operational capability. This level marks the first instance where the system assumes primary responsibility for both driving functions and for monitoring and responding to the environment, albeit under specific, limited conditions.

Level 4 (SAE L4), “High Driving Automation,” further advances the system's role. Level 4 systems perform all real-time driving functions and are responsible for monitoring the environment and responding to objects and events within specified operating conditions under which they are designed to function. These systems do not require a fallback-ready user to intervene while operating within these designed conditions. If the system encounters circumstances outside its designed operating parameters or experiences a relevant failure, it is capable of achieving a minimal risk condition (e.g., safely parking the vehicle) without human intervention. Operation under Level 4 is typically constrained by factors defining these operational conditions, such as geographical area, road type, environmental conditions, or time of day.

Finally, Level 5 (SAE 5), “Full Driving Automation,” represents the highest degree of automation. A Level 5 system is capable of performing all real-time driving functions under all roadway and environmental conditions that a human driver could manage, effectively eliminating limitations related to specific operating conditions. Such systems handle all driving tasks, including monitoring the environment and responding to objects and events, in all conditions, thereby eliminating the need for a human driver. Consequently, vehicles designed exclusively for Level 5 operation may lack traditional human driving controls, with occupants functioning solely as passengers.

This SAE J3016 classification provides a framework for delineating the capabilities and responsibilities associated with different stages of driving automation technology. It is noted, however, that SAE J3016 classification is provided by way of illustration and not as limitations. It is contemplated that the although the various embodiments may discuss autonomous driving with respect to specific SAE automation levels, any equivalent autonomous driving classification or no classification (e.g., specifying equivalent autonomous functions and/or controls) may be used according to the various embodiments described herein.

In one embodiment, behavioral maneuvers can be used for natural autonomous driving (AD) (e.g., autonomous steering and braking). By way of example, behavioral maneuver comprise Behavioral Drive Path, Behavioral Transition, Behavioral Speed, and/or Behavioral Stopping Area. For example, Behavioral Drive Path can be defined as the predominant trajectory to anticipate where to drive within a lane or towards another lane. This can be used, for instance, in complex situations such as curves, at intersections, and near missing markings. The drawing associated with behavioral drive path illustrates the anticipation of the driving path based on aggregated behavior.

Behavioral Transition can be defined as the predominant transition area to anticipate where others start and end transitioning before-after the intersection. This can be used, for instance, at intersections. The drawing associated with behavioral transitions illustrates the anticipated zones of lane changing or maneuvering before and after intersections based on observed behaviors.

Behavioral Speed can be defined as the predominant speed to anticipate where to slow down. This can be used, for instance, in situations like curves, slopes, and damaged roads. This drawing associated with behavioral speed indicates the expected speed reductions based on historical driving data in specific road conditions.

Behavioral Stopping Area can be defined as predominant stopping locations to anticipate where to stop explicitly (stop line) and implicitly (virtual locations). This can be used, for instance, in the middle of intersections and near missing markings. This “drawing” demonstrates the anticipated stopping points, both at marked stop lines and in other locations where drivers frequently stop.

In one embodiment, autonomous driving (e.g., autonomous steering and braking) can be also supported by three complementary pillars:
(1) Map Objects (e.g., digital map objects of the geographic database 105): they are pre-calculated objects that are a legal representation of the world but can contain features that may be uncomfortable for driving (e.g. sharp curves) and have coverage gaps (e.g. hard to detect markings). By way of example a legal representation refers to representing objects along with rules, regulations, and/or laws related to driving in the presence or within proximity of such objects. Examples of these objects include but are not limited to:
   Roads—the legal representation may indicate that road boundaries should not be crossed;
   Lanes—the legal representation may indicate that lane boundaries should not be crossed under certain circumstances;
   Speed Limits—the legal representation may indicate that the vehicle may not travel more than the posted speed limit;
   Road surface markings—the legal representation may indicate various legal restrictions that guide and control vehicular movement;
   Signs—the legal representation may also indicate various legal restrictions that guide and control vehicular movement;
   Traffic Signals—the legal representation may indicate when a vehicle should proceed, slow, and/or stop; and
   Restricted/Permitted Maneuvers—the legal representation may indicate what maneuvers the vehicle can perform.
(2) Behaviors (e.g., stored in behavior layer 119 alone or in combination with the geographic database 105): they are human-like pre-calculated maneuvers that are smooth and uninterrupted, even in complex situation, but can contain unexpected maneuvers. For example, they can be stored as instructions for actuating or facilitating the actuation of vehicle controls to perform the pre-calculated maneuver. Examples of these behaviors include but are not limited to:
   Behavioral Drive Paths are predominant trajectories that help anticipate where to drive within one lane and towards another lane.
   Behavioral Transitions are predominant transition areas that helps anticipate where others start and end transitioning (e.g., between road segments, lanes, etc.).
   Behavioral Speed trends are predominant speed that help anticipate where to slow down.
   Behavioral Stops are predominant stopping locations that help anticipate where to stop.
   Behavioral Decision Warnings indicate zones or areas where humans (e.g., based on their recorded vehicle paths) act unexpectedly compared to the map objects around them (e.g., act contrary to legal standards/requirements associated with the map objects). In one embodiment, such behavioral decision warnings help to anticipate more safely the SAE level of autonomous driving that should be employed in these areas (both for the highlighted Behavioral Drive Path and its neighbors).
(3) Live perception data: ensures live localization and live events handling, with focus on reactivity rather than anticipation. By way of example, live perception data refers to the real-time information gathered by a vehicle's sensors to ensure live localization and handling of live events. This data focuses on immediate reactivity to the surrounding environment, rather than pre-calculated anticipations, enabling the vehicle to adapt to dynamic and unforeseen changes on the road.

With the above context, the technical challenges lie in the task of distinguishing between expected, unexpected but healthy, and unexpected and unhealthy vehicular behaviors to appropriately support various levels of SAE autonomous driving. For effective autonomous operation, it is necessary to identify expected behaviors that are predictable and consistent, supporting higher autonomy levels such as SAE L2+ and L3. However, when encountering unexpected and healthy behaviors that are still within a range of normalcy, the system should downgrade to supporting SAE L2, ensuring safety and requiring the autonomous vehicle to maintain a level of alertness and adaptability. Conversely, unexpected and unhealthy behaviors, posing significant risks, should be distinctly identified to avoid autonomous operation (e.g., by requiring human takeover of driving duties), thus safeguarding the vehicle and its occupants. An additional layer of complexity arises when unexpected behaviors occur within an environment of otherwise expected behaviors. In such scenarios, even these neighboring expected behaviors should avoid autonomous operation (e.g., support SAE L2 or below), as the vehicle must be prepared to react dynamically to the surrounding unpredictable events, ensuring comprehensive safety and control.

The address these technical challenges, the system 100 of FIG. 1 introduces the following capabilities:
(1) In one embodiment, Behavioral Drive Path is referenced to a specific lane in the road and lane model. With this the relation to the lane, road and to legal maneuvers can be automatically evaluated by the mapping platform 107.
(2) In one embodiment, behaviors can contain Discrepancy Warnings for all segments where a relational issue to other elements is identified (e.g., proximity or crossing of road/lane boundaries or stop lines, speeding beyond posted speed limits, ignoring stop signs, etc.). Then the discrepancy warnings can be used to understand how potential meaningful mitigation measures can be taken, because any measure to mitigate relational issues will lead to deviations of the autonomous operation of a vehicle from the human like driving behavior. In one embodiment, potential measures may be implemented to mitigate relational issues while providing humanized driving to the extent possible.
(3) In one embodiment, Behavioral Drive Paths can be attributed with Discrepancy Warnings where discrepancies between Behaviors and Map Objects are automatically detected, based on pre-defined cases. For example, these cases include but are not limited to:
   Tendency to drive outside or too close to road edges
   Tendency to drive outside or too close to lane markings
   Tendency to drive above Speed Limits
   Associated Road has Restricted Turn
   Associated Road is Restricted Access
   Associated Road has Conditional Speed Limits
   Associated Road has Ongoing Constructions
   Incoming Change, Behaviors are obsolete

It is noted that the above examples of discrepancy warnings are provided by way of illustration and not as limitations. It is contemplated that any discrepancies between behavior and legal maneuvers are applicable to the various embodiments described herein.
(4) In one embodiment, the Customer or end user can acknowledge the standard pre-defined list of cases used for Discrepancy Warnings. The Customer can implement additional matching cases between Behaviors and Map Objects, for their own usage.
(5) In one embodiment, Discrepancy Warnings can be used for improving the activation and deactivation for self-driving functions and foresightful notification of driver take-over-requests.
(6) In one embodiment, the Customer or end user may choose to not deactivate self-driving functions in some areas with Discrepancy Warnings (e.g. tendency to cross a marking on a narrow road with cars parked on both sides).
(7) In one embodiment, the Customer or end user may choose to deactivate self-driving functions in areas nearby Discrepancy Warnings (e.g. the tendency for drivers to take a restricted turn could result in deactivating self-driving functions also on the nearby drive paths).
(8) In one embodiment, exceptions to the discrepancy warnings can be implemented. For example, the ‘Tendency to drive in opposite direction’ is available directly in the road and lane associations, therefore it can be excluded in the Discrepancy Warning list.
(9) In one embodiment, the Customer or end user may choose to overwrite the Behavioral Speed with their derived speed (e.g., based on the Speed Limits Static or Conditional Speed Limits, and the curvature and elevation of the Behavioral Drive Path), if humans tend to overspeed or in certain situations (e.g. conditional speed limits).
(10) In one embodiment, Behavioral Maneuvers can be licensed with Roads, Lanes, Speed Limits Static, Conditional Speed Limits, Permitted & Restricted Maneuvers, Constructions, which are the basis for the Discrepancy Warnings.
(11) In one embodiment, Decision Warning Stats about crossing Lane Markings can exclude designated road topologies or feature such as but not limited to: upcoming split and merge, upcoming toll area, upcoming construction, narrow roads with parking lane

In summary, in one embodiment, the system 100 the capability to derive a behavior may or layer 119 from aggregated driver behavior. For example, a behavior map can be derived from aggregated driver behavior by collecting crowd-sourced sensor data from multiple vehicles, which includes anonymized drive paths, speeds, and attributes such as the presence of other vehicles, day/night conditions, and road features. This data is then aligned to lane-level accuracy and clustered to define specific locations and maneuvers. The system aggregates these paths to create a singular representation per lane, capturing lane transition scores based on the rate of lane changes. These aggregated behaviors are attached to geographic maps, helping autonomous or assisted vehicles predict lane changes and plan maneuvers, enhancing safety and efficiency in driving.

Discrepancy warnings are then created by comparing behavior map features and attributes to legal maneuvers such as but not limited to those stored in a map (or any other equivalent database or data source such as legal/legislative documents that prescribe driving regulations) containing legal information such as the geographic database 105. In one embodiment, discrepancy warnings are generated by analyzing and comparing the behavior map features derived from aggregated driver data to legal maneuvers (e.g., such as but not limited to the legal representation of map objects stored in the geographic database 105 or any other equivalent data structure). This process involves identifying deviations between typical driver behaviors (e.g., as indicted by the Behavior Drive Paths) and the legal constraints or expected norms (e.g., as defined within the geographic maps or any other source of legal restrictions, information, etc.). For instance, if the behavior map indicates frequent speeding in particular areas where the map specifies speed limits, discrepancy warnings are triggered. These warnings help identify and flag areas where drivers; actual behaviors do not align with legal expectations indicated in the map. For example, the system 100 can perform actions such as but not limited to the following to determine discrepancy warnings:
Aggregated drive paths are compared to lanes in lane groups, lane boundaries, road boundaries to detect where drivers drive the wrong direction, drive outside of lanes, or perform illegal maneuvers.
Aggregated speed profiles are compared to speed limits to determine where aggregated speed is not withing the legal limit.
Aggregated stopping locations are compared to stop lines and crosswalks to determine they meet legal requirements
Aggregated stopping locations are analyzed with traffic signals, signs, and intersection information to determine if they are at a legal stopping location.

Aggregated lane transition probabilities are compared to lane transition status, lane boundary marking styles, lane boundaries, intersections, to determine if lane transitions are permissible where they may be likely.

In one embodiment, the mapping platform 107 or system 100 can provide example mapping/navigation products for autonomous driving (e.g., autonomous steering and braking) that are based on map objects and behaviors (e.g., humanized behaviors derived from observed vehicle trajectories). For example, Behavioral Maneuvers products are used to derive optimal autonomous driving (e.g., autonomous braking and steering) maneuvers at Lane-Level (e.g., L2/L3 Lane-Keep Assist, Lane-Change Assist, Cruise Control). This includes Human Trends products (Licensed on top of HDLM) which include but are not limited to any combination of: (1) Behavioral Maneuvers Path (replaces derived Lane Centerline); (2) Behavioral Maneuvers Transition (replaces derived Lane Transition Status); (3) Behavioral Maneuvers Speed (completes legal Speed Limits); and (4) Behavioral Maneuvers Stop (completes legal Road Surface Markings).

Products may also include Map Objects (HDLM), including but not limited to Roads, Lanes, Speed Limits, HD Signs, HD Traffic Signals, Poles, Barriers, and Road Surface Markings. These products, for instance, indicate that optimal AD Braking Maneuvers at Road-Level (e.g., Truck Fuel Optimization) are derived from Roads, Speed Limits, Stop/Yield Signs, Priority Roads, Traffic Signals, Slope, and Curvature.

These products can also be used for selecting optimal roads from A to B. In other examples, Map Objects can be used for selecting optimal roads for Navigation, considering, e.g., Constructions and Traffic Patterns. This product can differentiate between the needs of Trucks, Passengers, and Straight Roads. In Simple Situations (e.g., straight roads, single lane roads, etc.), Map Objects may be sufficient, Behaviors may not be needed, whereas In Complex Situations (e.g., complex intersections, weather and or time with poor visibility, large or narrow lanes, complex stopping locations, curved or damaged roads, etc.), smooth and uninterrupted Behaviors are needed (e.g., Intersections, Large & Narrow Lanes, Weather & Time, Stopping Locations, Curves, Slopes, Damaged Roads).

The various embodiments of system 100 can also be for analyzing unexpected behaviors. This figure notes that Analyzed Unexpected Behaviors are needed for Pattern Analysis, safer Maneuver Derivation, and safter Autonomous Driving Zones, giving examples of a Behavioral Path driving a Restricted U-Turn, Behavioral Speed being above Speed Limits, and Behavioral Path close to another Behavioral Drive Path. In addition, the various embodiments can be used to create safer Maneuver Derivations and AD Zones by addressing Unexpected Behaviors. Examples include always avoiding a specific Behavioral Path, always overwriting a Behavioral Speed, following a Behavioral Path based on Pattern Analysis, and noting when Behavioral Speed is above Speed Limits.

In one embodiment, Unexpected Behavior flags can be used for safer Maneuver Derivation and Autonomous Driving Zones. Examples can include a Behavioral Path sometimes being in the middle or on the left of a lane, and how this can be healthy or unhealthy depending on factors like parked cars or constructions. Such behavioral paths can comprise default and overwritten behaviors. For example, the default Behavioral Path is far from the parking side and has a wider curve, while Behavioral Speed can be overwritten near Traffic Lights or Conditional Speed. Default Behavioral Speed is fast if lights are OFF and slow if ON. In addition, with respect to examples relating to the healthiness of turns and speeds, this drawing elaborates on when certain unexpected behaviors might be healthy. Wide turns are healthy if there is opposite traffic, tight turns if there is not. Fast speeds are healthy with green lights or outside conditional hours, while slow speeds are healthy with red lights or during conditional hours. Fast speeds are healthy if dry and bright, while slow speed are healthy if wet and dark. It concludes that Unexpected Behaviors can mean Multi-trends Behaviors and necessitate Pattern Analysis.

The following flowcharts are provided by way of example and are not intended as limitations. Each of the flowcharts can be performed in any combination or order, and may omit one or more steps;

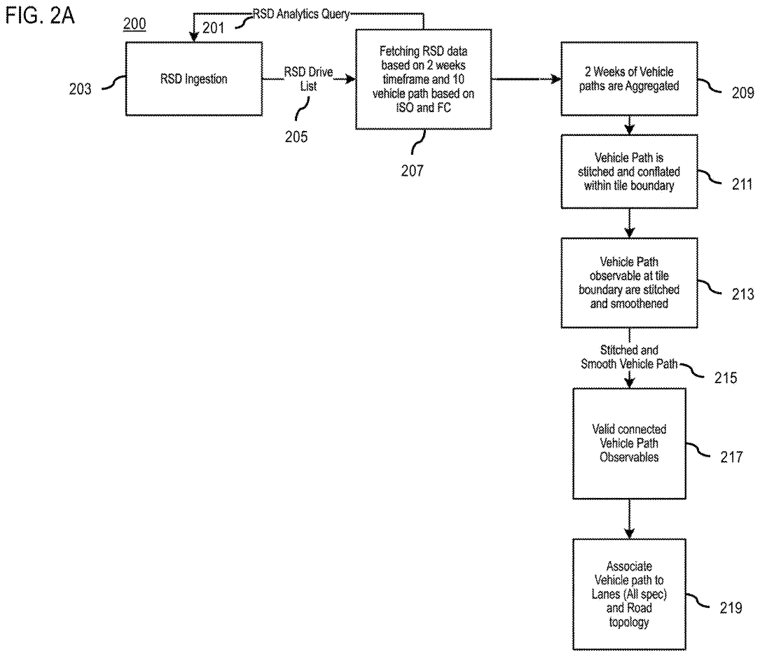

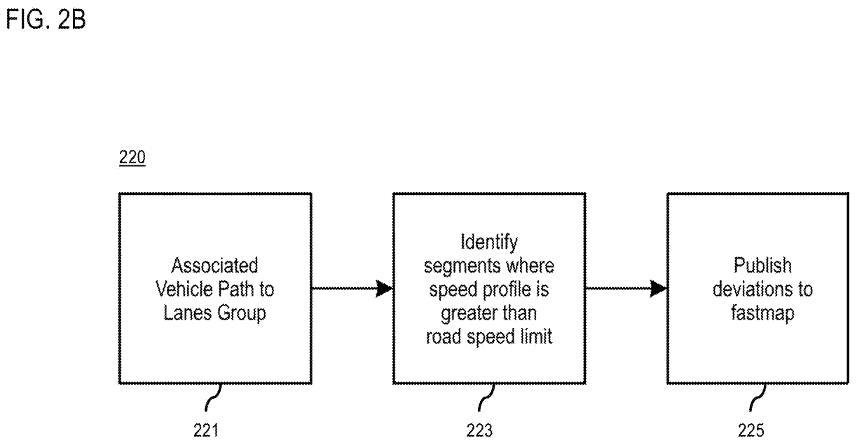

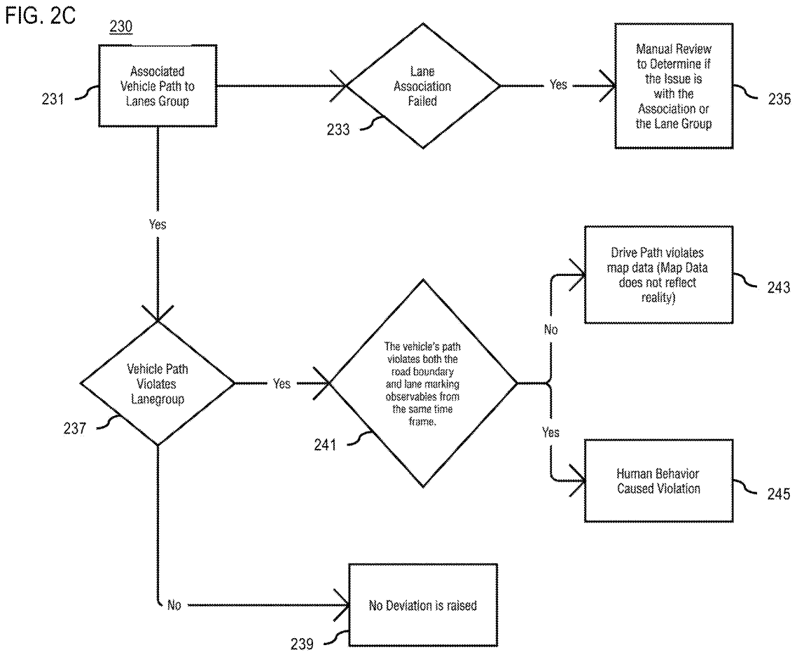

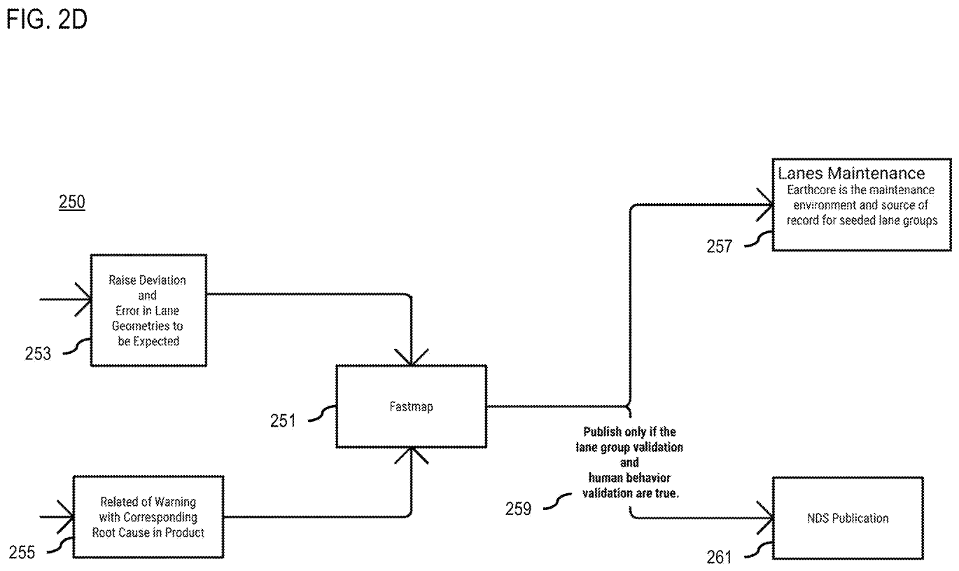

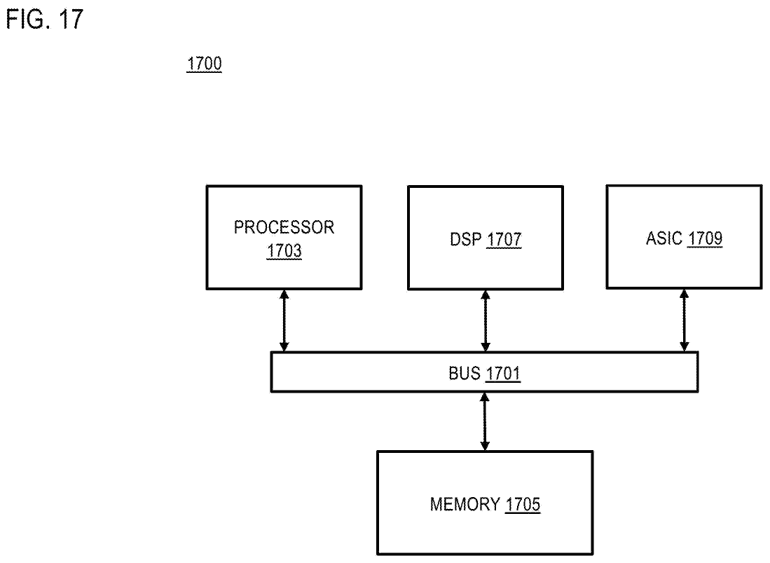

FIGS. 2A-2D is a flowchart of an end-to-end workflow for providing behavioral decision warning, according to one example embodiment. In various embodiments, the mapping platform 107 and/or any equivalent component may perform one or more portions of the process of FIGS. 2A-2D and may be implemented in, for instance, a chip set including a processor and a memory as shown in FIG. 17. As such, the mapping platform 107 can provide means for accomplishing various parts of the process, as well as means for accomplishing embodiments of other processes described herein in conjunction with other components of the system 100. Although the process of FIGS. 2A-2D is illustrated and described as a sequence of steps, it is contemplated that various embodiments of the process may be performed in any order or combination and need not include all of the illustrated steps. The end-to-end workflow is spread over FIGS. 2A-2D with FIG. 2A depicting processes associated with vehicle path observables, FIG. 2B depicting processes associated with deviations with respect to speed limits on road, FIG. 2C depicting processes associated with deviations with respect to lanes, and FIG. 2D depicting additional processes taking outputs of the processes of FIGS. 2A-2C.

The “Vehicle Path Observable” process 200 of FIG. 2A is as follows.
(1) RSD Analytics Query (block 201): The process begins with a query into an analytics system for RSD.
(2) RSD Ingestion (block 203) & Drive List (205): This query triggers the ingestion (collection or input) of RSD, resulting in an “RSD Drive List” 205.
(3) Data Fetching (block 207): Using the drive list 205, specific RSD data is fetched based on defined criteria: a 2-week timeframe and data corresponding to 10 vehicle paths, potentially filtered by standards or conditions referred to as “ISO” and “FC.”
(4) Aggregation (block 209): The fetched data, representing vehicle paths over two weeks, is aggregated or combined.
(4) Stitching and Conflation (block 211): The aggregated vehicle path data is then “stitched” (connected together, likely from segments) and “conflated” (merged or reconciled) within the boundaries of map “tiles.” This step aims to create a more continuous path representation within defined map areas.
(5) Boundary Stitching and Smoothing (block 213): Vehicle paths that cross the boundaries between these map tiles are specifically addressed. They are stitched together to ensure continuity across tiles and then “smoothened” to remove irregularities or noise, resulting in a cleaner stitched and smoothed path 215.
(6) Validation (block 217): The resulting “Stitched and Smooth Vehicle Path” 215 undergoes validation to ensure it represents a valid, connected trajectory. This produces the “Valid connected Vehicle Path Observables.”
(7) Association with Map (block 219): Finally, this validated vehicle path observable is associated with the underlying map information, specifically linking the path to road lanes (according to specifications, “All spec”) and the overall road topology (structure and layout).

In summary, this flowchart describes a data processing pipeline that takes RSD data, selects relevant paths over a specific period, cleans and connects these path segments (especially across map tile boundaries), validates the result, and finally maps the observed vehicle trajectory onto the road network, identifying the lanes used.

FIG. 2B is flowchart titled “Deviation with respect to speed limit on road” process 220 and continues from the process 200 of FIG. 2A as follows.
(8) Input (Implied) (block 221): The process starts with the output from the previous flowchart, which is the “Associated Vehicle Path to Lanes (All spec) and Road topology.” This input is represented here slightly differently as “Associated Vehicle Path to Lanes Group,” indicating the vehicle's path is now understood in the context of specific lane groups on the road.
(9) Identify Speeding Segments (block 223): The system analyzes this lane-associated vehicle path. It specifically looks at the vehicle's speed (“speed profile”) along different segments of the path and compares this speed against the official “road speed limit” for those corresponding segments. The goal is to identify any parts of the path where the vehicle's speed exceeded the legal limit.
(10) Publish Deviations (block 225): Once these segments of speeding (“deviations”) are identified, the information about these deviations is “Published” (sent or recorded) to a system or platform referred to as “fastmap.”

In summary, this process 220 takes the vehicle path that has been matched to road lanes, checks it for speeding violations by comparing the vehicle's actual speed to the speed limits on those road segments, and reports any identified speeding incidents to the “fastmap” system.

FIG. 2C is flowchart of a process 230 titled “Deviation with respect to lanes” and continues from the process 200 of FIG. 2A as follows.
(11) Input/Initial Check: The process 230 starts with the “Associated Vehicle Path to Lanes Group” (block 231), meaning the vehicle's path has been linked to a set of lanes. An immediate check (decision diamond labeled “Lane Association Failed?”) (block 233) determines if this initial association was successful.
   If YES (Association Failed): The process moves to “Manual Review to Determine if the issue is with the Association or the Lane Group” (block 235). This means if the system couldn't automatically link the path to lanes, human intervention is needed to figure out if the problem lies in the association process itself or in the underlying map data defining the lane group.
(12) Check for Lane Violations (If Association Succeeded): If the initial lane association was successful (implicit ‘No’ path from the first check, leading down from the input box), the process 230 continues to evaluate the path within the associated lane group.
   A decision diamond asks: “Vehicle Path Violates Lanegroup?” (block 237). This checks if the vehicle's actual path deviates from the boundaries or expected behavior within its assigned lane group (e.g., crossing lane lines).
   If NO (No Violation): The path proceeds to “No Deviation is raised” (block 239). This indicates the vehicle path is consistent with the associated lanes, and no lane-related issue is flagged for this path segment.
   If YES (Violation Occurred): The path violates the lane group rules (block 241). The process moves to a more detailed analysis in the next decision diamond.
(13) Determine Cause of Violation: This decision diamond at block 241 asks: “The vehicle's path violates both the road boundary and lane marking observables from the same time frame.” This tries to determine the nature of the violation by checking if the vehicle crossed both the physical edge of the road and lane markings around the same time.
   If NO (Violates Lane Group, but NOT Both Boundary & Markings) (block 243): The outcome is categorized as “Drive Path violates map data (Map Data does not reflect reality).” This suggests the deviation is likely due to errors or outdated information in the map's lane or boundary data, rather than erroneous driving. This path is associated with potential “Lanes Maintenance” (implying a need to correct the map).
   If YES (Violates Lane Group AND Both Boundary & Markings) (block 245): The outcome is categorized as “Human Behavior Caused Violation.” This implies the deviation (crossing lanes and road boundaries) is attributed to the driver's actions rather than map inaccuracies. This path is associated with logging the event as specific “Human Behavior.”

In summary, this flowchart of process 230 first handles cases where the path couldn't be matched to lanes at all (requiring manual review). If matched, it checks for deviations from the lane boundaries. If a deviation occurs, it further analyzes whether the deviation likely stems from incorrect map data (requiring map maintenance) or from the driver's behavior.

FIG. 2D continues the process from the previous flowcharts. This flowchart of process 250 centralizes the handling of the different deviations identified earlier.
(14) Central Hub-“Fastmap” (block 251): The box labeled “Fastmap” acts as a central system or database that receives information about deviations detected in the prior stages.
(15) Inputs into “Fastmap”:
   Speed Deviations: The arrow coming from the top represents the output of the flowchart of FIG. 2A. So, information about where the vehicle exceeded the speed limit is sent to Fastmap.
   Lane Deviations—Map Issue: The top arrow path from the flowchart of FIG. 2C (where the deviation was attributed to map data issues) leads here to the box “Raise Deviation and Error in Lane Geometries to be Expected” (block 253). This indicates that when a map data error is suspected, a specific type of deviation/error is flagged, acknowledging potential issues in lane geometry. This information is then fed into Fastmap.
   Lane Deviations—Human Behavior: The bottom arrow path from the flowchart of FIG. 2C (where the deviation was attributed to human behavior) leads here to the box “Related of Warning with Corresponding Root Cause in Product” (block 255). This suggests that when human behavior is deemed the cause, a warning is generated identifying this root cause, and this information is also sent into Fastmap.
(16) Triggering Map Maintenance: Following the input related to map errors (“Raise Deviation and Error . . . ” at block 253), there is a separate arrow pointing directly to the box “Lanes Maintenance” 257. This box explains that “Earthcore is the maintenance environment and source of record for seeded lane groups.” This means that identifying a likely map error not only sends data to Fastmap but also directly triggers or informs the dedicated map maintenance system (Earthcore) to address the potential issue with the lane data.
(17) Conditional Output-NDS Publication: An arrow leads out from Fastmap to the box “NDS Publication.” However, this path is conditional, as stated by the text: “Publish only if the lane group validation and human behavior validation are true” (block 259). This means that the aggregated data in Fastmap undergoes further validation checks. Only if specific criteria related to the validity of the lane group data and the human behavior assessment are met, will the data be published to an NDS format or system (e.g., the geographic database 105) (block 261).

In Summary, this stage acts as a central point for handling reported deviations:
It collects speed limit violations.
It collects lane deviations, flagging whether they are likely due to map errors or human behavior.
Deviations suspected to be map errors trigger a separate map correction process (“Lanes Maintenance”).
All collected deviation information is aggregated in “Fastmap.”
Finally, data from Fastmap is selectively published (to NDS) after passing specific validation checks related to lane and behavior data quality or confirmation.

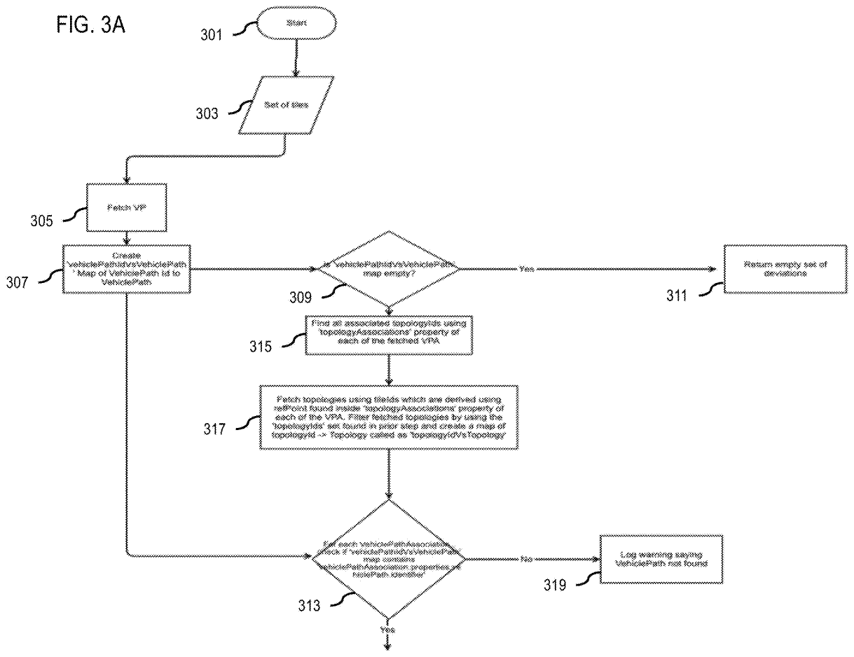

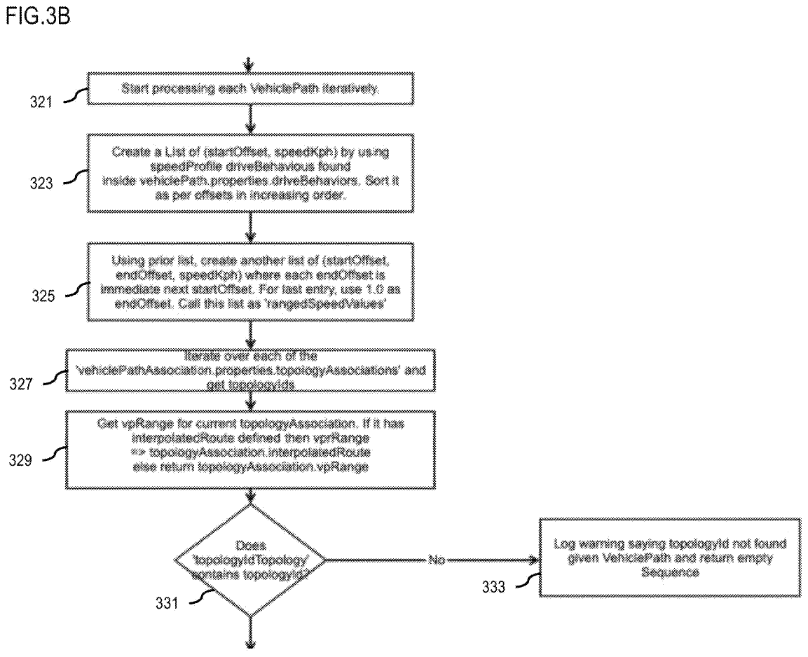

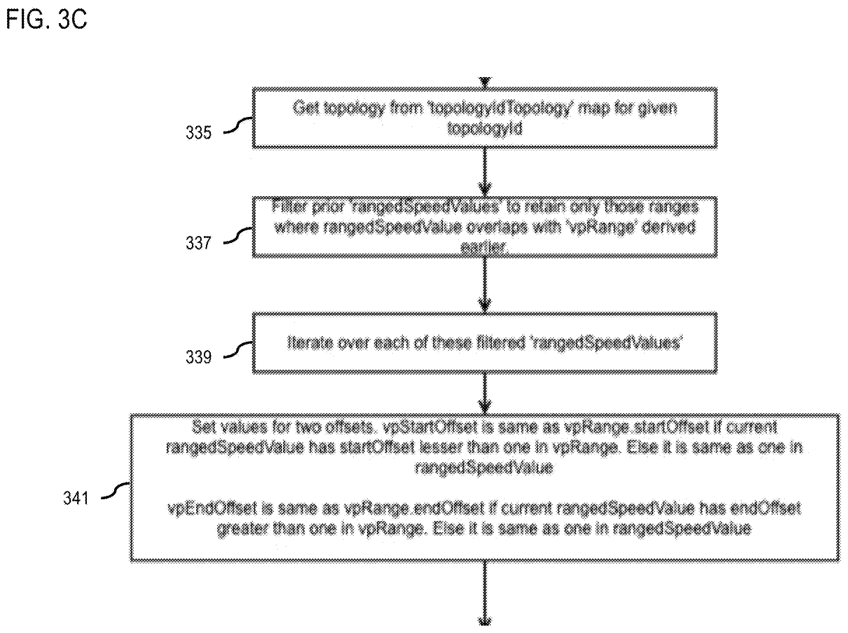

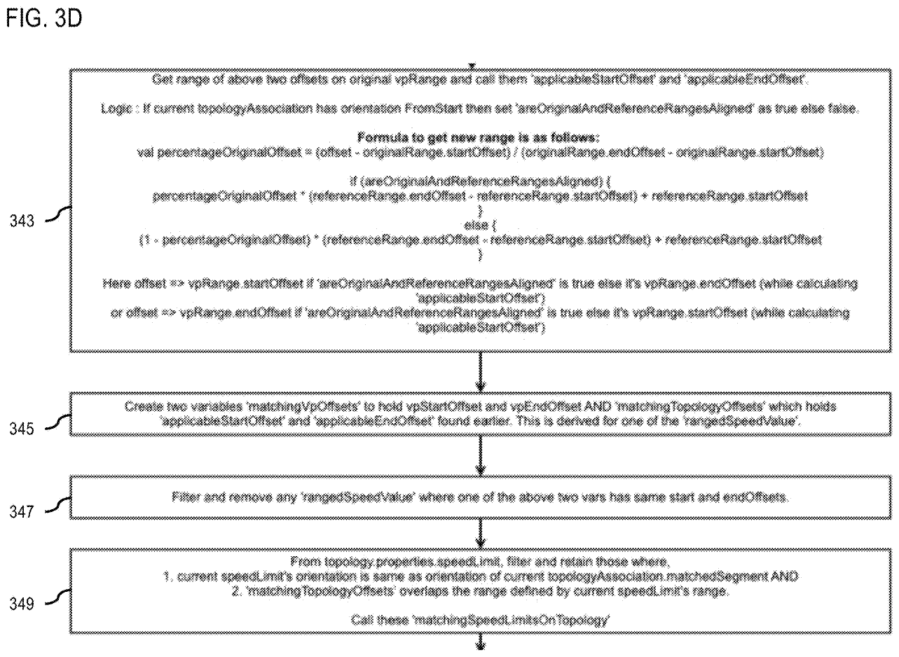

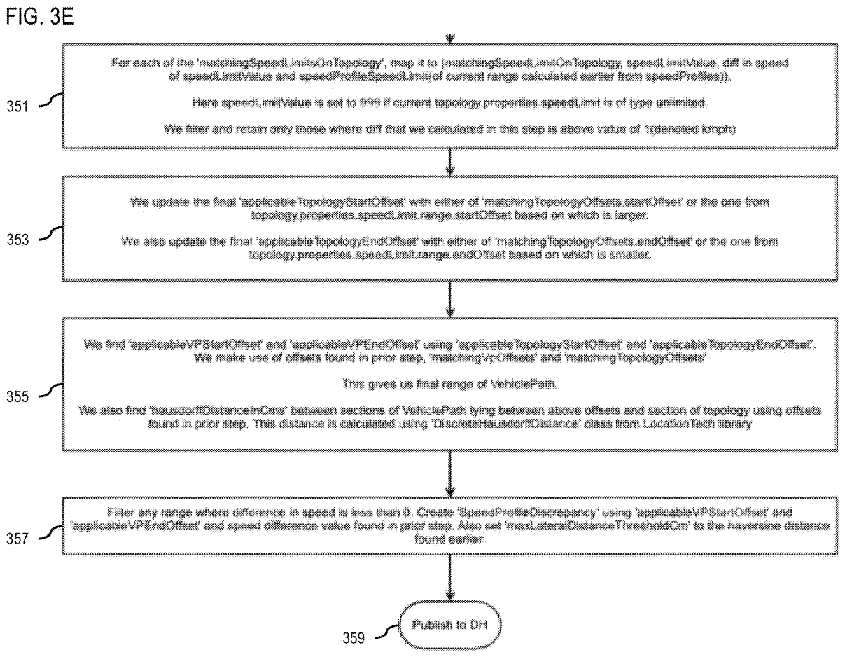

FIGS. 3A-3E are a flowchart of determining vehicle path speed profile discrepancy against road topology and/or other mapped features (e.g., infrastructure elements), according to one example embodiment. In various embodiments, the mapping platform 107 and/or any equivalent component may perform one or more portions of the process of FIGS. 3A-3E and may be implemented in, for instance, a chip set including a processor and a memory as shown in FIG. 17. As such, the mapping platform 107 can provide means for accomplishing various parts of the process, as well as means for accomplishing embodiments of other processes described herein in conjunction with other components of the system 100. Although the process of FIGS. 3A-3E is illustrated and described as a sequence of steps, it is contemplated that various embodiments of the process may be performed in any order or combination and need not include all of the illustrated steps.

In one embodiment, the processes of FIGS. 3A-3E comprises a relational check for vehicle drive path and overall maneuvers to other infrastructure elements as well as other averaged behaviors to normalize the behavior drive input data for future refinement of drive paths. Performing a relational check for vehicle drive path and overall maneuvers to other infrastructure elements involves analyzing and comparing the behavior and trajectory of a vehicle with its surrounding mapped environment, including roads, signage, and other infrastructure features. This process ensures that the vehicle's path aligns with the expected road topology.

The system evaluates the vehicle's path data, such as speed, direction, and maneuvers, in relation to the physical road layout. This includes checking discrepancies with features like lanes, speed limits, and intersections. It also examines the vehicle's movements, including lane changes, turns, acceleration, and braking, to ensure they correspond to nearby infrastructure such as traffic signals or lane markers.

Additionally, the process may involve normalizing data by aggregating behavior across multiple vehicles to refine future drive paths and eliminate anomalies. This creates a standardized representation of typical driving behavior for specific map areas.

Furthermore, the analysis integrates road topology data that defines the layout and properties of road segments and intersections. By associating vehicle paths with specific topology identifiers, the system verifies that a vehicle's route is consistent with the mapped road structures.

When the system detects discrepancies, such as consistent deviations from speed limits or lane misalignments, these are flagged as potential map errors or behavioral anomalies. This allows for corrective actions, like map updates or validation of behavior patterns, to be implemented effectively.

Overall, this relational check ensures consistency between vehicle behavior and surrounding infrastructure, enhancing the accuracy of map data and supporting better navigation and autonomous driving systems.

FIGS. 3A-3E depict a single flowchart spread out over multiple figures. More specifically, the flowchart illustrates a flow of vehicle path speed profile discrepancy against road topology. This discrepancy shows the range of given VehiclePath where there is a difference in speed limits above a threshold. This difference is calculated for a common range of VehiclePath and its associated Topology for the same range. Both the VehiclePath and Topology have speedLimit with ranges as one of the property.

FIG. 3A illustrates the following.
(1) Start & Tile Selection: The process begins at the “Start” oval (block 301) and immediately moves to defining a “Set of tiles” (block 303). This indicates the analysis is performed on specific geographic areas or map sections represented by these tiles.
(2) Fetch Vehicle Path Data: The next step is “Fetch VP” (block 305), where “VP” stands for VehiclePath. Relevant vehicle path data is retrieved, pertaining to the selected tiles.
(3) Create Vehicle Path Map A data structure named (block 307): ‘VehiclePathIdVsVehiclePath’ is created. This map links each VehiclePath's unique ID to its corresponding data object, making it easy to look up specific paths later using their ID.
(4) Check if Paths Found (block 309): A decision point checks if the ‘VehiclePathIdVsVehiclePath’ map is empty.
   If YES (Empty) (block 311): No vehicle paths were found or fetched for the selected tiles. The process terminates for this set of tiles and returns an “empty set of deviations,” as no analysis can be done.
   If NO (Not Empty): Vehicle paths were successfully fetched. The process continues.
(5) Find Associated Topology IDs (block 313): For each fetched VehiclePath (VPA-Vehicle Path Association), the system accesses a property named ‘TopologyAssociations’. This property contains identifiers (IDs) that link segments of the vehicle's path to corresponding segments of the underlying road topology map data. All these associated topology IDs are gathered.
(6) Fetch Associated Topology Data (block 315): The system now fetches the actual road topology data segments identified in the previous step. It uses ‘tilelds’ (e.g., derived from a ‘refPath’ property within the VehiclePath's ‘Topology Associations’) and filters using the specific ‘topologyIds’ collected earlier. The fetched topology data is stored in another map called ‘topologyIdVsTopology’, linking each topology ID to its corresponding data object.
(7) Validate Data Availability (block 317): The process then performs a validation check for each vehicle path association. It verifies if the topology segment ID associated with the vehicle path (found via vehiclePathAssociation.properties.hidePath.identifier) actually exists as a key in the topologyIdVsTopology map created in the previous step. Essentially, it confirms that the required map data for each part of the vehicle path was successfully fetched.
   If NO (Topology Data Missing) (block 319): The corresponding topology data for the specific vehicle path segment could not be found or fetched. A warning is logged (“Log warning saying VehiclePath not found”-though it might more accurately mean associated topology not found). The process likely skips or flags this particular association.
   If YES (Topology Data Found): The necessary topology data associated with the vehicle path segment is available. The process continues successfully for this vehicle path segment, proceeding to the next steps which are presumably shown in the subsequent part of the flowchart (off the bottom of this image).

In summary, this first part of the flowchart focuses on gathering and preparing the necessary data: fetching vehicle paths for specific map tiles, identifying and fetching the corresponding road topology segments linked to those paths, and validating that all required data pieces (both vehicle path and associated topology) are present before proceeding with the actual speed limit comparison analysis.

The process continues to FIG. 3B as follows. This section focuses on processing the speed profile of each vehicle path and relating it to its associated topology segments.
(8) Iterative Processing (block 321): The process now “Start [s] processing each VehiclePath iteratively.” This means the following steps are performed one by one for each vehicle path that successfully passed the validation checks in the previous stage.
(9) Extract and Sort Speed Profile (block 323): For the current VehiclePath being processed, the system creates a “List of (startOffset, speedKph)”.
   It extracts speed data (speedKph) and the point along the path where that speed starts (startOffset) from the speedProfile within the vehiclePath.properties.driveBehaviors.
   This list is then sorted according to the startOffset in ascending order, providing an ordered sequence of speed measurements along the path.
(10) Create Ranged Speed Values (block 325): Using the sorted list from the previous step, another list called rangedSpeedValues is created. This list represents the speed profile as segments: (startOffset, endOffset, speedKph).
   For each entry (startOffset_i, speedKph_i) from the prior list, its corresponding endOffset i is set to the startOffset of the next entry (startOffset_{i+1}).
   For the very last speed entry, the endOffset is set to 1.0 (e.g., representing the normalized end of the relevant path segment).
   This results in a list where each item defines a continuous segment of the path (startOffset to endOffset) and the constant speed (speedKph) maintained during that segment.
(11) Iterate Through Topology Associations (block 327): The process then iterates through each topology segment associated with the current VehiclePath (specifically looking at VehiclePathAssociation.properties.topologyAssociations) to get the relevant topologyIds one by one.
(12) Determine Vehicle Path Range (vpRange) (block 329): For the current topology association being considered in the loop, the system determines the corresponding range along the vehicle path, referred to as vpRange.
   It checks if an interpolatedRoute property exists for the topology association.
   If it does, vpRange is assigned the value of topology Association.interpolatedRoute.
   Otherwise (if interpolatedRoute is not defined), vpRange is assigned the value of topology Association.vpRange. This step ensures the correct segment of the vehicle path corresponding to the current topology segment is identified.
(13) Validate Topology Data Availability (Again) (block 331): A decision point checks: “Does ‘topologyIdVsTopology’ contains topologyId?”. This verifies if the map containing the fetched topology data (created in the first part of the flowchart) actually holds the data for the specific topologyId currently being processed in this loop.
   If NO (Data Missing) (block 333): A warning is logged indicating the topologyId was not found for the given VehiclePath, and an empty sequence might be returned for this specific association. Processing for this particular topology association likely halts.
   If YES (Data Found): The required topology data is confirmed to be available. The process continues to the next steps (not shown in this image), now equipped with the vehicle's ranged speed profile (rangedSpeedValues) and the specific vehicle path range (vpRange) corresponding to the validated topology segment.

In summary, this portion of the flowchart takes each validated vehicle path, structures its speed profile into defined ranges, and then, for each associated road topology segment, identifies the corresponding section of the vehicle path and re-confirms data availability before proceeding to the subsequent analysis (e.g., the actual comparison of vehicle speed and topology speed limits).

The process continues to FIG. 3C as follows. This section of the flowchart continues the processing for each VehiclePath and its associated topology segments, focusing on aligning the vehicle's speed profile with the specific topology segment being analyzed.
(14) Get Topology Data (block 335): This step is to “Get topology from ‘topologyIdTopology’ map for given topologyId.” Using the topologyId for the current association (validated in the previous step), the system retrieves the corresponding detailed topology data object from the map created earlier. This gives access to the properties of this specific road segment, including its speed limit information.
(15) Filter Relevant Speed Segments (block 337): The process takes the rangedSpeedValues list (which contains the vehicle's speed over different segments of its path, like [startOffset, endOffset, speedKph]) and filters it. It keeps only those speed segments (rangedSpeedValue) that spatially overlap with the vpRange (the portion of the vehicle path corresponding to the current topology segment, derived in the previous flowchart part). This step isolates the parts of the vehicle's speed profile that are relevant to the current piece of road map.
(16) Iterate Over Relevant Speed Segments (block 339): The system then “Iterate [s] over each of these filtered ‘rangedSpeedValues’.” The following calculations are performed for each vehicle speed segment that overlaps with the current vpRange.
(17) Calculate Precise Overlapping Range (block 341): This step calculates the exact portion of the vehicle path where the current vehicle speed segment (rangedSpeedValue) and the topology segment's corresponding path range (vpRange) overlap. It defines two new offsets, vpStartOffset and vpEndOffset, for this precise intersection:
   vpStartOffset Calculation:
      If the current rangedSpeedValue starts before vpRange starts (i.e., rangedSpeedValue.startOffset<vpRange.startOffset), then vpStartOffset is set to vpRange.startOffset.
      Otherwise, vpStartOffset is set to rangedSpeedValue.startOffset.
      This ensures the calculated start offset is not earlier than the beginning of the relevant range (vpRange).
   vpEndOffset Calculation:
      If the current rangedSpeedValue ends after vpRange ends (i.e., rangedSpeedValue.endOffset>vpRange.endOffset), then vpEndOffset is set to vpRange.endOffset.
      Otherwise, vpEndOffset is set to rangedSpeedValue.endOffset.
      This ensures the calculated end offset is not later than the end of the relevant range (vpRange).
   The result is a precise segment (vpStartOffset, vpEndOffset) representing the exact overlap. The vehicle's speed (speedKph from the current rangedSpeedValue) is known for this specific segment.
(17) Continue Processing: The flowchart continues downwards from this step. Having calculated the exact overlapping segment (vpStartOffset, vpEndOffset) and knowing the vehicle's speed within it, the process is now ready to retrieve the topology's speed limit for this corresponding segment and perform the core comparison to identify speed discrepancies.

In summary, this part isolates the relevant vehicle speed data for the specific road segment being analyzed and calculates the precise start and end points of the overlap between the vehicle's speed segment and the road segment's path representation. This prepares the inputs for comparing the vehicle's speed against the topology's speed limit over that specific, common range.

The process continues to FIG. 3D as follows. This part focuses on mapping the overlapping segment onto the topology's reference frame and identifying the relevant speed limits from the topology.
(18) Map Overlap to Topology's Reference Range (block 343): The first major step takes the previously calculated overlap offsets (vpStartOffset, vpEndOffset, which are relative to the vehicle path's range vpRange) and converts them into corresponding offsets within the topology segment's own native coordinate system or reference range. These new offsets are called applicableStartOffset and applicableEndOffset.
   Orientation Logic: It first checks the orientation of the current topology Association (likely comparing the direction of the vehicle path segment to the inherent direction of the topology segment). This determines if the ranges are “aligned.”
   Coordinate Transformation Formula: A formula is applied to perform the conversion. It calculates the proportional position of the vpStartOffset (or vpEndOffset) within the vpRange (the originalRange). This proportion is then applied to the length of the referenceRange (the topology's native range) and adjusted by the referenceRange.startOffset. The formula includes logic to handle cases where the orientation is aligned versus not aligned (reversed), ensuring the mapping is correct regardless of directionality.
(19) Store Matching Offsets (block 345): Two variables are created to hold the results for the current overlapping rangedSpeedValue being processed:
   matching VpOffsets: Stores the vpStartOffset and vpEndOffset (overlap in vehicle path coordinates).
   matchingTopologyOffsets: Stores the newly calculated applicableStartOffset and applicableEndOffset (overlap in topology's native coordinates).
(20) Filter Zero-Length Overlaps (block 347): A cleanup step filters out and removes any instances where the calculated overlap resulted in zero length (i.e., vpStartOffset equals vpEndOffset, or applicableStartOffset equals applicableEndOffset).
(21) Identify Applicable Topology Speed Limits (block 349): This is a key step where the topology's speed limits are brought into the calculation.
   It accesses the speedLimit property within the current topology object's properties. This likely contains one or more speed limit values, possibly with associated ranges within the topology segment.
   It filters this speed limit information based on two conditions:
      Orientation Match: The orientation of the speedLimit entry (from topology Association.matchedSegment) must match the orientation considered.
      Range Overlap: The range defined by matchingTopologyOffsets (the overlap calculated in step 1, in topology coordinates) must overlap with the range over which the current speedLimit entry applies (defined within the speedLimit properties).

The topology speed limit entries that satisfy both conditions (correct orientation and applicability to the specific overlapping segment) are retained and referred to as matchingSpeedLimitsOnTopology.
(22) Continue Processing: The flowchart proceeds downwards. At this point, for a specific segment of overlap, the process has identified:
   The vehicle's speed (speedKph from the relevant rangedSpeedValue).
   The exact range of this overlap in both vehicle path and topology coordinates.
   The specific speed limit(s) defined in the topology data that apply to this exact segment (matchingSpeedLimitsOnTopology).

The process continues to FIG. 3D as follows. This final part of the flowchart details the calculation of the speed discrepancy, the filtering of results, and the final output generation
(23) Calculate Speed Difference (block 351): The process iterates through each of the matchingSpeedLimitsOnTopology identified in the previous step for the current overlapping segment. For each match, it calculates the difference (diff) between:
   The speedLimitValue from the topology (using a high value like 999 if the topology indicates ‘unlimited’ speed).
   The vehicle's actual speed for that segment (speedProfileSpeedLimit, which corresponds to the speedKph from the relevant rangedSpeedValue).
(24) Filter by Discrepancy Threshold (block 351 continued): The calculated differences are then filtered. Only those instances where the diff is greater than 1 km/h are kept. This step focuses the analysis on significant discrepancies where the vehicle speed and the topology speed limit differ by more than this threshold. (Based on later steps, it seems primarily interested in cases where vehicle speed significantly exceeds the topology limit).
(25) Refine Applicable Topology Range (block 353): The start and end offsets defining the segment of interest within the topology's reference frame (applicableTopologyStartOffset, applicable TopologyEndOffset) are further refined. They are adjusted by comparing them with the specific range (startOffset, endOffset) over which the current matching topology speed limit itself applies. The final applicableTopologyStartOffset becomes the later of the two start offsets, and the final applicableTopologyEndOffset becomes the earlier of the two end offsets. This precisely clips the analysis segment to the exact portion where both the overlap occurs and the specific topology speed limit is valid.
(26) Determine Final Vehicle Path Range & Geometric Deviation (block 355):
   Using the refined topology offsets (final applicableTopologyStartOffset, final applicable TopologyEndOffset), the system calculates the corresponding final start and end offsets on the original vehicle path (applicableVPStartOffset, applicableVPEndOffset). This likely involves reversing the coordinate transformation performed earlier. This gives the exact segment of the vehicle's path where the discrepancy occurs.
   It also calculates the hausdorffDistanceInCms between the vehicle path section (defined by the final VP offsets) and the topology section (defined by the final topology offsets). This measures how much the vehicle's actual driven path geometrically deviated from the map's representation of the path during this segment of interest, using a specific function (DiscreteHausdorffDistance from a Location Tech library).
(27) Filter and Create Discrepancy Object (block 357):
   The results are filtered again to remove any range where the calculated speed difference (diff) is less than or equal to 0. This confirms the focus is on instances where the vehicle's speed exceeds the topology's speed limit.
   For each remaining significant discrepancy, a SpeedProfileDiscrepancy object is created. This object encapsulates:
      The precise vehicle path range (applicable VPStartOffset, applicable VPEndOffset).
      The calculated speed difference (diff).
      The calculated geometric deviation.
      A maxLateralDistanceThresholdCm value is also set, possibly related to the geometric deviation tolerance.
(28) Publish Results (block 359): Finally, these SpeedProfileDiscrepancy objects, representing validated instances where the vehicle's speed significantly exceeded the map's speed limit over a specific segment (along with geometric path deviation information), are “Publish [ed] to DH” (e.g., a database).

In conclusion, this final stage quantifies the speed difference, filters for significant speeding events relative to the map, precisely defines the segment where this occurs in both vehicle path and topology coordinates, measures the geometric path deviation, packages this information, and publishes the findings.

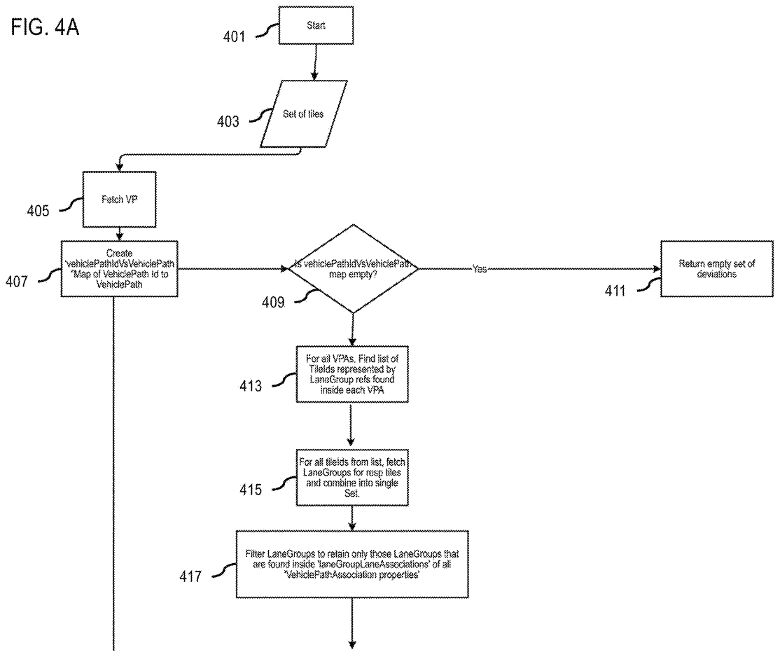

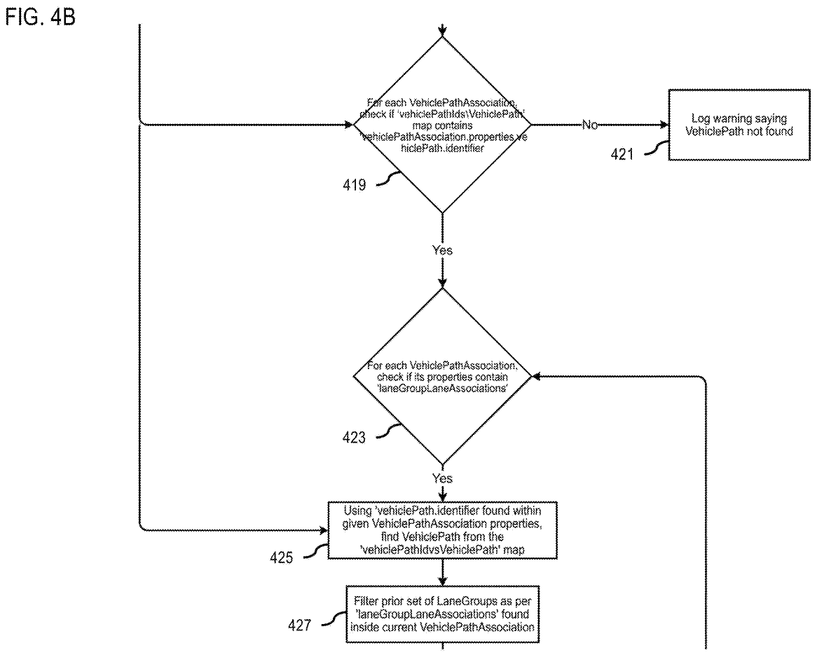

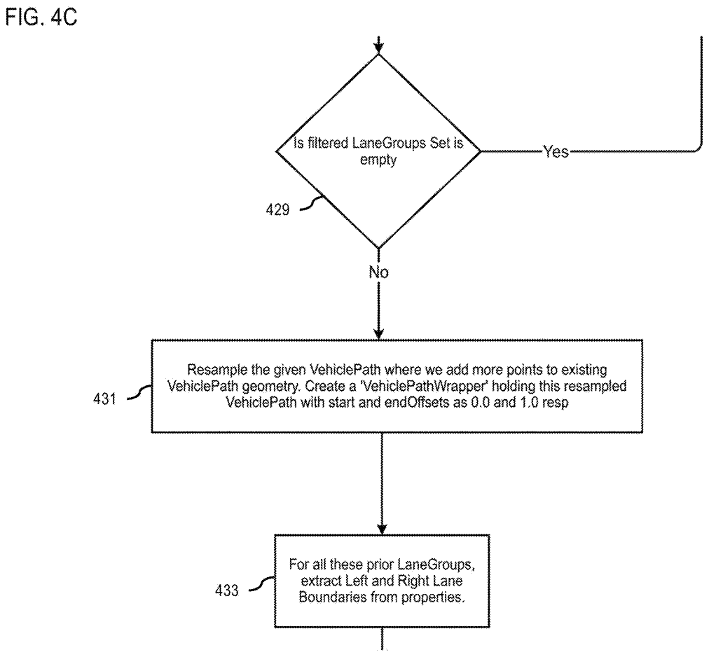

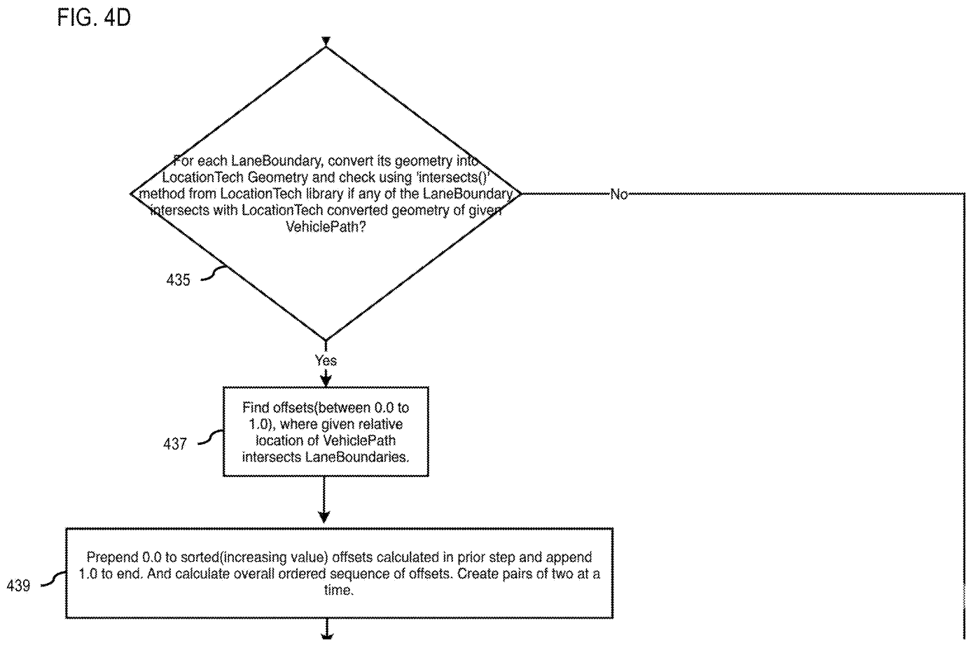

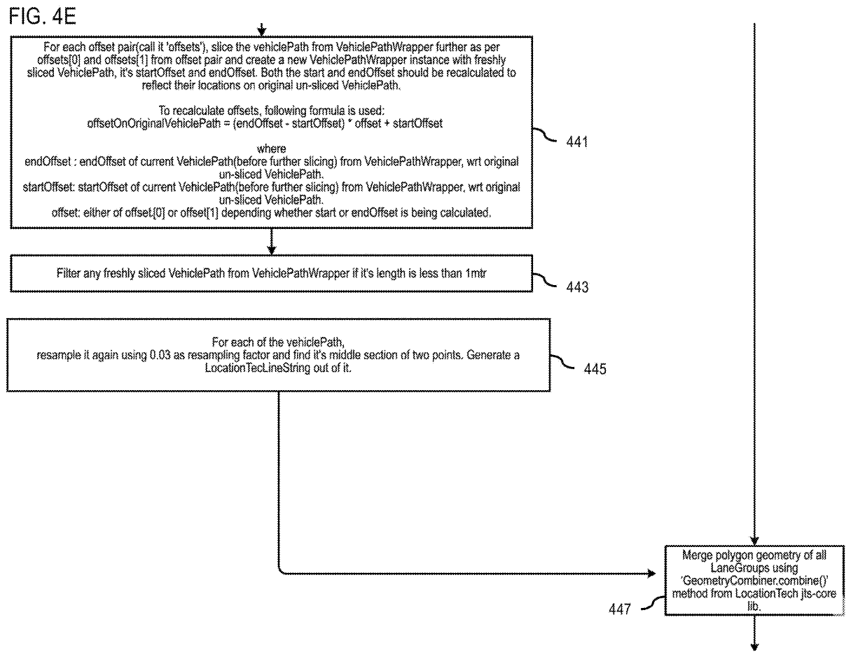

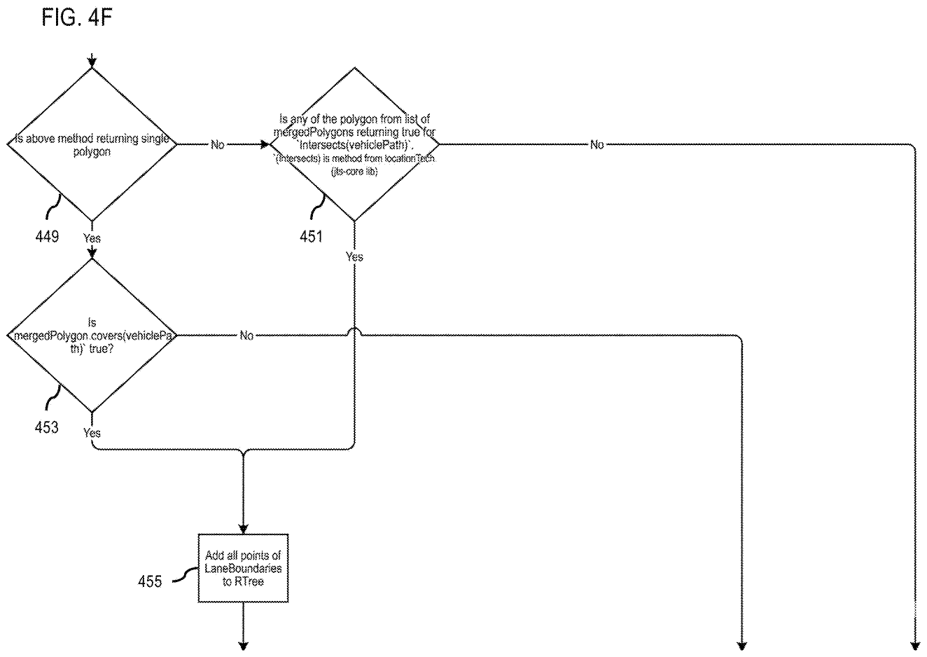

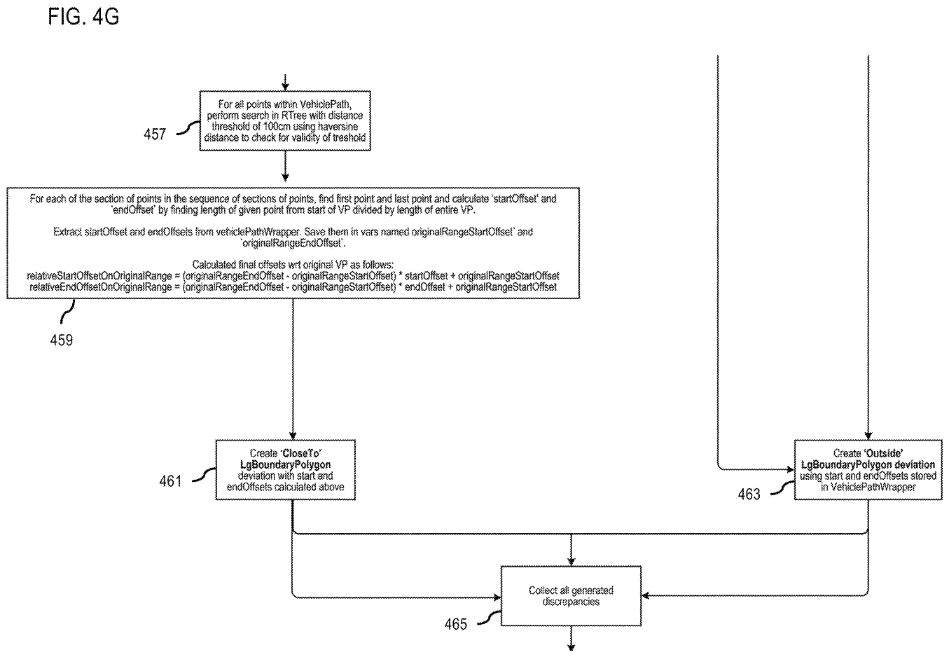

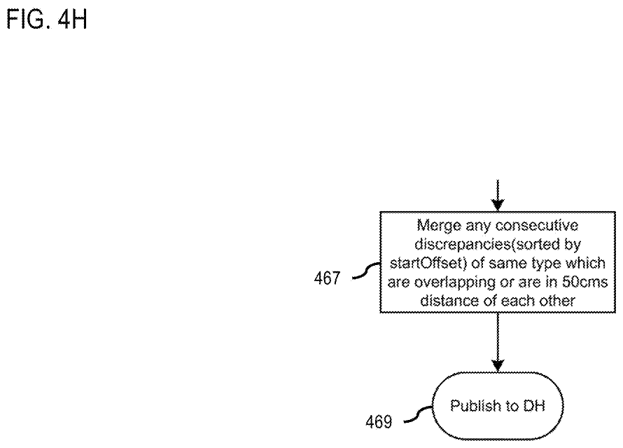

FIGS. 4A-4H are a flowchart of determining vehicle path discrepancy against road boundary seeded lane groups, according to one example embodiment. In various embodiments, the mapping platform 107 and/or any equivalent component may perform one or more portions of the process of FIGS. 4A-4H and may be implemented in, for instance, a chip set including a processor and a memory as shown in FIG. 17. As such, the mapping platform 107 can provide means for accomplishing various parts of the process, as well as means for accomplishing embodiments of other processes described herein in conjunction with other components of the system 100. Although the process of FIGS. 4A-4H is illustrated and described as a sequence of steps, it is contemplated that various embodiments of the process may be performed in any order or combination and need not include all of the illustrated steps.

FIGS. 4A-4H depict a single flowchart spread out over multiple figures. More specifically, the flowchart illustrates a flow of vehicle path discrepancy against road boundary seeded LaneGroup. This discrepancy shows the range of given VehiclePath where it comes to less than 100 cms (or any other designated threshold) from Road Boundaries defined by LaneGroup or goes outside them.

FIG. 4A illustrates the following.

This first part of the flowchart aims to identify discrepancies between a vehicle's path and road boundaries defined by associated LaneGroups.
(1) Start (block 401) & Tile Selection (block 403): The process initiates and selects a “Set of tiles,” defining the geographic areas for analysis.
(2) Fetch Vehicle Path Data (VP) (block 405): Vehicle path data relevant to the selected tiles is retrieved.
(3) Create Vehicle Path Lookup Map (block 407): A map (dictionary-like structure) called VehiclePathIdVsVehiclePath is created. It stores the fetched VehiclePath data, using the VehiclePath ID as the key for easy access.
(4) Check if Paths Exist (block 409): A decision point verifies if the VehiclePathIdVsVehiclePath map is empty.
   If YES (Empty) (block 411): No vehicle paths were found for the selected tiles. The process stops for this set of tiles and returns an empty set of deviations.
   If NO (Not Empty): Vehicle paths were successfully fetched, and the process continues.
(5) Identify Relevant Tile IDs from Vehicle Path (block 413): The system iterates through each fetched VehiclePath (VPA-likely Vehicle Path Attributes/Association). For each one, it examines properties related to associated LaneGroups (specifically looking for a LaneGroup refPath) to extract a list of relevant map TileIds.
(6) Fetch LaneGroup Data (block 415): Using the list of TileIds collected from all vehicle paths, the system fetches the corresponding LaneGroup data objects for those specific map tiles. All the fetched LaneGroups are combined into a single collection (a Set, to avoid duplicates).
(7) Filter Associated LaneGroups (block 417): This step filters the fetched LaneGroups. It retains only those LaneGroups that are explicitly referenced within the laneGroupLaneAssociations property found in the properties of the VehiclePathAssociation data. This ensures that the analysis uses only LaneGroup definitions directly linked to the vehicle paths being examined.
(8) Continue Processing: The flowchart proceeds downwards. At this stage, the system has successfully fetched the relevant vehicle path data and has identified and fetched the specific LaneGroup data objects that are directly associated with those vehicle paths. This prepared data is ready for the next steps, which will likely involve comparing the geometry of the vehicle paths against the boundaries defined within these filtered LaneGroups.

The process continues to FIG. 4B as follows.
(9) Iterative Validation (Vehicle Path Existence) (block 419): The process loops “For each VehiclePathAssociation” (derived from the vehicle paths fetched earlier). The first step within this loop is a decision: “Check if ‘VehiclePathIdVsVehiclePath’ map contains VehiclePathAssociation.properties.hidePath.identifier”. This verifies if the main lookup map (created in the first part of the flowchart) actually contains the data for the VehiclePath ID referenced by the current association being processed.
   If NO (block 421): The required VehiclePath data is missing in the lookup map. A warning is logged (“Log warning saying VehiclePath not found”), and the process likely skips this particular association.
   If YES: The corresponding VehiclePath data exists. The process continues to the next check for this association.
(10) Iterative Validation (LaneGroup Association Existence) (block 423): The next decision point checks “if its properties contain ‘laneGroupLaneAssociations’”. Still working with the current VehiclePathAssociation, this step ensures that the necessary property linking this path segment to specific LaneGroups actually exists within the association's data.
   If NO: The property is missing, meaning this path association cannot be linked to LaneGroups for the boundary check. The flow loops back (indicated by the arrow returning to the entry point of this loop), effectively skipping the remaining steps for this association and moving to the next one.
   If YES: The laneGroupLaneAssociations property exists. The process proceeds downwards for this association.
(11) Retrieve Specific Vehicle Path Data (block 425): Using the identifier found within the current VehiclePathAssociation.properties, the system explicitly retrieves the full VehiclePath data object from the VehiclePathIdVsVehiclePath map (which was confirmed to exist in an earlier step).
(12) Filter LaneGroups for Current Association (block 427): The process takes the “prior Set of LaneGroups” (the set that was filtered in the previous part of the flowchart based on all associations) and filters it again. This time, it keeps only those LaneGroups that are specifically listed within the laneGroupLaneAssociations property of the current VehiclePathAssociation being processed in the loop. This step isolates the exact LaneGroup(s) directly relevant to the specific segment or association being analyzed at this moment.
(13) Continue Processing: The flowchart exits downwards. Having successfully passed validation, retrieved the specific VehiclePath data, and identified the precise LaneGroup(s) applicable to this specific association, the process is now ready for the next stage. This stage will likely involve extracting boundary information from the identified LaneGroup(s) and comparing it geometrically with the retrieved VehiclePath data.

The process continues to FIG. 4C as follows.
(14) Check for Relevant LaneGroups (block 429): The first step is a decision point: “Is filtered LaneGroups Set empty?”. This checks if, after the final filtering performed in the previous stage (based on the current VehiclePathAssociation), any relevant LaneGroups actually remain associated with this specific segment of the vehicle path.
   If YES (Empty): No LaneGroups are specifically associated with this part of the path. Therefore, a boundary comparison cannot be performed. The process loops back (indicated by the arrow going upwards and likely rejoining the main loop for the next VehiclePathAssociation), skipping the analysis for the current segment.
   If NO (Not Empty): There is at least one relevant LaneGroup associated with this path segment. The process proceeds to prepare the geometric data for comparison.
(15) Resample Vehicle Path (block 431): The system proceeds to “Resample the given VehiclePath where we add more points to existing VehiclePath geometry.” This involves increasing the number of points defining the vehicle's path trajectory, typically through interpolation. This creates a higher-resolution or denser representation of the path, which is often beneficial for accurate geometric calculations like distance measurements. A VehiclePathWrapper object is created to hold this resampled path, marked with normalized start and end offsets (0.0 and 1.0).
(16) Extract Lane Boundaries (block 433): Next, the process iterates “For all these prior LaneGroups” (i.e., the non-empty set identified in step 1). For each relevant LaneGroup, it accesses its properties and extracts the geometric definitions for the “Left and Right Lane boundaries.” These represent the edges of the lanes or road as defined in the map data associated with the vehicle's path.
(17) Continue Processing: The flowchart arrow indicates the process moves to the next stage. At this point, the system has prepared the key geometric inputs required for the analysis:
   A detailed, high-resolution representation of the vehicle path segment (VehiclePathWrapper).
   The geometric lines representing the left and right boundaries associated with that path segment, extracted from the relevant LaneGroup(s).

The process continues to FIG. 4D as follows.
(18) Intersection Check (Core Geometric Test) (block 435): The process enters a decision diamond that performs the main geometric check.
   It iterates through “each LaneBoundary” (left and right) extracted previously.
   It converts the boundary's geometry and the resampled vehicle path's geometry into a compatible format (specified as “LocationTech Geometry”).
   It uses an intersects( ) method (from a “LocationTech library”) to determine if any part of the LaneBoundary geometry physically intersects with the VehiclePath geometry.
   If NO: Neither the left nor the right boundary intersects the vehicle path. This implies the path remained entirely between the defined boundaries for this segment. The process follows the “No” path, exiting to the right and likely looping back to process the next VehiclePathAssociation, as no boundary crossing deviation occurred here.
   If YES: At least one boundary (left or right) intersects the vehicle path. This indicates the vehicle crossed or touched a lane boundary. The process follows the “Yes” path downwards for further analysis.
(19) Identify Intersection Locations (Offsets) (block 437): Since an intersection occurred, this step pinpoints where along the vehicle path these intersections happened.
   It finds the specific “offsets” (normalized positions between 0.0 and 1.0 along the resampled vehicle path) where the path geometry intersects the LaneBoundary geometries. This yields a list of points marking boundary crossings.
(20) Segment the Path by Intersections (block 439): This step uses the intersection points to divide the vehicle path segment into smaller pieces based on boundary crossings.
   It takes the list of intersection offsets calculated previously and sorts them in increasing order.
   It adds the start offset 0.0 to the beginning of this sorted list.
   It adds the end offset 1.0 to the end of the list.
   It then creates consecutive pairs from this augmented list (e.g., (0.0, offset1), (offset1, offset2), . . . , (offsetN, 1.0)). Each pair defines a continuous sub-segment of the vehicle path. These sub-segments represent portions of the path either between boundary crossings, or between the start/end of the segment and the first/last crossing.
(21) Continue Processing: The flowchart arrow points downwards. The process now has the vehicle path divided into specific sub-segments based on where it intersected the lane boundaries. This segmentation is crucial for the next stage, which will likely involve analyzing each sub-segment to determine if the vehicle was inside or outside the boundaries during that interval and calculating the proximity (distance) to the boundaries, especially for segments where no crossing occurred but the path might have come close (as per the initial problem description).

The process continues to FIG. 4E as follows.
(22) Process Sub-segments (block 441): The flowchart iterates “For each offset pair (offset (i), offset (i+1))” which defines a sub-segment identified in the previous step.
   Slice Geometry: It “slice [s] the VehiclePath Wrapper further” to extract the specific geometry corresponding to the current sub-segment (offset (i), offset (i+1)). A new, temporary VehiclePathWrapper instance is created for this “freshly sliced VehiclePath.”
   Recalculate Original Offsets: The start and end offsets of this sub-segment are recalculated to represent their positions on the “original un-sliced VehiclePath.” A formula is provided to map the normalized offsets (relative to the potentially resampled segment analyzed earlier) back to the coordinate system of the original path data.
(23) Filter Short Segments (block 443): Any “freshly sliced VehiclePath” whose calculated length is less than a threshold (e.g., 1 meter) is filtered out and discarded. This prevents further processing of negligible segments.
(24) Find Mid-Segment Representative (block 445): For each remaining (non-filtered) sub-segment:
   It is resampled again very finely (e.g., “using 0.03 as resampling factor”).
   The system finds the “middle section of two points” within this finely resampled sub-segment.
   A “Location TechLineString” object is generated from these two middle points. This creates a short line segment representing the central part of the vehicle path within this sub-segment, likely used for subsequent distance calculations.
(25) Merge LaneGroup Boundaries (block 447): In parallel (or preparation for the next step), the system takes the polygon geometry of all the LaneGroups that were deemed relevant earlier (the filtered set associated with the current VehiclePathAssociation) and merges them into a single geometric shape. It uses a specific library function (GeometryCombiner.combine( ) from LocationTech.jts-core) for this task. This results in one unified polygon representing the combined valid area or boundaries defined by the associated LaneGroups.
(26) Continue Processing: The flowchart proceeds, carrying forward two key pieces of information:
   The representative LineString from the middle of each relevant vehicle path sub-segment.
   The single, merged polygon representing the overall LaneGroup boundaries for this section.

The process continues to FIG. 4F as follows:
(26) Check Polygon Merge Result (block 449): The first decision point evaluates the outcome of the boundary merging step from the previous flowchart section (“Is above method returning single polygon?”).
   If YES (Single Polygon): The LaneGroup boundaries were successfully merged into one contiguous polygon. The process proceeds down the ‘Yes’ path to the next check (Step 3).
   If NO (Multiple/No Polygons): The merging resulted in multiple separate polygons or failed. The process proceeds down the ‘No’ path to handle this case (Step 2).
(27) Check Intersection (Multiple Polygons Case) (block 451): This step applies if the merge resulted in a list of polygons. It asks: “Is any of the polygon from list of mergedPolygons returning true for intersects (vehiclePath)?”.
   It checks if the vehicle path segment (likely the representative LineString) intersects any of the polygons in the list.
   If NO: The path does not intersect any of the boundary pieces. The process exits to the right, likely skipping detailed analysis for this segment as no crossing occurred.
   If YES: The path intersects at least one of the boundary polygons. The process continues downwards to the final preparation step (Step 5), indicating a boundary crossing occurred.
(28) Check Coverage (Single Polygon Case) (block 453): This step applies if the merge resulted in a single polygon. It asks: “Is mergedPolygon.covers (vehiclePath) true?”.
   It checks if the single merged boundary polygon completely contains the vehicle path segment within its boundaries.
   If YES: The path is entirely inside the defined lane boundaries. The process exits to the right, likely skipping detailed analysis for this segment as no violation occurred.
   If NO: The path is not entirely inside the polygon; it either touches the boundary or goes outside. The process continues downwards to the final preparation step (Step 5), indicating a potential discrepancy.
(29) Prepare for Distance Calculation (block 455): This step (“Add all points of LaneBoundaries to RTree”) is reached only if a potential discrepancy was identified in the previous checks (i.e., the path intersected one of multiple boundary polygons OR the path was not fully covered by the single merged polygon).
   It takes all the individual points that define the original Left and Right “LaneBoundaries” (extracted before the merging step).
   It inserts these points into a spatial index data structure called an “RTree.” An R-tree organizes spatial data for efficient searching, particularly for finding nearest neighbors.
(30) Continue Processing: The flowchart exits downwards from the R-tree creation step. By creating the R-tree containing the boundary points, the system is now prepared for the final calculation: efficiently finding the minimum distance between points on the relevant vehicle path sub-segment and the nearest point on the lane boundaries using the R-tree index. This distance will then be compared against the predefined threshold (e.g., 100 cm) to determine if a discrepancy should be reported.

The process continues to FIG. 4G as follows.
(31) Proximity Calculation (block 457): The process takes the vehicle path segments identified as potentially problematic (intersecting or not fully covered by the merged LaneGroup polygon) and the R-tree containing the boundary points.
   It iterates “For all points within VehiclePath” (referring to the points of the relevant sub-segment).
   For each point, it “perform [s] search in RTree” to find the nearest boundary point(s).
   It calculates the distance (specified as “haversine distance,” though likely Euclidean in practice for local analysis) between the path point and the nearest boundary point.
   It checks if this distance is less than the specified “distance threshold of 100 cm”. This identifies all points on the vehicle path that are closer to a lane boundary than the allowed threshold.
(32) Identify and Define ‘CloseTo’ Discrepancy Ranges (block 459):
   The system identifies continuous sequences of points along the path that violated the 100 cm threshold.
   For each such sequence, it finds the first and last points.
   It then calculates the startOffset and endOffset corresponding to these first and last points. The description indicates these offsets are calculated relative to the entire original VehiclePath (by comparing path length to the point vs. total path length, or using a recalculation formula provided which maps sub-segment offsets back to the original path's coordinate system based on the sub-segment's own start/end relative to the original). Let's call these finalStartOffset and finalEndOffset.
(33) Create ‘CloseTo’ Deviation Records (block 461): For each sequence identified and processed in the previous step, the system creates a specific type of discrepancy record: “CloseTo LgBoundaryPolygon deviation”. This record stores the calculated finalStartOffset and finalEndOffset, marking the segment along the original VehiclePath where the vehicle came too close to the boundary.
(34) Create ‘Outside’ Deviation Records (block 463): An alternative path comes from the right side (e.g., representing segments as being definitively outside the boundaries, e.g., failing the mergedPolygon.covers (vehiclePath) check). This path leads to the creation of “Outside LgBoundaryPolygon deviation” records. These records use start and end offsets stored in the VehiclePathWrapper (presumably representing the entire sub-segment that was outside).
(35) Collect Discrepancies (block 465): All the deviation records generated-both the ‘CloseTo’ records (proximity violations) and the ‘Outside’ records (boundary crossing violations)—are gathered together in a central collection step: “Collect all generated discrepancies.”
(36) Final Output: This collection of discrepancy records represents the final output of the analysis. It contains details of all segments along the original vehicle paths where the path either went outside the boundaries defined by the associated LaneGroups or came closer to those boundaries than the specified threshold (100 cm). The flowchart likely concludes here or with a subsequent step to publish or store this collected information.

The process continues to FIG. 4H as follows.
(37) Input: The process begins with the collection of all ‘CloseTo’ and ‘Outside’ discrepancy records generated in the previous stages.
(38) Merge Consecutive/Close Discrepancies (block 467): This step performs a post-processing consolidation of the collected discrepancies.
   The discrepancy records are first sorted by their startOffset.
   The system then iterates through the sorted list, looking for consecutive discrepancies of the same type (e.g., two ‘CloseTo’ records one after the other, or two ‘Outside’ records).
   If two consecutive discrepancies of the same type either overlap in their defined ranges or are very close to each other (the gap between the end of the first and the start of the second is within a small threshold, specified as “50 cms distance”), they are merged into a single, longer discrepancy record.
   This step helps to clean up the results by combining potentially fragmented small violations into more significant, continuous events.
(39) Publish to DH (block 469): This is the final action in the workflow. The processed list of discrepancies (now potentially merged and consolidated) is “Publish [ed] to DH.” This means the final results, detailing the segments where the vehicle path violated boundary conditions (either proximity or crossing), are sent to a designated system or database (“DH”) for storage, reporting, or further action.
(40) End: This step concludes the entire process described in this multi-part flowchart.

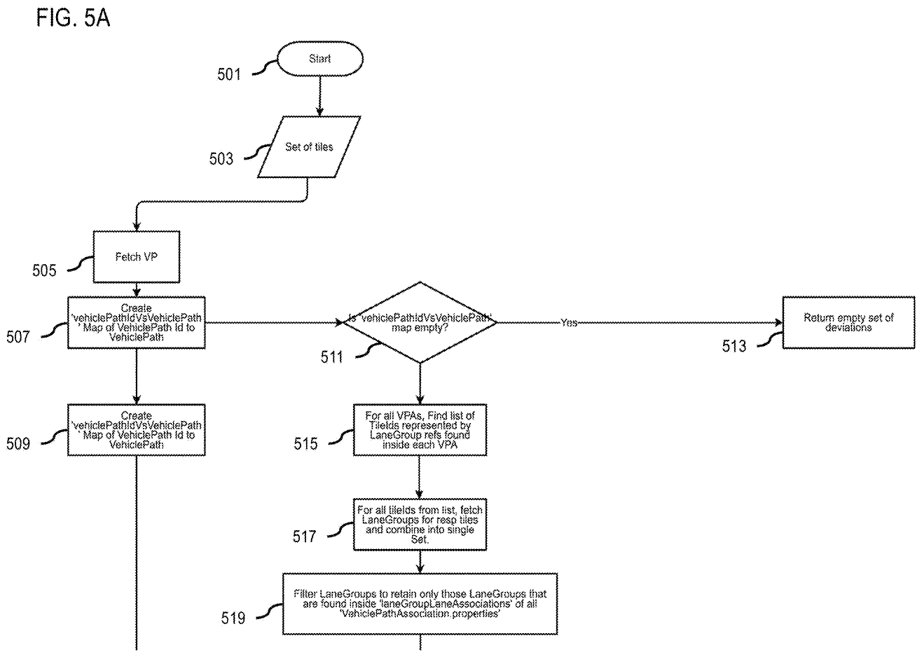

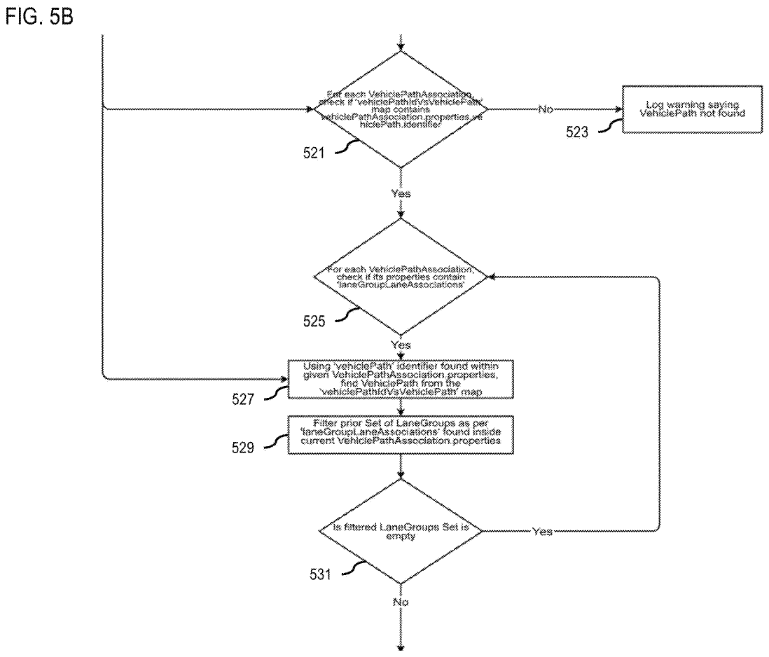

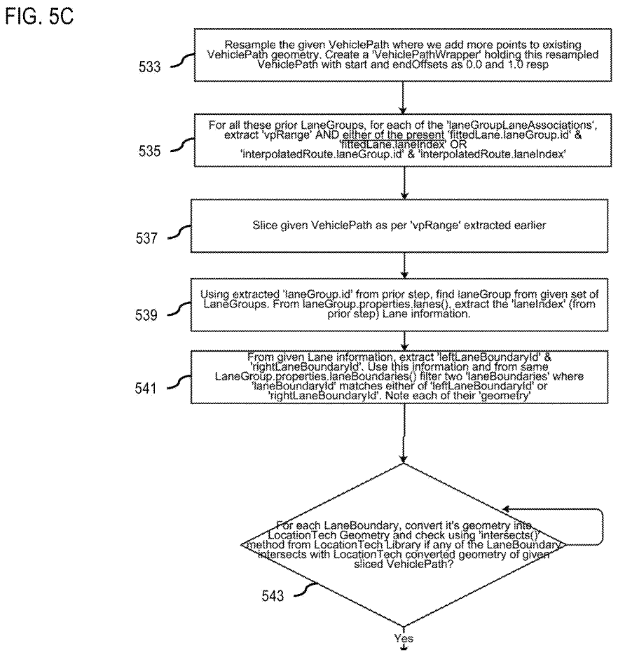

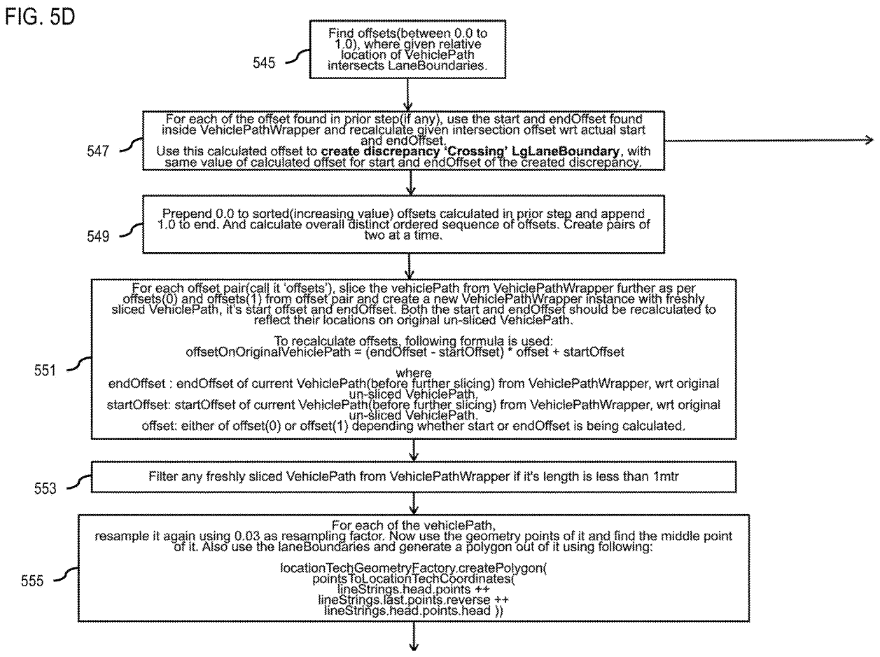

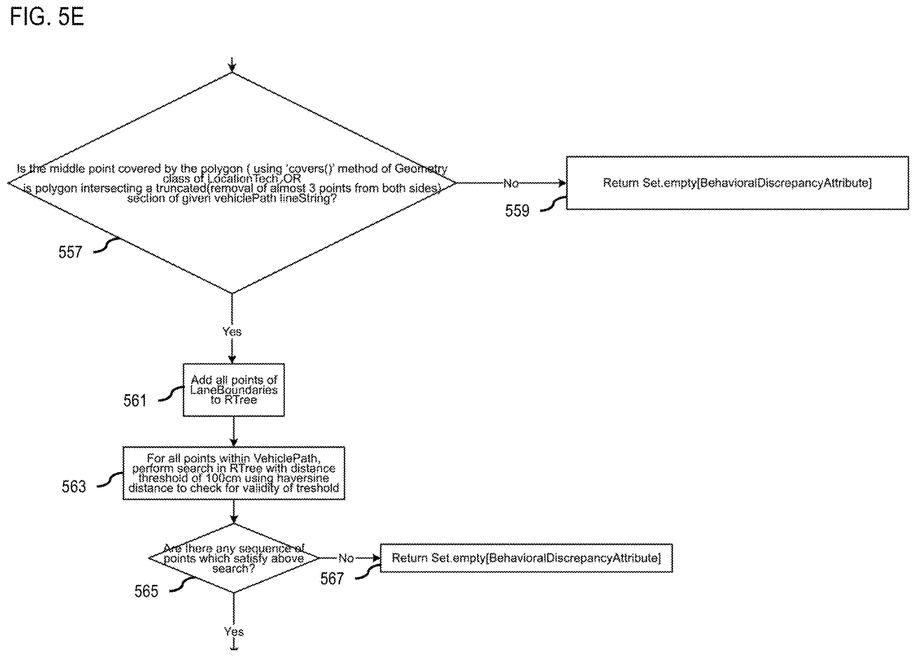

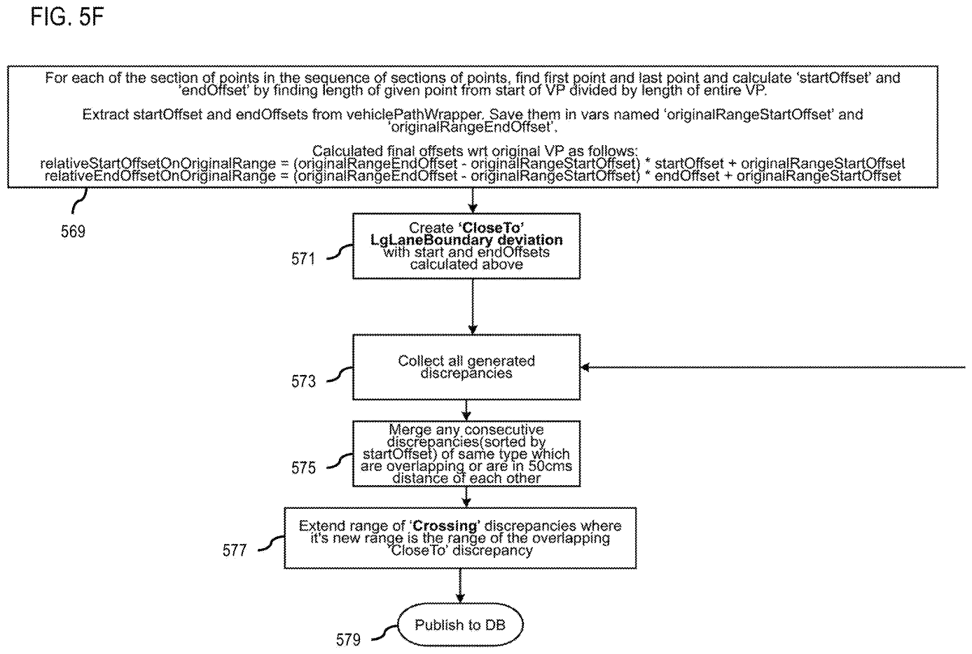

FIGS. 5A-5F is a flowchart of determining vehicle path discrepancy against lane boundary seeded lane groups, according to one example embodiment. In various embodiments, the mapping platform 107 and/or any equivalent component may perform one or more portions of the process of FIGS. 5A-5F and may be implemented in, for instance, a chip set including a processor and a memory as shown in FIG. 17. As such, the mapping platform 107 can provide means for accomplishing various parts of the process, as well as means for accomplishing embodiments of other processes described herein in conjunction with other components of the system 100. Although the process of FIGS. 5A-5F is illustrated and described as a sequence of steps, it is contemplated that various embodiments of the process may be performed in any order or combination and need not include all of the illustrated steps.

FIGS. 5A-5F depict a single flowchart spread out over multiple figures. More specifically, the flowchart illustrates a flow of vehicle path discrepancy against lane boundary seeded LaneGroup. This discrepancy shows the range of given VehiclePath where it comes to less than 100 cms (or any other designated distance threshold) from Lane Boundary defined within LaneGroup feature or goes outside them.

FIG. 5A illustrates the following.
(1) Start (block 501) & Tile Selection (block 503): The process begins and selects a “Set of tiles,” which defines the specific geographic areas for the analysis.
(2) Fetch Vehicle Path (VP) (block 505): It retrieves the relevant vehicle path data corresponding to the selected map tiles.
(3) Create Vehicle Path Lookup Map (blocks 507 and 509): A data structure (e.g., a dictionary or hash map) called VehiclePathIdVsVehiclePath is created. This maps the unique ID of each fetched VehiclePath to its corresponding data object, allowing for efficient retrieval later.
(4) Check if Paths Were Found (block 511): A decision step checks if the VehiclePathIdVsVehiclePath map is empty.
   If YES (block 513): No vehicle paths were fetched for the specified tiles. The process concludes for this set of tiles by returning an “empty set of deviations.”
   If NO: Vehicle paths were found, and the process continues.
(5) Identify Relevant Tile IDs from VP Data (block 515): The system iterates through each fetched Vehicle Path (VPA-Vehicle Path Attributes or Association). Within each VPA's data, it looks for references (refPath) associated with LaneGroup features and extracts the corresponding map tile identifiers (TileIds). This identifies the specific map tiles containing the LaneGroup data relevant to the vehicle paths.
(6) Fetch Relevant LaneGroup Data (block 517): Using the list of collected TileIds, the system fetches the actual LaneGroup data objects for those respective tiles from the map data source. All the fetched LaneGroups are combined into a single collection (a Set, which handles duplicates).
(7) Filter LaneGroups by Association (block 519): This crucial step filters the fetched LaneGroups. It retains only those LaneGroups that are explicitly listed or referenced within the laneGroupLane Associations property found inside the properties of the relevant VehiclePathAssociation data. This ensures that only LaneGroups directly linked to the vehicle paths under analysis are considered further.
(8) Continue Processing: The flowchart proceeds downwards. At the end of this portion, the system has successfully gathered the necessary vehicle path data and filtered the associated LaneGroup data to include only those directly relevant to the paths. This prepared dataset is now ready for the subsequent steps, which will involve extracting the specific lane boundary information from these LaneGroups and comparing it with the vehicle path geometry.

The process continues to FIG. 5B as follows.
(9) Iterative Validation (Vehicle Path Existence) (block 521): The process loops through each “VehiclePathAssociation” (segments or links related to the fetched vehicle paths). The first check inside this loop is a decision: “Check if′VehiclePathIdVsVehiclePath′ map contains VehiclePathAssociation.properties.hidePath.identifier”. This validates if the main vehicle path lookup map holds the data for the specific VehiclePath ID linked to the current association.
   If NO (block 523): The necessary VehiclePath data isn't found. A warning “Log warning saying VehiclePath not found” is issued, and processing likely skips this association.
   If YES: The VehiclePath data exists. The process continues to the next validation step for this association.
(10) Iterative Validation (LaneGroup Association Existence) (block 525): The second decision point checks “if its properties contain ‘laneGroupLaneAssociations’”. This verifies if the current VehiclePathAssociation object actually includes the property that links it to the relevant LaneGroups needed for the lane boundary analysis.
   If NO: This essential linking property is missing. The flow loops back (arrow points upwards and left), effectively skipping the rest of the steps for this association and moving to the next one.
   If YES: The property exists. The process proceeds downwards.
(11) Retrieve Specific Vehicle Path Data (block 527): Using the identifier from the current VehiclePathAssociation.properties, the system explicitly retrieves the full VehiclePath data object from the VehiclePathIdVsVehiclePath map.
(12) Filter LaneGroups for Current Association (block 529): The “prior Set of LaneGroups” (filtered in the first part of the flowchart based on all associations) is filtered again. This time, it only keeps LaneGroups specifically listed within the laneGroupLaneAssociations property of the current VehiclePathAssociation. This isolates the exact LaneGroup(s) relevant to the specific path segment being processed.
(13) Check if Relevant LaneGroups Remain (block 531): A final decision step for this section asks: “Is filtered LaneGroups Set empty?”. This checks if the second filtering step (Step 4) resulted in no associated LaneGroups for this specific VehiclePathAssociation.
   If YES: No relevant LaneGroups were found for this specific association after the second filter. The flow loops back (arrow points upwards and right), skipping the detailed boundary analysis for this association and moving to the next one.
   If NO: At least one relevant LaneGroup is confirmed to be associated with this specific part of the vehicle path. The process proceeds downwards to the next stage.
(14) Continue Processing: The flowchart continues off the bottom of the image. At this point, for a specific VehiclePathAssociation, the system has validated data existence, retrieved the specific VehiclePath object, and confirmed there is at least one precisely relevant LaneGroup associated with it. The next steps will involve extracting the lane boundary information from these specific LaneGroups.

The process continues to FIG. 5C as follows.
(15) Input: The process starts with the specific VehiclePath object and the non-empty, filtered set of LaneGroup(s) associated with the current VehiclePathAssociation.
(16) Resample Vehicle Path (block 533): Just like in the “Road Boundary” flowchart, this step “Resample [s] the given VehiclePath where we add more points to existing VehiclePath geometry.” The path's trajectory is made more detailed by adding interpolated points. This higher-resolution path is then stored in a VehiclePathWrapper object, which also includes normalized start (0.0) and end (1.0) offsets representing the segment being analyzed.
(17) Extract Individual Lane Boundary Geometries (blocks 535): The next step is “For all these prior LaneGroups, extract geometry for each LaneBoundary for given LaneGroup from properties.”
   It iterates through the relevant LaneGroup(s) identified previously (block 537).
   For each LaneGroup, it accesses its properties to retrieve the geometric definitions of each individual Lane Boundary contained within it (block 539). This is subtly different from the previous flowchart which mentioned extracting “Left and Right” boundaries (block 541); this step focuses on potentially multiple individual lane line geometries within the group.
(18) Continue Processing: The flowchart arrow indicates the process moves to the next stage. At this point, the necessary geometric data has been prepared for the core analysis:
   A detailed, high-resolution representation of the vehicle path segment (VehiclePathWrapper).
   The specific geometries of all individual Lane Boundaries associated with this path segment, extracted from the relevant LaneGroup(s) (block 541).

The process continues to FIG. 5D as follows.
(19) Find Intersection Locations (Offsets) (block 545): The first step is to “Find offsets (between 0.0 to 1.0) where given relative location of VehiclePath intersects LaneBoundaries.” This calculation identifies the precise normalized positions along the resampled vehicle path where its geometry crosses any of the extracted lane boundary geometries.
(20) Create ‘Crossing’ Discrepancy Records (block 547): “For each of the offset found in prior step( . . . ) Use this calculated offset to create discrepancy ‘Crossing’ LgLaneBoundary, with same value of calculated offset for start and endOffset . . . ”. For every individual intersection point identified by an offset in the previous step, a specific type of discrepancy record, “Crossing LgLaneBoundary”, is immediately generated. This record marks the exact point of the lane crossing, using the intersection offset value for both the start and end offset of the record itself.
(21) Segment Path Based on Crossings (block 549): “Prepend 0.0 to sorted (increasing value) offsets calculated in prior step and append 1.0 to end . . . . Create pairs of two at a time.” This step takes the list of intersection offsets, sorts them, adds the segment's start (0.0) and end (1.0) markers, and creates pairs of consecutive offsets. Each pair (offset i, offset_{i+1}) now defines a continuous sub-segment of the vehicle path between lane boundary crossings (or between an endpoint and a crossing).
(22) Process Sub-segments (Between Crossings) (block 551): The flowchart then processes each of these sub-segments defined by the offset pairs:
   Slice Geometry & Recalculate Original Offsets: The geometry for the sub-segment is extracted (“sliced”) from the VehiclePathWrapper. Its start and end offsets are recalculated relative to the original, un-sliced VehiclePath using the provided formula, mapping them back to the original path's coordinate system.
   Filter Short Segments (block 553): Any sub-segment shorter than a threshold (1 meter) is discarded.
(23) Prepare for Proximity Check (block 555): For each remaining, valid sub-segment (representing a portion of the path between lane crossings):
   Find Midpoint: The sub-segment is resampled again finely, and its geometric “middle point” is identified.
   Create Lane Corridor Polygon: Using the points from the associated laneBoundaries (specifically mentioned are lineStrings.head and lineStrings.last), a polygon geometry is constructed. The formula suggests taking points from one boundary, appending points from another boundary in reverse order, and closing the loop, likely creating a polygon representing the lane area or corridor itself.
(24) Continue Processing: The flowchart proceeds downwards. It has now:
   Generated specific “Crossing LgLaneBoundary” records for each point where the path crossed a lane boundary.
   Processed the path segments between these crossings.
   For each significant “between-crossing” segment, it has prepared a representative middle point and a polygon defining the lane corridor.

The process continues to FIG. 5E as follows.
(25) Input: The process receives the representative middle point of a vehicle path sub-segment (which lies between crossings) and the polygon representing the lane corridor for that area, along with the original lane boundary geometries.
(26) Initial Geometric Checks (block 557): A decision diamond performs checks to determine if the path segment is generally within the lane corridor:
   It checks if the “middle point covered by the polygon” using a covers( ) method.
   It also checks if the “polygon intersecting a truncated . . . section of given vehiclePath lineString”. This seems to verify that the overall path segment interacts spatially with the lane corridor polygon.
   If NO (block 559): If the middle point isn't covered OR the polygon doesn't intersect the path segment, it suggests the segment is either outside the main corridor or has some other geometric anomaly. In this case, the process exits for this segment, returning an “empty Set [BehavioralDiscrepancyAttribute]”, meaning no proximity violation is assessed here (crossings/outside status might have been determined earlier).
   If YES: If the middle point is covered AND the polygon intersects the path segment, it confirms the path segment is generally inside the lane corridor, making it a candidate for a proximity check. The process proceeds downwards.
(27) Prepare for Proximity Calculation (block 561): “Add all points of LaneBoundaries to RTree”. For segments confirmed to be inside the corridor, this step takes all the points defining the individual lane boundaries (extracted earlier) and builds a spatial index structure (an RTree) from them. This allows for very efficient searching for the nearest boundary point later.
(28) Calculate Distances to Boundaries (block 563): “For all points within VehiclePath, perform search in RTree with distance threshold of 100 cm using haversine distance . . . ”.
   The system iterates through the points of the current vehicle path sub-segment.
   For each point, it uses the RTree to efficiently find the nearest point(s) on any of the lane boundaries.
   It calculates the distance between the path point and its nearest boundary point (using the specified distance metric).
   It compares this distance to the defined proximity threshold (e.g., 100 cm).
(29) Check if Threshold Met (block 565): The final decision diamond asks: “Are there any sequence of points which satisfy above search?”. It checks if the previous step found any points along the sub-segment that were closer to a lane boundary than the 100 cm threshold.
   If NO (block 567): No points violated the proximity threshold. The vehicle path maintained sufficient clearance from the lane boundaries throughout this segment.
   The process exits this segment, returning an “empty Set [BehavioralDiscrepancy Attribute]”.
   If YES: One or more points were found to be closer than 100 cm. This signifies a “CloseTo” type of discrepancy. The process continues downwards to the next stage, which will involve defining the range of this proximity violation and creating the appropriate discrepancy record.

The process continues to FIG. 5F as follows.
(30) Define ‘CloseTo’ Discrepancy Ranges (block 569):
   The process takes the sequences of points previously identified as violating the proximity threshold (being closer than 100 cm to a boundary).
   For each continuous sequence, it finds the first and last points.
   It then calculates the start (finalStartOffset) and end (finalEndOffset) offsets corresponding to these first and last points, mapping their positions back relative to the original, un-sliced VehiclePath using the provided recalculation logic/formula.
(31) Create ‘CloseTo’ Deviation Records (block 571): For each proximity violation sequence identified and mapped in the previous step, a “CloseTo LgLaneBoundary deviation” record is created. This record stores the finalStartOffset and finalEndOffset, defining the precise segment along the original VehiclePath where the vehicle was too close to a lane boundary.
(32) Collect All Discrepancies (block 573): All discrepancy records generated throughout the entire process are gathered together. This includes:
   The “Crossing LgLaneBoundary” records (marking exact intersection points).
   The “CloseTo LgLaneBoundary” records (marking proximity violation ranges from the step above).
(33) Merge Consecutive/Close Discrepancies (bock 575): The collected list undergoes a consolidation step.
   Discrepancies are sorted by their start offset.
   Consecutive discrepancies of the same type (e.g., two CloseTo events) are merged into one longer event if their ranges overlap or the gap between them is very small (within “50 cms distance”). This simplifies the output by combining minor, adjacent violations.
(34) Extend ‘Crossing’ Discrepancy Ranges (block 577): A specific rule is applied: “Extend range of ‘Crossing’ discrepancies where it's new range is the range of the overlapping ‘CloseTo’ discrepancy.” If a point-like Crossing event occurs within or overlaps with a range-based CloseTo event, the Crossing record's range is expanded to match the CloseTo record's range. This links the act of crossing directly to the period of proximity surrounding it.
(35) Publish Results (block 577): Finally, the processed, potentially merged, and adjusted list of lane boundary discrepancies is “Publish [ed] to DH.” This sends the final findings, detailing where the vehicle path crossed or came too close to lane boundaries, to the target system (“DH”).
(36) End: This step marks the completion of the flowchart's execution.

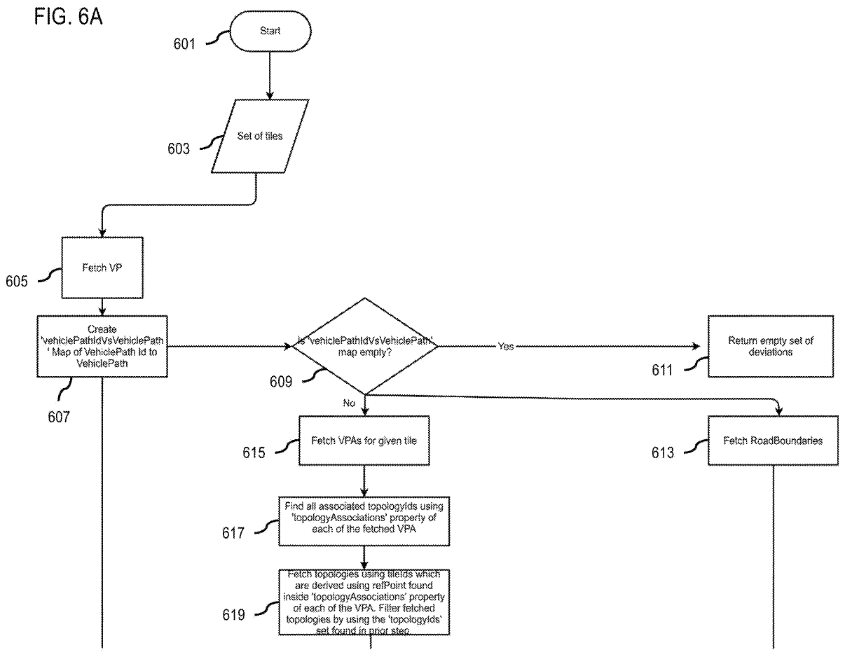

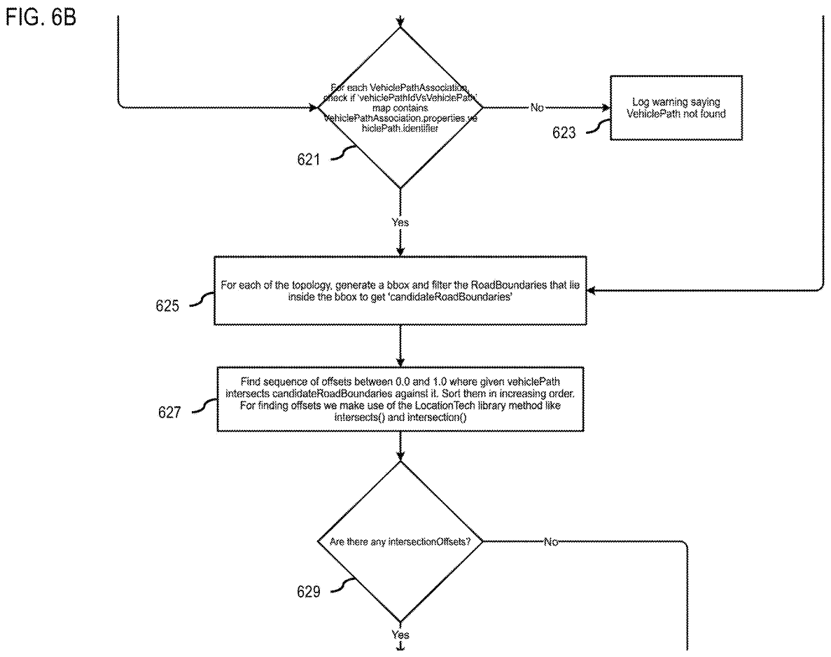

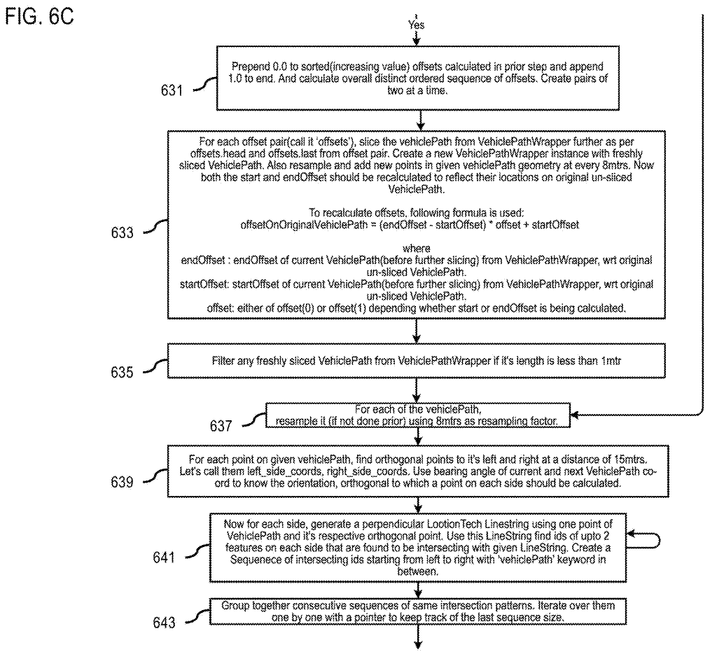

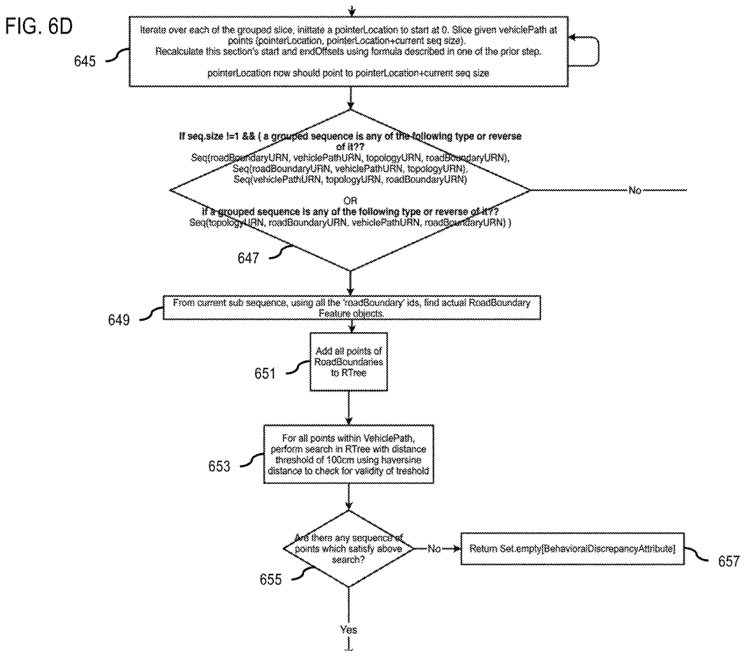

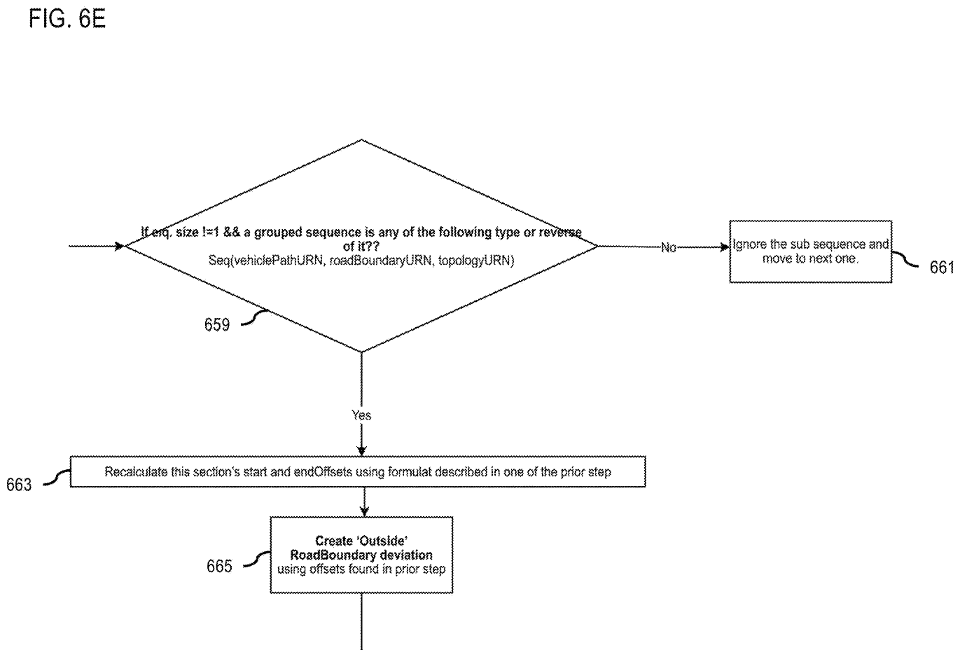

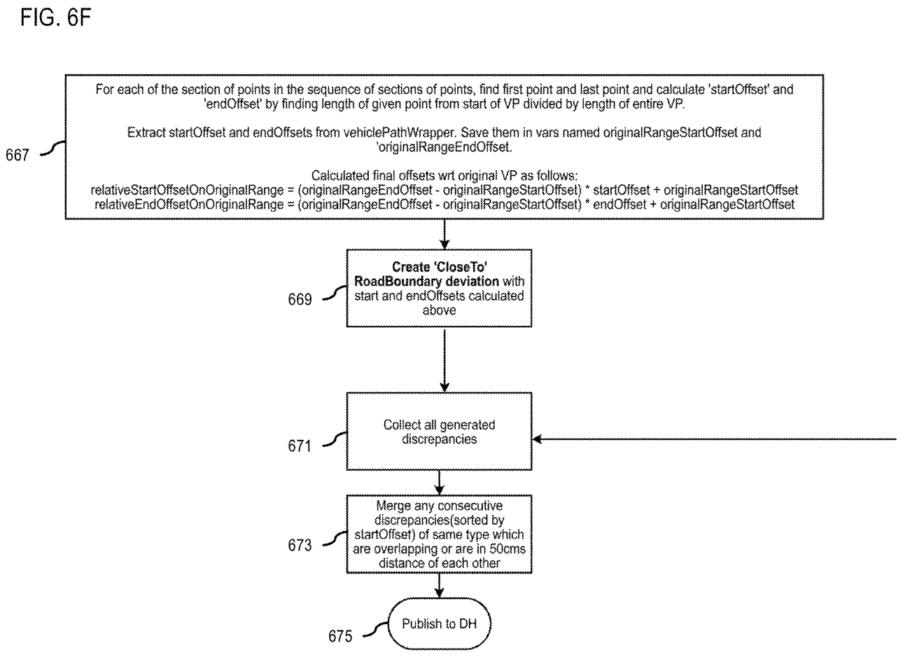

FIGS. 6A-6E is a flowchart of determining vehicle path discrepancy against Road Boundary Observable (Road Side Detection (RSD)), according to one example embodiment. In various embodiments, the mapping platform 107 and/or any equivalent component may perform one or more portions of the process of FIGS. 6A-6E and may be implemented in, for instance, a chip set including a processor and a memory as shown in FIG. 17. As such, the mapping platform 107 can provide means for accomplishing various parts of the process, as well as means for accomplishing embodiments of other processes described herein in conjunction with other components of the system 100. Although the process of FIGS. 6A-6E is illustrated and described as a sequence of steps, it is contemplated that various embodiments of the process may be performed in any order or combination and need not include all of the illustrated steps.

FIGS. 6A-6E depict a single flowchart spread out over multiple figures. More specifically, the flowchart illustrates a flow of vehicle path discrepancy against RSD observable (road boundary). This discrepancy shows the range of given VehiclePath where it comes to less than 100 cms (or any other designated distance threshold) from Road Boundary observable feature or goes outside them.

FIG. 6A illustrates the following.
(1) Start (block 601) & Tile Selection (block 603): The process begins and selects a “Set of tiles,” defining the geographic regions for this analysis.
(2) Fetch Vehicle Path (VP) (block 605): It retrieves the relevant VehiclePath data corresponding to the selected map tiles.
(3) Create Vehicle Path Lookup Map (block 607): A map (VehiclePathIdVsVehiclePath) is created to store the fetched VehiclePath data, using the VehiclePath ID as the key for easy retrieval.
(4) Check if Paths Exist (block 609): A decision point checks if any VehiclePaths were successfully fetched (i.e., if the map created above is empty).
   If YES (Empty) (block 611): No paths were found. The process terminates for these tiles, returning an “empty set of deviations.”
   If NO (Not Empty): Paths were found. The process proceeds along two parallel-looking branches.
(5) Fetch Vehicle Path Associations (VPAs) & Topology (block 613): This branch focuses on fetching related contextual data:
   Fetch VPAs for given tile: It retrieves Vehicle Path Associations/Attributes (VPAs) relevant to the current tile.
   Find associated topologyIds: It examines the fetched VPAs to find topologyIds listed in their Topology Associations property. These IDs link the VPAs to standard map topology segments.
   Fetch topologies: Using the topologyIds and tile information (derived from refPoint within the associations), it fetches the actual corresponding topology data segments from the map data source.
(6) Fetch Observable Road Boundaries (block 615): This branch runs in parallel or concurrently with the VPA/Topology fetching. It directly “Fetch [es] RoadBoundaries” (block 617). Given the context “RSD observable (road boundary),” these are not static map definitions but rather boundary geometries derived from prior analysis of aggregated Road Segment Data (RSD), representing observed or inferred road edges (block 619).
(7) Continue Processing: The flowchart structure implies that after this stage, the system has collected several key datasets for the selected tiles:
   The VehiclePath data.
   The associated VPAs and corresponding Topology map data segments.
   The RSD-derived observable RoadBoundary data.

The process continues to FIG. 6B as follows.
(8) Iterative Validation (Vehicle Path Existence) (block 621): The process appears to iterate, likely processing “For each VehiclePathAssociation” or related topology segment. The first step is a decision: “Check if ‘VehiclePathIdVsVehiclePath’ map contains VehiclePathAssociation.properties.hidePath.identifier”. It verifies if the main lookup map contains data for the VehiclePath ID associated with the current context.
   If NO (block 623): The required VehiclePath data is missing. A warning “Log warning saying VehiclePath not found” is issued, and the process likely skips or exits for this iteration.
   If YES: The VehiclePath data is confirmed to exist. The process continues.
(9) Filter Relevant Road Boundaries (block 625): “For each of the topology, generate a bbox and filter the RoadBoundaries the lie inside the bbox to get ‘candidateRoadBoundaries’”.
   This step uses the topology data fetched earlier. For each topology segment associated with the current context, it creates a bounding box (bbox).
   It then filters the set of fetched RSD observable RoadBoundaries (obtained in the first flowchart part), keeping only those boundaries that fall within or intersect this bounding box. This uses the topology as a spatial guide to select only the geographically relevant observable boundaries. The result is a set of candidateRoadBoundaries.
(10) Find Intersections with Observable Boundaries (block 627): “Find sequence of offsets between 0.0 and 1.0 where given vehiclePath intersects candidateRoadBoundaries against it. Sort them in increasing order . . . make use of the LocationTech library method like intersects( ) and intersection( )”.
   This is the core intersection test against the observable boundaries. It compares the geometry of the vehiclePath (likely the relevant segment) with the geometries of the candidateRoadBoundaries identified above.
   Using geometry library functions, it finds all points where the path intersects these boundaries and calculates their positions as normalized offsets (between 0.0 and 1.0) along the vehicle path.
   These intersection offsets are then sorted numerically.
(11) Check if Intersections Occurred (block 629): A decision diamond asks: “Are there any intersectionOffsets?”. This checks if the previous step found any intersections between the vehicle path and the candidate observable road boundaries.
   If NO: The vehicle path did not cross any relevant observable road boundaries in this segment. The process follows the “No” path (exiting right), likely bypassing steps related to handling crossings for this segment.
   If YES: At least one intersection point was found. The vehicle path crossed an observable road boundary. The process follows the “Yes” path downwards to handle these intersections.
(12) Continue Processing: The flowchart continues from the “Yes” branch. Having confirmed that intersections occurred and having identified their precise locations (offsets) along the vehicle path, the next steps will likely involve recording these crossing events and potentially segmenting the path based on these crossings for further analysis (like checking proximity between crossings).

The process continues to FIG. 6C as follows.
(13) Segment Path by Intersections (block 631): “Prepend 0.0 to sorted . . . offsets . . . append 1.0 . . . . Create pairs of two at a time.” As in previous flowcharts, this step takes the sorted list of intersection offsets, adds the start (0.0) and end (1.0) points, and creates pairs (offset_i, offset_{i+1}). Each pair defines a sub-segment of the vehicle path between consecutive intersections with the observable boundaries.
(14) Process Sub-segments (block 633): The flowchart iterates through each offset pair defining a sub-segment:
   Slice & Resample (block 635): It extracts (“slice”) the geometry for the sub-segment from the VehiclePathWrapper. It then resamples this geometry, adding points frequently (“at every 8 mtrs”).
   Create Wrapper & Recalculate Original Offsets: A new VehiclePathWrapper holds this sliced and resampled geometry. The start/end offsets of this sub-segment are recalculated relative to the original, un-sliced VehiclePath using the provided formula.
   Filter Short Segments: Any resulting sub-segment shorter than 1 meter is discarded.
(15) Resample Again (Consistency Check) (block 637): “For each of the VehiclePath, resample it (if not done prior) using 8 mtrs as resampling factor.” This ensures the path segment being analyzed has points spaced approximately every 8 meters (or any other designated interval).
(16) Orthogonal Analysis (block 639): This is a distinct analysis step compared to the previous flowcharts:
   Find Orthogonal Points: For points along the resampled vehicle path sub-segment, the system calculates points that are orthogonally (perpendicularly) positioned 15 meters to the left and 15 meters to the right of the path. The direction (left/right) is determined based on the path's orientation.
   Create Perpendicular Probes (block 641): For each side (left/right), it generates short LocationTech Linstring objects. Each LineString connects a point on the vehicle path to its corresponding orthogonal point (15 m away). These act like perpendicular probes extending from the path.
   Identify Intersecting Boundaries: Using these perpendicular LineString probes, the system checks for intersections with the nearby candidateRoadBoundaries (observable boundaries). It aims to identify up to two boundary features intersecting these probes on each side (left and right) of the vehicle path.
(17) Group Intersection Patterns (block 643):
   Sequence Generation: For points along the path, sequences are created representing the IDs of the boundaries intersected by the probes on the left and right (e.g., [left_id_1, left_id_2, ‘VehiclePath’, right_id_1, right_id_2]).
   Grouping: Consecutive sequences along the path that exhibit the same pattern of intersecting boundary IDs are grouped together. This identifies stretches of the path where the relationship to the surrounding observable boundaries (which boundaries are nearby on the left/right) remains consistent.
   Iteration: The system then iterates through these groups of consistent patterns.
(18) Continue Processing: The flowchart arrow points downwards. This detailed analysis has segmented the path between observable boundary crossings and further characterized these segments by identifying the consistent pattern of nearby observable boundaries to the left and right. This contextual information (what boundaries are nearby and for how long) is now available for the final steps, which will likely use this, possibly combined with distance calculations using the orthogonal points, to classify these segments and determine ‘CloseTo’ or ‘Outside’ discrepancies relative to the observable road boundaries.

The process continues to FIG. 6D as follows.
(19) Iterate Through Grouped Sequences (block 645): The process loops through each “grouped slice” (sequence of points with a consistent boundary intersection pattern).
   It extracts the corresponding geometric slice from the VehiclePath.
   It recalculates the start and end offsets of this slice relative to the original, un-sliced VehiclePath using the previously defined formula.
   A pointerLocation is used to keep track of the position and move to the next group in subsequent iterations.
(19) Check Intersection Pattern Type (block 647): A decision diamond evaluates the specific intersection pattern associated with the current group. It checks if the pattern matches certain predefined configurations:
   Type 1 (Between Boundaries): Patterns like Seq (roadBoundaryURN, vehiclePathURN, roadBoundaryURN), indicating an observable boundary was detected on both the left and right. Other variations involving topologyURN might also fall here.
   Type 2 (Adjacent/Outside Boundary): Patterns like Seq (topologyURN, roadBoundary URN, vehiclePathURN) or Seq (vehiclePathURN, roadBoundaryURN, topologyURN), indicating the path is likely to one side of a detected observable boundary.
   If NO Match: If the pattern for the current group doesn't fit these expected types, the process exits this path (arrow to the right), e.g., skipping the proximity check for this group.
   If YES Match: If the pattern is one of the types targeted for analysis, the process continues downwards.
(20) Retrieve Road Boundary Objects (block 649): “From current sub sequence, using all the ‘roadBoundary’ ids, find actual RoadBoundary Feature objects.” For the current group whose pattern matched, the system uses the URNs/IDs stored in the pattern sequence to retrieve the full data objects for those specific RSD observable Road Boundaries.
(21) Prepare for Proximity Calculation (block 651): “Add all points of RoadBoundaries to RTree.” It takes the geometric points defining these retrieved Road Boundary objects and builds an RTree spatial index for efficient distance searching.
(22) Calculate Distances to Observable Boundaries (block 653): “For all points within VehiclePath, perform search in RTree with distance threshold of 100 cm using haversine distance . . . ”
   It iterates through the points of the current vehicle path slice.
   For each path point, it queries the RTree to find the nearest point on the relevant observable Road Boundaries.
   It calculates the distance and checks if it's less than the specified threshold (100 cm).
(23) Check if Threshold Met (block 655): The final decision point asks: “Are there any sequence of points which satisfy above search?”. It checks if the proximity search found any points on the path slice closer than 100 cm to an observable road boundary.
   If NO (block 657): No proximity violation was detected for this segment. The process returns an empty result for this segment type (“Return Set empty [BehavioralDiscrepancyAttribute]”).
   If YES: Points were found closer than the threshold. This indicates a ‘CloseTo’ discrepancy relative to the observable road boundary. The process continues downwards (arrow labeled “Yes”) to define and record this discrepancy.

The process continues to FIG. 6E as follows.
(24) Input: This section follows a path from the previous decision point where the intersection pattern of a grouped sequence was checked. Specifically, it handles cases that did not proceed to the detailed proximity check.
(25) Check for Specific ‘Outside’ Pattern (block 659): The decision diamond checks if the current grouped sequence meets specific criteria:
   The sequence length (seq.size) is not equal to 1 (meaning it represents more than a single point).
   AND the intersection pattern matches Seq (vehiclePathURN, roadBoundaryURN, topologyURN) or its reverse (Seq (topologyURN, roadBoundaryURN, vehiclePathURN)). This pattern implies that the vehicle path is on one side, an observable road boundary is adjacent to it, and potentially only topology data (or nothing) is detected on the other side of the boundary. This configuration strongly suggests the vehicle path is running outside of the detected observable road boundary.
   If NO (block 661): The pattern does not match this specific “outside” condition (and it also didn't match the “between boundaries” condition that led to the proximity check earlier). The process follows the “No” path to “ignore the sub sequence and move to next one.” This segment is disregarded.
   If YES: The pattern matches the “outside” condition. The process proceeds downwards to classify this segment.
(26) Recalculate Original Offsets (block 663): “Recalculate this section's start and endOffsets using formula described in one of the prior step.” For the segment identified as being “outside,” its start and end offsets are calculated relative to the original, un-sliced VehiclePath using the standard formula seen previously. This defines the range of the “outside” event along the original path.
(27) Create ‘Outside’ Discrepancy Record (block 665): “Create ‘Outside’ RoadBoundary deviation using offsets found in prior step.” A specific discrepancy record is generated, explicitly labeled as an “Outside RoadBoundary deviation.” This record uses the recalculated start and end offsets to mark the segment where the path was determined, based on the intersection pattern, to be outside the observable road boundary.
(28) Continue Processing: The flowchart continues downwards from this step. This path, having generated an ‘Outside’ discrepancy record, will likely merge with the path that generates ‘CloseTo’ records before the final collection and publishing steps.

The process continues to FIG. 6F as follows.
(29) Input: The process continues from the “Yes” path of the last decision in the previous flowchart section, indicating that sequences of points closer than the threshold (e.g., 100 cm) to an observable road boundary were found.
(30) Define ‘CloseTo’ Discrepancy Ranges (block 667):
   It identifies the continuous sequences of points that violated the proximity threshold.
   For each sequence, it finds the first and last points.
   Using these points and the context of the sub-segment they belong to, it calculates the startOffset and endOffset for the sequence relative to the original, complete VehiclePath using the standard recalculation formula seen in previous flowcharts. Let's call these finalStartOffset and finalEndOffset.
(31) Create ‘CloseTo’ Discrepancy Records (block 669): For each sequence identified as violating the proximity threshold, a “CloseTo RoadBoundary deviation” record is created. This record uses the finalStartOffset and finalEndOffset calculated above to define the segment along the original VehiclePath where the path was too close to an observable road boundary.
(32) Collect All Discrepancies (block 671): All discrepancy records generated throughout this workflow are gathered:
   The “CloseTo RoadBoundary” deviation records created in the step above.
   The “Outside RoadBoundary” deviation records created in the previous flowchart section based on intersection pattern analysis.
(33) Merge Consecutive/Close Discrepancies (block 673): The collected list is post-processed to consolidate results:
   Discrepancies are sorted by their start offset.
   Consecutive discrepancies of the same type (CloseTo with CloseTo, or Outside with Outside) are merged into a single, longer record if their defined ranges overlap or if the gap between them is very small (within “50 cms distance”).
(34) Publish Results (block 675): Finally, the processed and potentially merged list of discrepancy records, detailing where the vehicle path came too close to or went outside of the RSD observable road boundaries, is “Publish [ed] to DH.” This sends the final output to the designated system or database (“DH”).
(35) End: This step concludes this specific flowchart analysis.

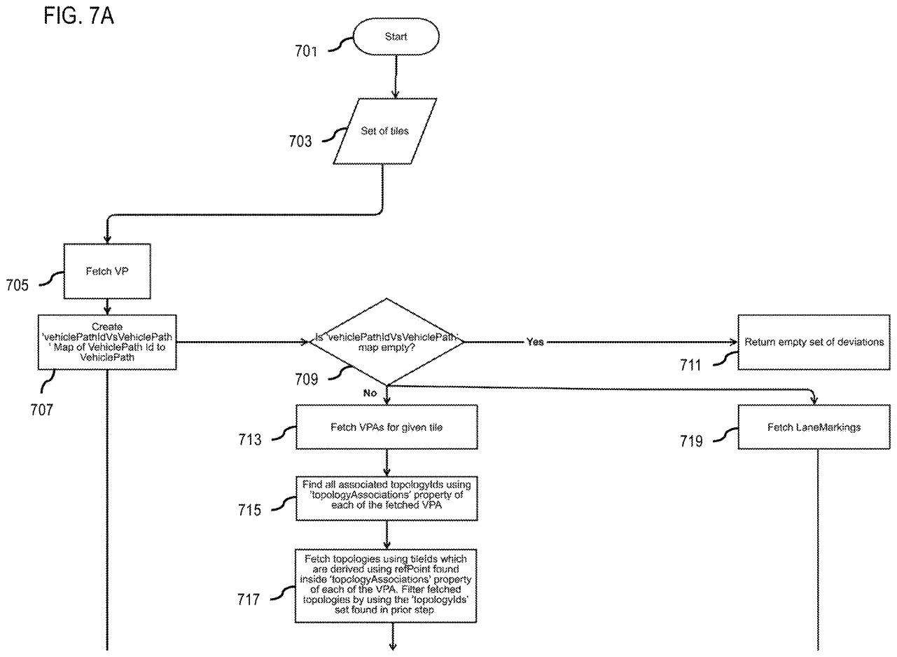

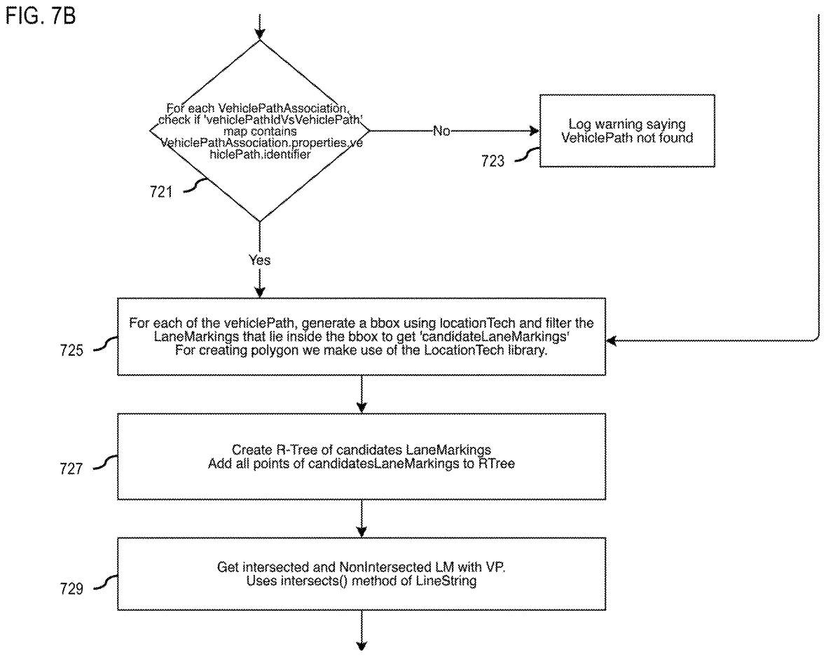

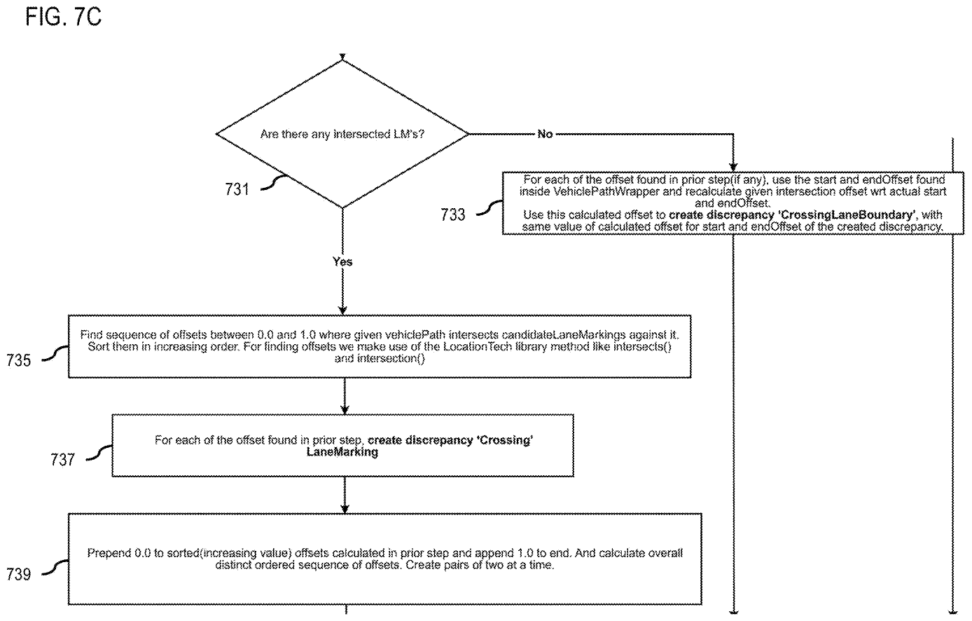

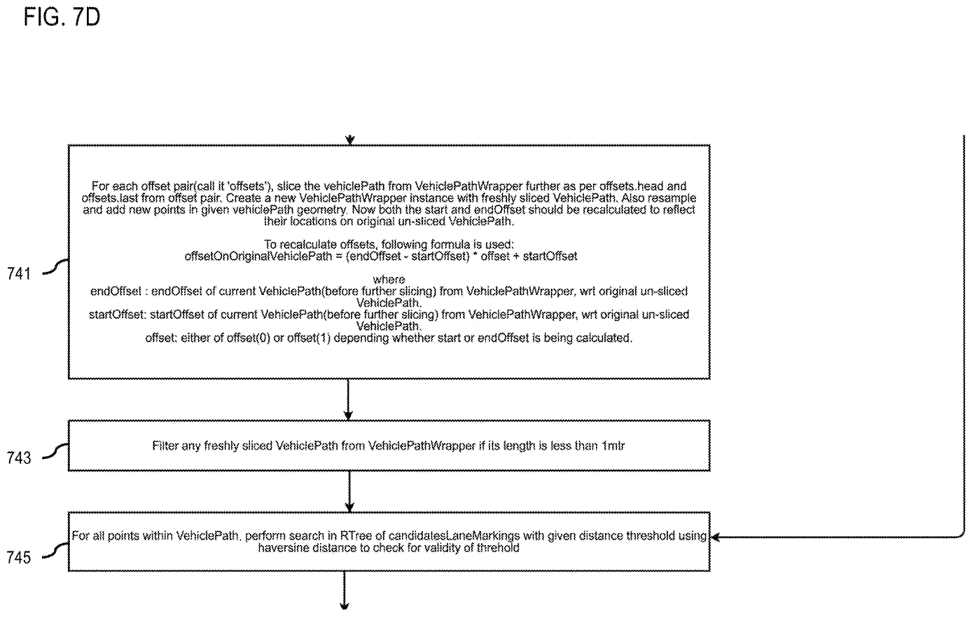

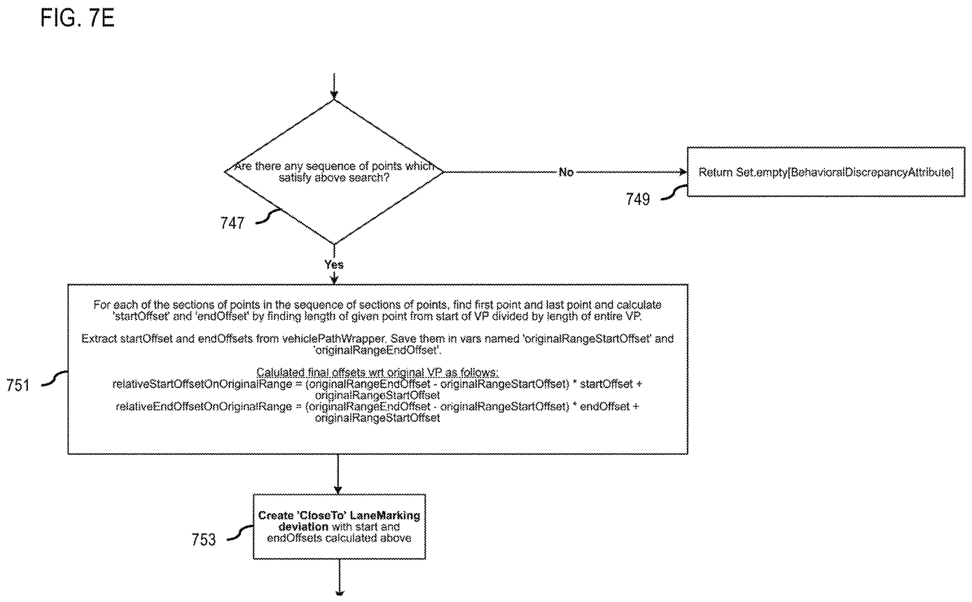

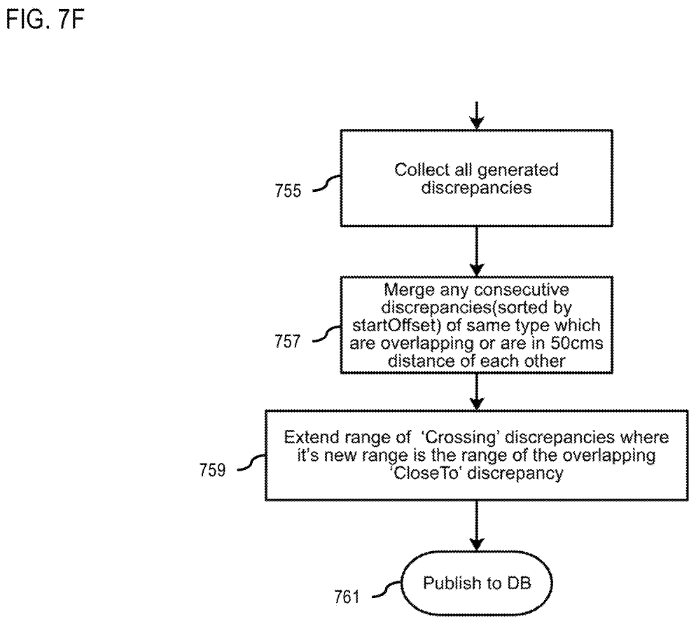

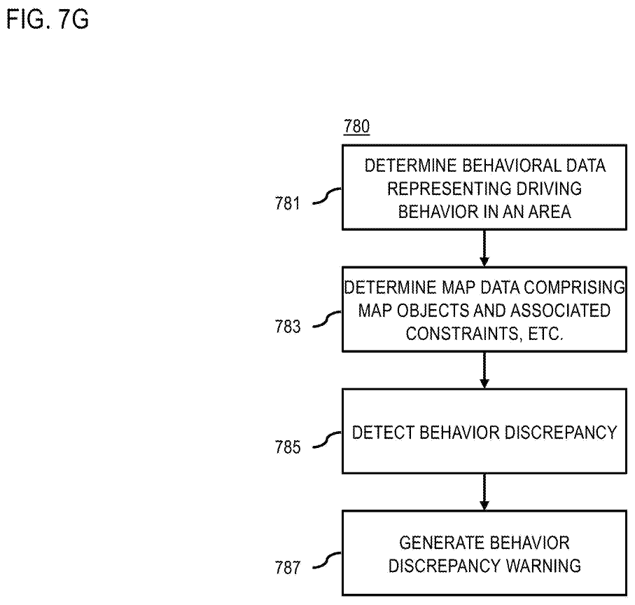

FIGS. 7A-7F is a flowchart of determining vehicle path discrepancy against Lane Boundary Observable (RSD), according to one example embodiment. In various embodiments, the mapping platform 107 and/or any equivalent component may perform one or more portions of the process of FIGS. 7A-7F and may be implemented in, for instance, a chip set including a processor and a memory as shown in FIG. 17. As such, the mapping platform 107 can provide means for accomplishing various parts of the process, as well as means for accomplishing embodiments of other processes described herein in conjunction with other components of the system 100. Although the process of FIGS. 7A-7F is illustrated and described as a sequence of steps, it is contemplated that various embodiments of the process may be performed in any order or combination and need not include all of the illustrated steps.

FIGS. 7A-7F depict a single flowchart spread out over multiple figures. More specifically, the flowchart illustrates a flow of vehicle path discrepancy against lane boundary observable (RSD). This discrepancy shows the range of given VehiclePath crosses a LaneMarking to gets within a distance of 100 cms (or any other designated distance threshold) of it.

FIG. 7A illustrates the following.
(1) Start (block 701) & Tile Selection (block 703): The process initiates by selecting a “Set of tiles,” defining the geographic area for analysis.
(2) Fetch Vehicle Path (VP) (block 705): Vehicle path data relevant to the selected tiles is retrieved.
(3) Create Vehicle Path Lookup Map (block 707): A map (VehiclePathIdVs VehiclePath) is created to store the fetched VehiclePath data, keyed by the VehiclePath ID for efficient access.
(4) Check if Paths Exist (block 709): A decision step checks if any VehiclePaths were fetched (i.e., if the map is empty).
   If YES (Empty) (block 711): No relevant paths were found. The process ends for these tiles, returning an “empty set of deviations.”
   If NO (Not Empty): Paths exist. The process continues, branching into two parallel-looking data fetching streams.
(5) Fetch Vehicle Path Associations (VPAs) & Topology: This branch gathers contextual map data:
   Fetch VPAs for given tile (block 713): Retrieves Vehicle Path Associations/Attributes (VPAs) associated with the current tile.
   Find associated topologyIds (block 715): Examines the fetched VPAs to extract topologyIds from their TopologyAssociations property, linking them to map topology segments.
   Fetch topologies (block 717): Uses these topologyIds and tile information to fetch the corresponding topology data segments from the map database.
(6) Fetch Observable Lane Markings (block 719): This branch fetches the primary data for comparison: “Fetch LaneMarkings.” Based on the flowchart's goal (“lane boundary observable (RSD)”) representing observed lane lines rather than static map data.
(7) Continue Processing: The flowchart structure indicates that after this initial stage, the system has collected the necessary inputs for the analysis:
   The VehiclePath data for the selected tiles.
   The corresponding RSD-derived observable LaneMarking data.
   Associated VPA and topology data (e.g., for context or spatial filtering).

The process continues to FIG. 7B as follows.
(8) Iterative Validation (Vehicle Path Existence) (block 721): The process iterates, likely “For each VehiclePathAssociation.” The first step validates data integrity: “Check if ‘VehiclePathIdVsVehiclePath’ map contains VehiclePathAssociation.properties.hidePath.identifier”. It ensures the data for the VehiclePath referenced by the current association exists in the main lookup map.
   If NO: The required data is missing (block 723). A “Log warning saying VehiclePath not found” is issued, and this association is likely skipped.
   If YES: The data exists, and the process continues for this association.
(9) Filter Relevant Lane Markings (block 725): “For each of the vehiclePath, generate a bbox using locationTech and filter the LaneMarkings the lie inside the bbox to get ‘candidateLaneMarkings’.”
   Unlike some previous flows that used topology, this step uses the geometry of the vehiclePath itself (likely the segment corresponding to the current association) to define the area of interest.
   It generates a bounding box (bbox) around this vehicle path segment.
   It then filters the observable LaneMarkings (fetched in the first part), keeping only those that fall within or intersect this bounding box. This yields the candidateLaneMarkings that are geographically relevant to the path segment being analyzed.
(10) Create Spatial Index (R-Tree) (block 727): “Create R-Tree of candidates LaneMarkings. Add all points of candidatesLaneMarkings to RTree”. An R-tree spatial index is built using all the geometric points that make up the candidateLaneMarkings. This structure will enable efficient distance calculations and intersection queries in later steps.
(11) Identify Intersecting vs. Non-Intersecting Lane Markings (block 729): “Get intersected and NonIntersected LM [LaneMarkings] with VP [VehiclePath]. Uses intersects( ) method of LineString”.
   This step performs intersection tests between the geometry of the current vehicle path segment (VP) and each of the candidateLaneMarkings (whose points are indexed in the R-tree).
   It categorizes the candidateLaneMarkings based on the results: identifying which ones are directly intersected by the vehicle path and which ones are not.
(12) Continue Processing: The flowchart proceeds downwards. The key outputs from this stage are:
   An R-tree containing the points of all relevant nearby observable Lane Markings.
   Two lists or sets of these Lane Markings: those intersected by the path, and those not intersected.

The process continues in FIG. 7C as follows.
(13) Check for Intersected Lane Markings (LMs) (block 731): The process starts with a decision: “Are there any intersected LMs?”. This checks the categorization performed in the previous step-did the vehicle path cross any of the candidate observable lane markings?
   If NO (block 733): The vehicle path did not intersect any relevant lane markings. The process follows the “No” path to the right. (The box on the “No” path contains text describing the creation of ‘Crossing’ discrepancies, which seems incorrect/misplaced as no crossings occurred according to the decision diamond. Logically, this path should proceed to proximity analysis against the non-intersected lane markings, likely using the R-tree built earlier, but those steps aren't shown branching here).
   If YES: The vehicle path did intersect one or more lane markings. The process follows the “Yes” path downwards to explicitly handle these crossings.
(14) Find Intersection Offsets (Yes Path) (block 735): “Find sequence of offsets between 0.0 and 1.0 where given vehiclePath intersects candidateLaneMarkings . . . Sort them . . . make use of . . . intersects( ) and intersection( )”. Although the previous stage categorized markings as intersected, this step formally calculates the precise locations (as normalized offsets along the vehicle path) where these intersections occur using geometry library functions. The offsets are then sorted.
(15) Create ‘Crossing’ Discrepancy Records (Yes Path) (block 737): “For each of the offset found in prior step, create discrepancy ‘Crossing’ LaneMarking”. For each specific intersection offset calculated above, a “Crossing LaneMarking” discrepancy record is generated. This marks the exact point along the vehicle path where an observable lane marking was crossed.
(16) Segment Path by Crossings (Yes Path) (block 739): “Prepend 0.0 to sorted . . . offsets . . . append 1.0 . . . . Create pairs of two at a time.” This standard segmentation step takes the sorted intersection offsets, adds the path start (0.0) and end (1.0) markers, and creates pairs of consecutive offsets (offset_i, offset_{i+1}). Each pair defines a continuous sub-segment of the vehicle path between the identified lane marking crossings.
(17) Continue Processing:
   No Intersection Path: Proceeds off-page to the right, presumably towards proximity analysis of non-intersected lane markings.
   Yes Intersection Path: Proceeds downwards, having created records for each crossing event and having segmented the path into pieces between crossings. The next step for this path will be to analyze these “between-crossing” segments, likely checking for proximity violations within them.

The process continues in FIG. 7D as follows.
(18) Process Sub-segments (Between Crossings) (block 741): The flowchart iterates “For each offset pair (call it ‘offsets’)” which defines a sub-segment between consecutive lane marking crossings (or between an endpoint and a crossing).
   Slice Geometry & Resample: It extracts (“slice”) the geometry for the current sub-segment from the VehiclePathWrapper. It may also resample this geometry (“Also resample and add new points . . . ”) to ensure adequate point density.
   Create Wrapper & Recalculate Original Offsets: A new VehiclePathWrapper is created for the sliced (and potentially resampled) sub-segment. The start and end offsets of this sub-segment are then recalculated using the provided formula to map their positions relative to the original, un-sliced VehiclePath.
(19) Filter Short Segments (block 743): “Filter any freshly sliced VehiclePath from VehiclePathWrapper if it's length is less than 1 m”. Any sub-segments resulting from the slicing and resampling that are shorter than 1 meter are discarded from further analysis.
(20) Proximity Check (block 745): “For all points within VehiclePath, perform search in RTree of candidatesLaneMarkings with given distance threshold using haversine distance to check for validity of treshold”. This is the core proximity analysis for the segments between crossings.
   It iterates through the points of the current (non-filtered) vehicle path sub-segment.
   For each point, it queries the RTree (which contains the points of the nearby observable candidatesLaneMarkings).
   The query finds the distance (specified as “haversine”) from the vehicle path point to the nearest point on any of the candidate lane markings in the RTree.
   This distance is compared against the predefined proximity threshold (e.g., 100 cm).
(21) Continue Processing: The flowchart proceeds downwards. This proximity check step effectively identifies all points within the current sub-segment (which itself lies between crossings) that are closer to an observable lane marking than the specified threshold allows. The results of this check (which points, if any, are “too close”) are passed to the final stage of the flowchart for creating the appropriate discrepancy records.

The process continues in FIG. 7E as follows.
(22) Check Proximity Result (block 747): The process begins with a decision diamond: “Are there any sequence of points which satisfy above search?”. This checks if the proximity calculations performed in the previous step found any points on the current vehicle path sub-segment that were closer to an observable lane marking than the specified threshold.
   IfNO (block 749): No points were found to be closer than the threshold. The vehicle maintained sufficient distance from lane markings throughout this segment. The process follows the “No” path and returns an “empty Set [BehavioralDiscrepancyAttribute]”, indicating no proximity discrepancy is recorded for this segment.
   If YES: One or more points (forming a sequence) were found to be closer than the threshold. This signifies a proximity violation. The process follows the “Yes” path downwards to define and record this discrepancy.
(23) Identify and Define ‘CloseTo’ Discrepancy Ranges (Yes Path) (block 751):
   It takes each continuous sequence of points that violated the proximity threshold.
   For each sequence, it identifies the first and last points.
   It then calculates the startOffset and endOffset corresponding to these points relative to the original, complete VehiclePath, using the standard recalculation formula to map them back from the sub-segment's coordinate system. Let's call these final StartOffset and finalEndOffset.
(24) Create ‘CloseTo’ Discrepancy Records (Yes Path) (block 753): “Create ‘CloseTo’ LaneMarking deviation with start and endOffsets calculated above”. For each proximity violation sequence, a “CloseTo LaneMarking deviation” record is generated. This record stores the finalStartOffset and finalEndOffset, precisely marking the segment along the original VehiclePath where the vehicle was too close to an observable lane marking.
(25) Continue Processing: The flowchart exits downwards from the “Create ‘CloseTo’” step. These newly created ‘CloseTo’ LaneMarking deviation records are now ready. They will proceed to the final steps of the overall process.

The process continues to FIG. 7F as follows.
(26) Input: The process starts by receiving the “CloseTo LaneMarking deviation” records generated in the previous step. It also implicitly includes the “Crossing LaneMarking” records generated earlier for points where the path intersected lane markings.
(27) Collect All Discrepancies (block 755): This step gathers together all the discrepancy records generated during this workflow: the Crossing records and the CloseTo records related to observable lane markings.
(28) Merge Consecutive/Close Discrepancies (block 757): The collected list of discrepancies undergoes a consolidation process:
   The records are sorted based on their start offset along the vehicle path.
   The system merges any consecutive discrepancies of the same type (i.e., CloseTo with CloseTo, or Crossing with Crossing) if their defined ranges overlap or if the gap between them is very small (within “50 cms distance”). This helps combine minor, fragmented events into single, more significant discrepancy reports.
(29) Extend ‘Crossing’ Discrepancy Ranges (block 759): A specific refinement is applied: “Extend range of ‘Crossing’ discrepancies where it's new range is the range of the overlapping ‘CloseTo’ discrepancy.” If a point-like Crossing event overlaps geographically with a range-based CloseTo event, the range associated with the Crossing record is expanded to match the full range of the CloseTo record. This ensures that the act of crossing is captured within the context of the surrounding proximity violation.
(30) Publish Results (block 761): Finally, the processed, consolidated, and potentially extended list of lane marking discrepancies (Crossing and CloseTo) is “Publish [ed] to DB.” This sends the final results to a destination Database (“DB”) for storage and later use.
(31) End: This marks the completion of this specific flowchart's analysis for lane marking discrepancies.

FIG. 7G is a flowchart of a process 780 for providing behavioral decision warning, according to one example embodiment. In various embodiments, the mapping platform 107 and/or any equivalent component may perform one or more portions of the process 780 and may be implemented in, for instance, a chip set including a processor and a memory as shown in FIG. 17. As such, the mapping platform 107 can provide means for accomplishing various parts of the process, as well as means for accomplishing embodiments of other processes described herein in conjunction with other components of the system 100. Although the process 780 is illustrated and described as a sequence of steps, it is contemplated that various embodiments of the process may be performed in any order or combination and need not include all of the illustrated steps.

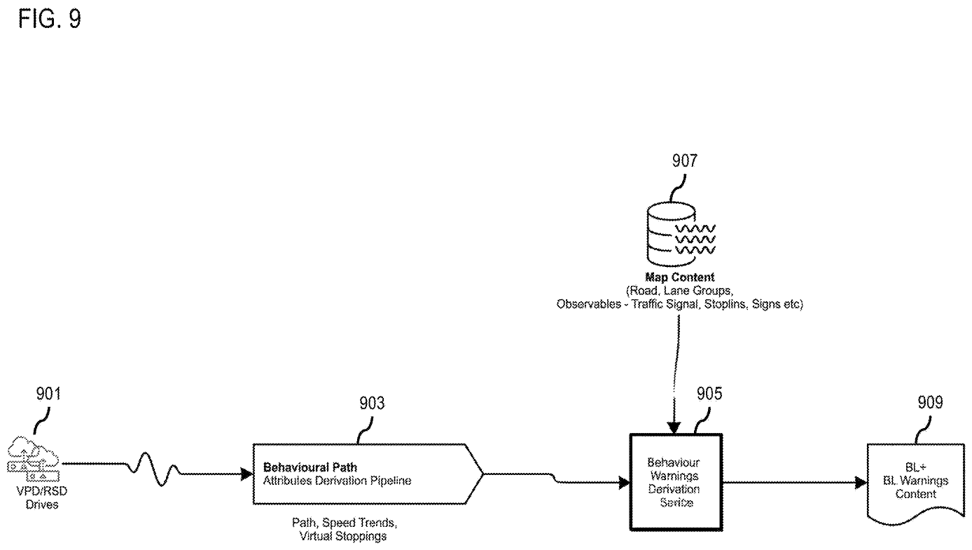

In one embodiment, the process 780 of FIG. 7G provides a consolidated and higher-level representation of the behavior discrepancy warning workflows described elsewhere in the present application. More specifically, the step of determining, for a given area, behavioral data representing aggregated driving behavior in the given area may be implemented using the vehicle-path, speed, stopping, and transition derivation operations described with respect to the end-to-end workflow of FIGS. 2A-2D and the behavior derivation architecture of FIG. 9, including generation of behavioral drive paths, behavioral speed profiles, and other aggregated behavior attributes from vehicle drive data. The step of determining, for the given area, map data comprising one or more map objects and one or more driving constraints, permissions, conditions, or requirements associated with the one or more map objects corresponds to the use of map content such as roads, lanes, speed limits, lane groups, road boundaries, lane markings, signs, traffic signals, stop lines, and restricted or permitted maneuvers as described throughout the application, including FIGS. 1C, 1D, 8, and 9. The step of detecting, based on a comparison between the behavioral data and the map data, a behavior discrepancy between the aggregated driving behavior and the one or more driving constraints, permissions, conditions, or requirements may be implemented using any one or more of the more specific discrepancy-detection workflows described in FIGS. 3A-3E, 4A-4H, 5A-5F, 6A-6F, and 7A-7F, including comparisons of behavioral speed against speed limits, vehicle paths against road boundaries or lane markings, stopping behavior against stopping-related map content, and maneuver or transition behavior against mapped permissions, restrictions, or lane-transition information. The step of generating a behavior discrepancy warning indicating the detected behavior discrepancy corresponds to the warning-generation, publication, storage, and downstream-use operations described in FIGS. 2D, 8, and 9, including storing or publishing discrepancy attributes associated with roads, lanes, lane groups, or linear ranges of vehicle paths and providing such warnings to routing, planning, driver-assistance, or autonomous-vehicle control functions. Thus, FIG. 7G may be understood as expressing, in a compact form, the common logical framework underlying the more detailed example workflows disclosed throughout the application for deriving, evaluating, and operationally using behavior discrepancy warnings in a mapped driving environment.

In one embodiment, the disclosed system includes a mapping platform in communication with a geographic database, behavior-layer data, vehicle drive data, and planned maneuver data, and further contemplates that discrepancy warning information may be pre-computed at the backend or, in other embodiments, computed in the vehicle. This allows the process 780 to be integrated into a practical technological environment involving map processing, behavior modeling, route generation, driver-assistance functionality, and autonomous-vehicle planning and control.

At block 781, process 780 includes determining, for a given area, behavioral data representing aggregated driving behavior in the given area. In one embodiment, the behavioral data is derived from vehicle drive data collected from a plurality of vehicles that traverse the given area. In one embodiment, the behavioral data comprises at least one of a behavioral drive path, a behavioral transition, a behavioral speed profile, or a behavioral stopping area. For example, behavioral drive paths are predominant trajectories that indicate where vehicles tend to drive within a lane or toward another lane, behavioral transitions indicate where vehicles tend to begin and end transitioning, behavioral speed profiles indicate where vehicles tend to slow down or travel at a particular speed, and behavioral stopping areas indicate predominant explicit or implicit stopping locations.

In one embodiment, determining the behavioral data comprises aggregating vehicle drive data from a plurality of vehicles, the vehicle drive data comprising at least one of vehicle-path data, speed data, lane-transition data, or stopping-location data. For example, various embodiments described herein may comprise collecting crowd-sourced or fleet-derived sensor data from multiple vehicles, including anonymized drive paths, speeds, and related driving attributes, aligning the data to lane-level accuracy, clustering the data to define locations and maneuvers, and generating one or more aggregated behavioral representations for a lane, road segment, or other mapped area. In some embodiments, the behavioral data may be generated from vehicle path observables that are ingested, aggregated, stitched, conflated, smoothed, validated, and associated with lanes and road topology.

The operations performed at block 781 provide a practical technological improvement because the process transforms distributed vehicle sensor observations into a machine-usable behavior layer that is spatially referenced to mapped roadway features. Rather than merely collecting information about human driving conduct, the process generates behavior representations that can be consumed by downstream vehicle-planning and control systems to anticipate where vehicles tend to drive, transition, slow, or stop, including in complex road environments where map geometry alone may be insufficient for smooth and uninterrupted driving. This improves the technical operation of driver-assistance and autonomous-driving systems by providing a pre-computed or pre-derived behavioral input that can be automatically evaluated relative to map-based roadway constraints.

At block 783, process 780 includes determining, for the given area, map data comprising one or more map objects and one or more driving constraints, permissions, conditions, or requirements associated with the one or more map objects. In one embodiment, the map data is retrieved from a geographic database and includes map objects such as roads, lanes, road boundaries, lane boundaries, speed limits, road surface markings, stop lines, crosswalks, signs, traffic signals, lane-transition status data, intersection information, restricted or permitted maneuver data, access restrictions, conditional speed limits, and construction-related map content. In one embodiment, the one or more driving constraints, permissions, conditions, or requirements associated with the one or more map objects include restrictions or conditions indicating that road boundaries should not be crossed, lane boundaries should not be crossed under certain circumstances, a vehicle should not exceed an applicable speed limit, a vehicle should stop or yield in response to a stop line, sign, or traffic signal, and one or more maneuvers are restricted or permitted in association with a road, lane, or intersection.

The map data of block 783 provides a structured, machine-readable rule layer that is linked to map objects and that can be automatically evaluated against aggregated driving behavior. This provides a practical application in a vehicle-navigation and autonomous-driving system because the map data is used as a technical input to determine whether behavior observed from a fleet is compatible with the mapped roadway constraints, permissions, conditions, and requirements. By tying such information to specific roads, lanes, boundaries, signs, signals, and other map objects, the process improves the ability of a planning or control system to reason about roadway rules in a machine-executable form at lane level or road level.

At block 785, process 780 includes detecting, based on a comparison between the behavioral data and the map data, a behavior discrepancy between the aggregated driving behavior and the one or more driving constraints, permissions, conditions, or requirements. In one embodiment, process 780 further comprises performing a relational check for at least one of a vehicle drive path, a speed profile, a stopping location, or one or more maneuvers against one or more infrastructure elements, one or more averaged behaviors, or a combination thereof. For example, the various embodiments described herein may comprise comparing aggregated drive paths against lane groups, lane boundaries, road boundaries, and road topology; comparing aggregated speed profiles against speed limits; comparing aggregated stopping locations against stop lines, crosswalks, signs, traffic signals, and intersection information; and comparing aggregated transition behavior against lane-transition status, boundary styles, lane boundaries, and intersection-related features.

In one embodiment, the behavior discrepancy is based on determining that the behavioral data indicates that a behavioral drive speed exceeds a speed limit indicated in the map data. For example, aggregated speed profiles may be compared against mapped speed limits to determine where the aggregated speed is not within a legal or mapped limit, and segments associated with such deviations may be identified and published as discrepancy information. This comparison provides a technical improvement because the system does not merely record speed behavior, but automatically evaluates the behavioral speed relative to mapped roadway constraints in order to identify areas where a vehicle-planning system should not simply follow the observed fleet behavior.

In one embodiment, the behavior discrepancy is based on determining that the behavioral data indicates a vehicle drive path that is within a proximity threshold to, or outside of, one or more of the map objects represented in the map data. In one embodiment, the one or more map objects comprise a road boundary or a lane marking. The various embodiments describe workflows for determining where a vehicle path comes within a designated threshold distance of, crosses, or goes outside road boundaries or lane markings defined by lane groups or observable features, and for generating discrepancy records corresponding to such close-to, crossing, or outside conditions over a linear range of the vehicle path. In this manner, the process performs a concrete spatial analysis of path geometry relative to mapped roadway features and thereby improves the ability of technical driving systems to detect boundary-related risk conditions in a way that is tied to roadway geometry and not to an abstract rule evaluation.

In one embodiment, the behavior discrepancy is based on determining that the behavioral data indicates a driving maneuver that is prohibited by the driving constraints, permissions, conditions, or requirements associated with the one or more map objects, the driving maneuver comprising at least one of a restricted turn or travel on a restricted-access road segment. The various embodiments described herein identify discrepancy cases such as associated road has restricted turn and associated road is restricted access, and further explains that behavioral decision warnings may be generated where human driving tendencies do not align with legal maneuvers indicated by the map content. This provides a practical technological use because the system can prevent an autonomous-driving or navigation system from deriving or selecting a maneuver that is inconsistent with mapped roadway permissions or restrictions.

In one embodiment, the behavior discrepancy is based on determining that the behavioral data indicates a stopping location inconsistent with at least one of a stop line, a crosswalk, a traffic signal, a traffic sign, or intersection information represented in the map data. The various embodiments described herein may comprise comparing aggregated stopping locations to stop lines and crosswalks to determine whether the stopping locations satisfy legal requirements, and also analyzing aggregated stopping locations with traffic signals, signs, and intersection information to determine whether the stopping location is a legal or expected stopping location. This use of stop-related comparison improves technical driving performance because it enables a vehicle-planning system to identify areas where observed stopping behavior should be treated as unreliable or warning-worthy rather than being directly followed.

In one embodiment, the behavior discrepancy is based on determining that the behavioral data indicates a lane transition inconsistent with at least one of a lane transition status, a lane-boundary marking style, a lane boundary, or an intersection attribute represented in the map data. For example, aggregated lane transition probabilities may be compared to lane transition status, lane-boundary marking styles, lane boundaries, and intersections to determine whether likely transitions are permissible where they occur. By checking whether transition behavior is consistent with mapped transition rules and boundary conditions, the system improves technical decision-making in lane-level planning and navigation.

In one embodiment, the behavior discrepancy is based on determining that the behavioral data indicates a behavioral speed that exceeds a conditional speed limit applicable to the given area. The various embodiments described herein identify conditional speed limits as a type of map-object-related condition and further explains that a customer or end user may choose to overwrite the behavioral speed with another speed derived from static speed limits, conditional speed limits, curvature, elevation, or other mapped attributes where humans tend to overspeed or where conditional rules apply. This provides a concrete technological application in that the discrepancy analysis directly affects the speed input or speed-selection behavior of a vehicle control system.

In one embodiment, the behavior discrepancy warning indicates that the behavioral data is obsolete based on at least one of an ongoing construction condition or an incoming change associated with the given area. The various embodiments described herein identify discrepancy cases such as associated road has ongoing constructions and incoming change, behaviors are obsolete. Thus, the discrepancy warning may expressly indicate that a previously derived behavioral path, transition, speed profile, or stopping area should no longer be relied upon because the mapped environment has changed or because a construction-related condition has rendered the prior behavioral data stale. This improves system reliability by preventing outdated behavioral information from being used in route selection or autonomous-driving decision-making after the relevant roadway conditions have changed.

At block 787, process 780 includes generating a behavior discrepancy warning indicating the detected behavior discrepancy. In one embodiment, generating the behavior discrepancy warning comprises storing or publishing a discrepancy attribute associated with at least one of a road segment, a lane, a lane group, or a linear range of a vehicle path. The various embodiments described herein may comprise publishing discrepancy results to backend systems and storing discrepancy attributes on vehicle paths or other mapped entities, including discrepancy information associated with roads, lanes, lane groups, or specific linear portions of vehicle paths. In one embodiment, the discrepancy attribute identifies a start offset and an end offset of the linear range of the vehicle path associated with the detected behavior discrepancy. The various embodiments described herein comprise discrepancy outputs as linear ranges having corresponding start and end offsets, including close-to, outside, and crossing conditions represented over one or more portions of a vehicle path.

In one embodiment, the discrepancy attribute generated at block 787 is a machine-readable output that is stored in a map database, behavior-layer data store, or publication pipeline and is usable by technical systems downstream from the discrepancy-detection process. The storage or publication of discrepancy attributes over identified path ranges provides a technical improvement because the resulting output is not merely descriptive, but is directly consumable by planning, routing, driver-assistance, and autonomous-driving systems that can react to the identified discrepancy type and corresponding spatial extent.

In one embodiment, process 780 further comprises precomputing the behavior discrepancy warning at a backend mapping platform and providing the behavior discrepancy warning to a planning module or control module for controlling operation of an autonomous vehicle. For example, the behavior discrepancy warnings may be pre-computed values on the backend, which can save compute power in the vehicle, and may be available at an early stage of data processing, such as in a prediction or motion-planning stage, so that the vehicle can anticipate a dangerous or undesirable situation before the vehicle has already planned and begun a maneuver. In one embodiment, controlling the operation of the autonomous vehicle comprises at least one of selecting a level of autonomous driving, requesting a driver take manual control, or activating or deactivating a self-driving function. In one embodiment, discrepancy warnings may be used for improving activation and deactivation of self-driving functions, for foresightful notification of driver take-over requests, and for selecting safer autonomous-driving zones or autonomy levels, including transitions between more and less autonomous modes.

In one embodiment, process 780 further comprises generating routing data for a vehicle based on the behavior discrepancy warning, wherein the routing data directs the vehicle to avoid the given area associated with the behavior discrepancy warning. For example, false positives or warning conditions may cause a navigation system to determine an alternate route, and further explains that discrepancy warnings can be used to create safer maneuver derivations and autonomous-driving zones by avoiding or de-prioritizing behavioral paths or areas associated with warnings. Thus, the warning generated by process 780 may be used as an input to route generation so that the vehicle avoids an area in which aggregated behavior is inconsistent with map-based constraints, permissions, conditions, or requirements.

The operations of blocks 781, 783, 785, and 787 therefore provide a concrete technical solution to a technical problem arising in driver-assistance and autonomous-driving systems, namely that aggregated or human-like driving behavior may not always align with mapped roadway constraints or current roadway conditions, and that conventional systems may therefore generate uncomfortable, unsafe, or impermissible maneuvers if they rely on such behavior without discrepancy analysis. By deriving aggregated behavioral data, determining map data including map objects and associated driving constraints, permissions, conditions, or requirements, detecting discrepancies through relational comparison, and generating machine-readable discrepancy warnings that are stored, published, precomputed, and consumed by route-planning and vehicle-control systems, process 780 improves the accuracy, safety, responsiveness, and computational efficiency of technical vehicle systems operating in the mapped roadway environment.

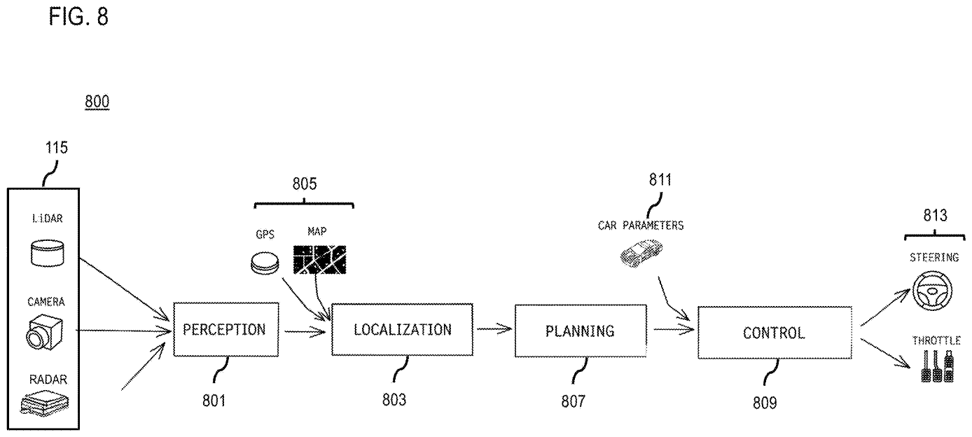

FIG. 8 is a diagram of an architecture 800 of an autonomous driving or advanced driver assistance system (e.g., onboard systems 103 of vehicle 101), according to one example embodiment. This architecture 800 outlines the modules involved in processing sensor information to generate vehicle control actions. In one embodiment, the includes a PERCEPTION module 801. This module 801 receives data inputs from a suite of sensors 115, including Lidar, Camera, and Radar. The PERCEPTION module 801 is responsible for sensing the vehicle's operational environment, performing tasks such as object detection and classification (identifying observables), and constructing an understanding of the current scene around the vehicle.

Output from the PERCEPTION module 801 is utilized by the LOCALIZATION module 803. This module 803 integrates information from positioning systems 805, such as but not limited to GPS, with MAP data (e.g., corresponding to the geographic database 105). By correlating sensor inputs and map data, the LOCALIZATION module 803 determines the precise position and orientation of the vehicle within the road network or its surroundings.

Subsequent to localization, the PLANNING module 807 receives the vehicle's state (position, orientation) and the perceived environmental model. This module calculates a suitable trajectory or path for the vehicle to follow, considering factors like the destination, planned maneuvers, road rules, and the behavior of other road users detected by the PERCEPTION module 801.

The trajectory generated by the PLANNING module 807 serves as input to the CONTROL module 809. This control module 809 also takes into account specific CAR PARAMETERS 811 (e.g., vehicle dynamics, capabilities). Its function is to translate the planned path into low-level, executable commands for the vehicles control actuators.

Finally, the CONTROL module 809 outputs commands for actuators 813 such as but not limited to STEERING and THROTTLE (and implicitly braking). These commands are executed by the vehicle's actuation systems to physically guide the vehicle along the planned trajectory.

In one the behavior discrepancy warnings generated according to the various embodiments described herein can be used by, e.g., the PLANNING module (e.g., for motion planning/maneuver) or equivalent to plan autonomous maneuvers of the vehicle. In one embodiment, the behavior discrepancy warnings are pre-computed values on the backend allow saving the compute power in the vehicle (e.g., in other embodiments, the same operation could be done in the vehicle). The ability to pre-compute the discrepancy warning data is an added value because having this information available at early state of data processing (e.g., prediction module which is a part of motion planning step), a car can anticipate a dangerous situation on the road and plan appropriate maneuver upfront.

Alternatively, if discrepancy warning information is not available, then a car would plan a maneuver, and then system would have to react in the last moment to the situation after the vehicle has planned the maneuver and ended up in the ‘undesired’ situation (e.g., in an area affected by a discrepancy warning). This results either in driver's intervention or vehicle safety function kicking in and stopping the dangerous maneuver.

This figure represents the core sense-plan-act cycle of an automated driving system. The data generated throughout this process, such as the executed path, speed profile, and perceived observables, corresponds to the type of information (e.g., VPD/RSD) utilized as input in the previously discussed data processing flowcharts for analyzing behavioral patterns and discrepancies. Table 1 below illustrates potential autonomous vehicle behavior based on considering or not considering the discrepancy warning.

TABLE 1

| Discrepancy | behavior when it's NOT | System behavior when |
|---|---|---|
| Warning type | considered | it's considered |
| Tend to drive | Vehicle accelerates to the | System may consider |
| above speed | observed speed, and then either | the speed and adjust it |
| limits | driver intervenes, or the system | smoothly to the legal |
| | re-adjusts the speed to the legal | one |
| | speed limit (impacting | |
| | passengers' comfort, or safety) | |
| Tend to drive | Vehicle sets up its trajectory to | Vehicle can plan the |
| near road edge | drive close to the edge, causing | maneuver to rely more |
| Tend to drive | either the safety hazard or | on the driver |
| near/cross lane | passengers' discomfort | involvement (for |
| boundary | | example it can switch |
| | | driving mode from |
| | | hands off to hands on |
| | | mode) |
| Tend to make | Vehicle plans an illegal | Vehicle can plan a |
| forbidden turns | operation that might result in | different maneuver, or |
| Tend to drive on | safety hazard or last moment | switch driving mode |
| a forbidden lane | driver's intervention, or fine | from hands off to |
| Tend to ignore | being a result an offence | hands on mode |
| explicit stop | against driving law. | |

FIG. 9 is a diagram of a high level system view of deriving behavioral decision warnings, according to one embodiment. More specifically, FIG. 9 depicts a system architecture illustrating a process for deriving vehicle behavioral information and generating related content. The system utilizes input data sourced from ‘VPD/RSD Drives’ 901, representing collected vehicle path data (VPD) and/or road-side detection (RSD) data.

This input data is initially processed by a “Behavioral Path Attributes Derivation Pipeline” 903. As indicated by the associated annotations, this pipeline 903 derives key behavioral metrics from the input drives (e.g., drives 901), such as the reconstructed vehicle path, identified speed trends, and inferred virtual stoppings.

The output attributes from the derivation pipeline 903, encompassing the path, speed trends, and virtual stoppings, are then fed into a “Behavior Warnings Derivation Service” 905. This service additionally receives input from a “Maps Content” data source 907 (e.g., geographic database 105). The map content 907 includes foundational map data like road definitions and lane groups, as well as potentially dynamic or observed features such as traffic signals, stop lines, and road signs.

The “Behavior Warnings Derivation Service” 905 processes the derived behavioral path attributes in conjunction with the contextual information provided by the map content data source. The final output of this service is designated as “BL+BL Warnings Content” 909, suggesting the generation of enriched behavioral logs (BL) augmented with warnings derived from comparing the vehicle's behavior against the legal maneuvers (e.g., as indicated in the map context) according to the various embodiments described herein.

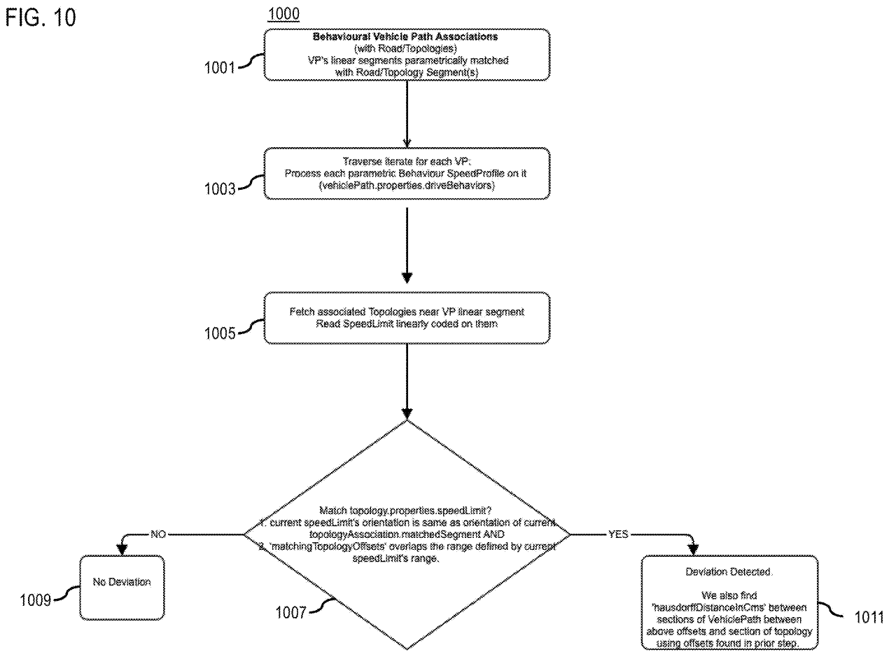

FIG. 10 is a flowchart of a process 1000 for determining speed limit deviations, according to one embodiment. In various embodiments, the mapping platform 107 and/or any equivalent component may perform one or more portions of the process 1000 and may be implemented in, for instance, a chip set including a processor and a memory as shown in FIG. 17. As such, the mapping platform 107 can provide means for accomplishing various parts of the process, as well as means for accomplishing embodiments of other processes described herein in conjunction with other components of the system 100. Although the process of 1000 is illustrated and described as a sequence of steps, it is contemplated that various embodiments of the process may be performed in any order or combination and need not include all of the illustrated steps.
(1) Input Data (block 1001): The process starts with “Behavioral Vehicle Path Associations (with Road/Topologies)”. This means the input is not just raw vehicle paths, but paths that have been associated with behavioral data (like speed) and whose segments have been “parametrically matched” or aligned with corresponding segments of road/topology map data.
(2) Iterate and Process Speed (block 1003): The system then “Traverse iterate [s] for each VP” (Vehicle Path). For each path or relevant segment, it processes the “parametric Behaviour SpeedProfile” associated with it (found in vehiclePath.properties.driveBehaviors). This step extracts the vehicle's actual speed information along the path segment.
(3) Fetch Topology and Speed Limit (block 1005): For the current vehicle path segment being analyzed, the system “Fetch [es] associated Topologies near VP linear segment”. It retrieves the corresponding road/topology map segment(s) that were matched to the vehicle path in the input data. It then “Read [s] SpeedLimit linearly coded on them”-extracting the official speed limit information directly from the map data for that road segment.
(4) Validate Applicable Speed Limit (block 1007): The core logic resides in the decision diamond “Match topology properties speedLimit?”. This step doesn't compare vehicle speed to the limit yet, but rather validates if the fetched topology speed limit is applicable to the specific vehicle path segment being considered. It checks two conditions:
   Condition 1 (Orientation): Is the orientation (directionality) of the “current speedLimit” the same as the orientation of the matched segment (current topology Association.matchedSegment)? This ensures the speed limit corresponds to the vehicle's direction of travel.
   Condition 2 (Range Overlap): Do the relevant offsets defining the vehicle path's position on the topology (matchingTopologyOffsets) overlap with the specific range along the topology segment where the “current speedLimit” applies? (Speed limits can change within a single map segment).
(5) Determine Outcome:
   If NO (block 1009): If either the orientation doesn't match or the segment doesn't fall within the speed limit's applicable range, the process concludes there is “No Deviation.” This means a valid, applicable speed limit from the topology could not be found for this specific path segment comparison.
   If YES (block 1011): Both conditions are met. A topology speed limit that is valid for the specific path segment (considering direction and location) has been successfully identified. The process flags “Deviation Detected.”
      Hausdorff Distance: Upon detecting this match, the system also calculates the “hausdorffDistanceInCms” between the relevant section of the VehiclePath and the corresponding section of the topology. This measures the geometric difference (how far apart the driven path was from the map's representation) for the segment where the speed limit was successfully matched.

In summary, this flowchart describes the process 1000 of taking a vehicle path with a known speed profile, finding the corresponding map topology segment, extracting the speed limit from the map, and validating whether that specific map speed limit is truly applicable to the vehicle path segment based on orientation and range. If an applicable speed limit is found, it flags this potential for deviation analysis and calculates the geometric path difference.

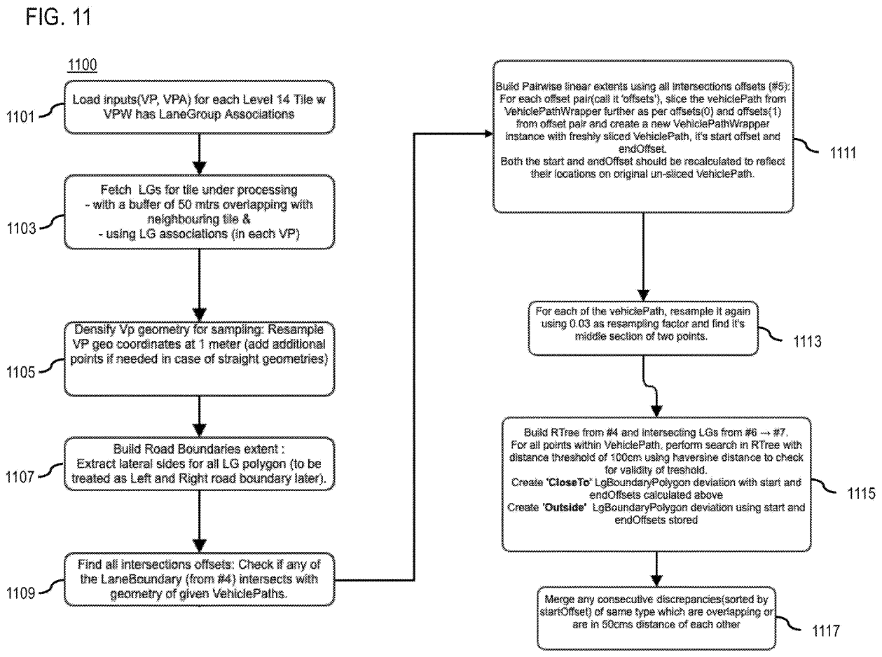

FIG. 11 is a flowchart of a process 1100 for determining speed limit deviations, according to one embodiment. More specifically, this flowchart describes a process for finding deviations between a vehicle path and a lane model, specifically focusing on proximity to or crossing of boundaries derived from LaneGroups. In various embodiments, the mapping platform 107 and/or any equivalent component may perform one or more portions of the process 1100 and may be implemented in, for instance, a chip set including a processor and a memory as shown in FIG. 17. As such, the mapping platform 107 can provide means for accomplishing various parts of the process, as well as means for accomplishing embodiments of other processes described herein in conjunction with other components of the system 100. Although the process 1100 is illustrated and described as a sequence of steps, it is contemplated that various embodiments of the process may be performed in any order or combination and need not include all of the illustrated steps.
(1) Load Inputs (block 1101): The process begins by loading necessary input data for a specific map tile (“Level 14 Tile”). This includes Vehicle Paths (VP) and Vehicle Path Associations (VPA), filtered to only include those VPWs (Vehicle Path Wrappers or similar structures) that have associated “LaneGroup Associations.”
(2) Fetch LaneGroups (LGs) (block 1103): It fetches the LaneGroup data relevant to the tile being processed. Importantly, it includes a “buffer” to also fetch LaneGroups from adjacent tiles to handle features or paths crossing boundaries, using the LG associations from the input VPs to identify relevant LGs.
(3) Densify Vehicle Path Geometry (block 1105): The geometry of the input Vehicle Paths is processed (“Densify,” “Resample”) to increase its resolution. The goal is to ensure there's a coordinate point approximately every 1 meter along the path, adding points as needed, especially on straight sections.
(4) Derive Road Boundaries from LaneGroups (block 1107): The system extracts the “lateral extent” (side boundaries) from all the fetched LaneGroup polygons for the area. These extracted extents are then treated collectively as the effective “Left and Right road boundary” for the subsequent analysis. This creates a representation of the overall drivable area based on the lane model.
(5) Find Intersections (block 1109): It performs intersection tests between the densified Vehicle Path geometries (from step 3) and the derived Road Boundaries (from step 4). All intersection points are identified and their locations recorded as offsets along the vehicle paths.
(6) Segment Vehicle Path (block 1111): Using the intersection offsets found, the Vehicle Paths are segmented. The process adds start (0.0) and end (1.0) markers to the sorted offsets and creates pairs representing continuous sub-segments between intersections. For each sub-segment, its geometry is extracted (“sliced”), and its start/end offsets are recalculated relative to the original, un-sliced Vehicle Path.
(7) Resample Sub-segments & Find Midpoints (block 1113): Each sub-segment (between intersections) is resampled again very finely (“using 0.03 as resampling factor”). For each finely resampled sub-segment, its “middle section of two points” is identified (likely points near the geometric center).
(8) Build RTree & Perform Proximity Search (block 1115):
   An RTree spatial index is built using points from the derived Road Boundaries (from step 4), possibly refined based on which LaneGroups were involved in intersections or segment processing (steps 6-7).
   The system iterates through points on the Vehicle Paths (likely the sub-segments from step 7). For each point, it queries the RTree to find the distance to the nearest boundary point.
   This distance is checked against a threshold (e.g., “100 cm”).
   Based on the intersection results (step 5) and proximity results (this step), discrepancy records are created:
      ‘CloseTo’ LgBoundaryPolygon deviation: Generated for segments where points were found closer than the 100 cm threshold. Uses the recalculated start/end offsets defining the violation range.
      ‘Outside’ LgBoundaryPolygon deviation: Generated for segments determined to be outside the derived boundaries (e.g., identified via intersection logic or possibly geometric containment tests not explicitly shown). Uses stored start/end offsets.
(9) Merge Discrepancies (block 1117): All generated CloseTo and Outside discrepancy records are collected and sorted by their start offset. Consecutive records of the same type are merged if their ranges overlap or if the gap between them is very small (e.g., within “50 cms distance”). This consolidates the results.
(10) End: The flowchart concludes after the merging step, likely outputting the final, processed list of deviations detected against the lane model's derived boundaries.

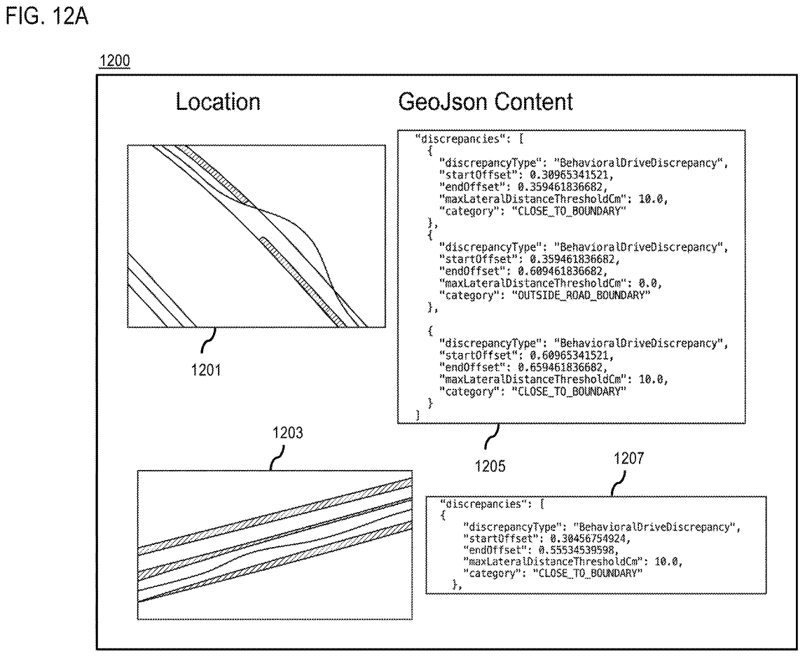

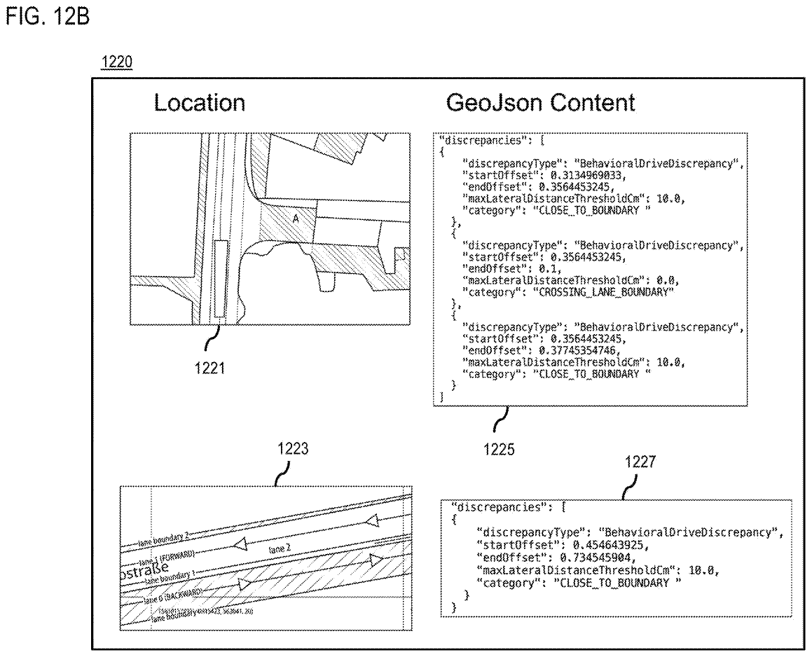

FIG. 12A is a diagram of an example 1200 of determining a behavior layer vehicle path is outside or close to a road boundary (Lane Group), according to one example embodiment. FIG. 11 presents two example cases:

### (1) HBvR BL-VP Outside Road Boundary (LG):

Context: This case describes the scenario where the vehicle path geometry is checked against the outer lateral edges of map-matched Lane Group polygons, with these edges being treated as the effective “Road Boundaries.”

Inputs: Vehicle Paths and Lane Group Polygons.

Processing Goal: To identify segments where the vehicle path goes outside these derived road boundaries. This corresponds to the logic paths in the flowcharts that identify intersections or lack of coverage, potentially leading to the creation of an “Outside LgBoundaryPolygon deviation” record.

Output: The result is described as a “Vehicle Path (Fleet) Attribute with Outside Road Boundary Discrepancy as Linear Range.” This means the identified deviation is stored as an attribute associated with the vehicle path, marking the specific start and end offsets (linear range) where the “Outside” condition occurred.

Visualization/GeoJson: The figure includes a sample map visualization (e.g., visualizations 1201 and 1203) and corresponding GeoJson data illustrating detected discrepancies (e.g., JSON data objects 1205 and 1207). Notably, the sample GeoJson for this case shows records with the category “OUTSIDE_ROAD_BOUNDARY” but also “CLOSE_TO_BOUNDARY”, indicating the underlying process might detect and report both types even when focusing on the “Outside” condition definitionally.

### (2) HBvR BL-VP Close to Road Boundary (LG):

Context: This case uses the same setup-vehicle paths checked against road boundaries derived from Lane Group outer edges.

Inputs: Vehicle Paths and Lane Group Polygons.

Processing Goal: To identify segments where the vehicle path comes within a predefined proximity threshold (e.g., 100 centimeters, as discussed in the flowchart context) of the derived road boundaries, without necessarily going completely outside. This corresponds to the logic paths involving R-tree proximity searches leading to the creation of a “CloseTo LgBoundaryPolygon deviation” record.

Output: The result is a “Vehicle Path (Fleet) Attribute with Close To Road Boundary Discrepancy as Linear Range,” marking the specific start and end offsets where the path was closer to the boundary than the allowed threshold.

Visualization/GeoJson: The figure again provides a sample visualization and GeoJson data for this case, showing discrepancy records with the category “CLOSE_TO_BOUNDARY”.

In summary, FIG. 12A clarifies the nature of the “Outside” and “CloseTo” discrepancies specifically when analyzed against boundaries derived from map-based Lane Groups, illustrating the inputs, the conditions checked (as detailed in the corresponding flowcharts), and the format of the output (linear ranges along the path stored as attributes, represented visually and in GeoJson). It confirms that the analysis identifies ranges where the path either crosses/is outside the derived boundaries or violates a minimum distance threshold to those boundaries.

FIG. 12B is a diagram of an example 1220 of determining a behavior layer vehicle path is outside or close to a lane boundary (Lane Group), according to one example embodiment. FIG. 12B presents two example cases:

### (1) Algorithm Result: Crossing Lane Boundary

Context: This case involves checking vehicle path geometries against the “internal lanes lateral boundaries” obtained from map-matched Lane Groups.

Inputs: Vehicle Paths and the derived Lane Group Lanes boundaries.

Processing Goal: To identify points or segments where the vehicle path intersects these internal lane boundaries. This aligns with the flowchart steps that explicitly detect intersections and generate “Crossing LaneMarking” or equivalent deviation records.

Output: The result is a “Vehicle Path (Fleet) Attribute with Crossing Lane Boundaries Discrepancy as Linear Range.” This signifies that the detected crossing events are stored as attributes defining specific ranges (or potentially points, if start/end offsets are identical) along the vehicle path.

Visualization/GeoJson: The figure includes a sample map view (e.g., visualizations 1221 and 1223) and GeoJson data (JSON data objects 1225 and 1227). The GeoJson example shows discrepancy records with the category “CROSSING_LANE_BOUNDARY”, confirming this output type. It also shows “CLOSE_TO_BOUNDARY”, suggesting both types may be reported from the same analysis pipeline.

### (2) Algorithm Result: Close to Lane Boundary

Context: Using the same comparison against “internal lanes lateral boundaries” derived from Lane Groups.

Inputs: Vehicle Paths and the derived Lane Group Lanes boundaries.

Processing Goal: To identify segments where the vehicle path comes within a predefined proximity threshold (e.g., 100 cm) of an internal lane boundary, without necessarily crossing it. This corresponds to the flowchart logic involving R-tree proximity searches resulting in “CloseTo LaneMarking” or equivalent deviation records.

Output: The result is a “Vehicle Path (Fleet) Attribute with Close to Lane Boundaries Discrepancy as Linear Range,” marking the segments where the proximity threshold was violated.

Visualization/GeoJson: The sample visualization and GeoJson data illustrate this case, showing discrepancy records categorized as “CLOSE_TO_BOUNDARY”.

In summary, this figure distinguishes between “Crossing” and “CloseTo” discrepancies when evaluating a vehicle's path specifically against the internal lane boundaries derived from a lane model (Lane Groups), illustrating the inputs, analysis focus, and resulting outputs (categorized linear ranges) consistent with the corresponding processing flowcharts.

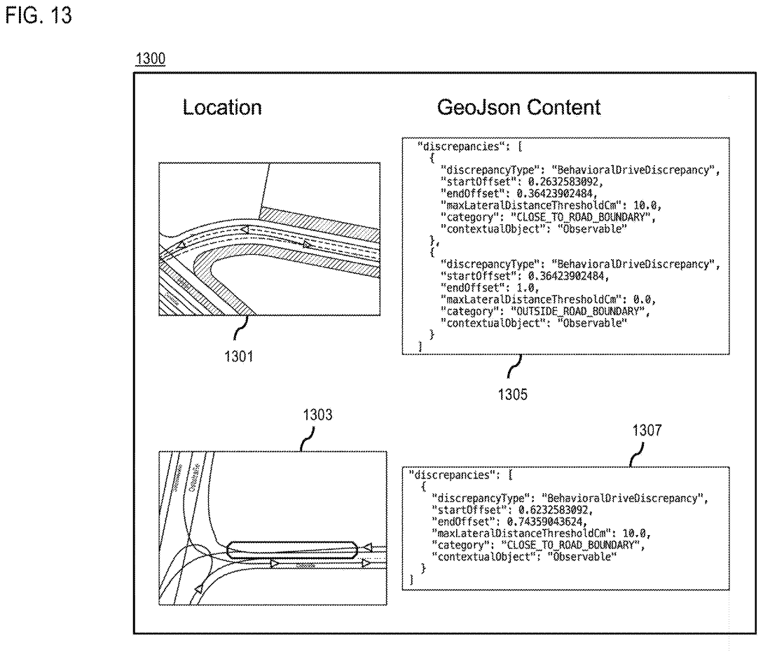

FIG. 13 is a diagram 1300 of an example of determining a deviation against a road boundary observable, according to one example embodiment. FIG. 13 presents illustrative examples for two types of deviations detected when analyzing vehicle path geometry against Road Boundary Linear Observables. These observables, as established in the related flowcharts, represent road boundaries derived from aggregated sensor data (like RSD) rather than from static map features like Lane Groups.

The figure details two primary algorithms or analysis cases:

### (1) Detecting ‘Outside’ Road Boundary (Observable) Discrepancy:

Algorithm Description: The first row describes using “Geometric associations to identify laterally left/right RB [Road Boundary]”. It notes the potential re-use of processing logic (“Re-use linear VPs crossing LGroups Boundary Module for RBs”). This corresponds to the flowchart sections that analyze intersection patterns to determine if the vehicle path is geometrically outside the detected observable road boundary.

Inputs: Vehicle Paths and the specific “Road Boundary Linear Observable” data.

Output: The analysis yields a “Vehicle Path (Fleet) Attribute with Outside Road Boundary Discrepancy as Linear Range.” This signifies that segments where the path was found to be outside the observable boundary are marked with their start and end offsets along the path (e.g., shown in visualizations 1301 and 1303).

Example: The GeoJson Content sample (e.g., JSON data objects 1305 and 1307) confirms this, showing records with category: “OUTSIDE_ROAD_BOUNDARY” and importantly, contextualObject: “Observable”, explicitly linking the deviation to the observable data source.

### (2) Detecting ‘Close To’ Road Boundary (Observable) Discrepancy:

Algorithm Description: The second row uses the same fundamental approach of geometric associations against the observable road boundaries but focuses on proximity. This aligns with the flowchart sections that perform proximity checks using R-trees against the observable boundary points to find where the path comes within a specific threshold (e.g., 100 cm).

Inputs: Vehicle Paths and the “Road Boundary Linear Observable” data.

Output: The result is a “Vehicle Path (Fleet) Attribute with Close to Road Boundary Discrepancy as Linear Range,” marking segments where the path violated the proximity threshold relative to the observable boundary.

Example: The GeoJson Content sample illustrates this, showing records with category: “CLOSE_TO_ROAD_BOUNDARY” and contextualObject: “Observable”.

In summary, FIG. 13 provides concrete examples of the ‘Outside’ and ‘CloseTo’ discrepancy types specifically when the comparison is made against dynamic, observable road boundaries (derived from sources like RSD), as processed by the corresponding flowcharts. It highlights the specific inputs (observable boundaries) and outputs (categorized linear ranges marked as attributes on the vehicle path) for these scenarios.

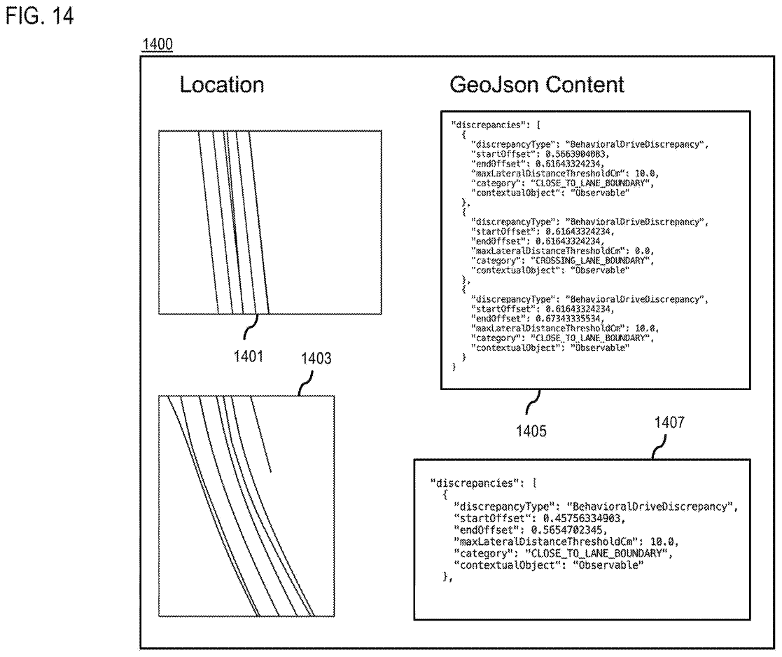

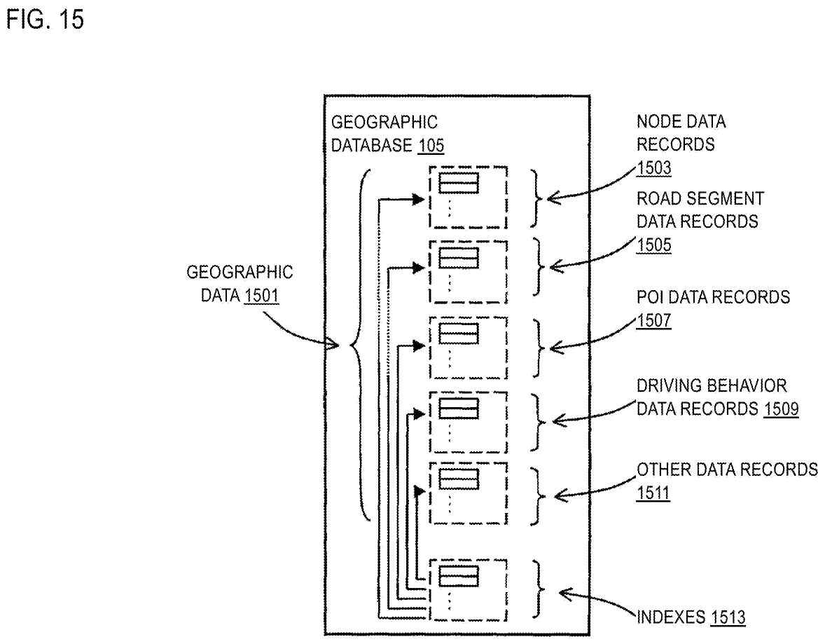

FIG. 14 is a diagram of an example 1400 of determining a deviation against a land marking observable, according to one example embodiment. FIG. 14 presents illustrative examples for two types of deviations detected when analyzing vehicle path geometry against Lane Marking Linear Observables. As established in the related flowcharts, these observables represent lane markings derived from aggregated sensor data (like RSD), distinct from static map-based boundaries or observable road boundaries shown in previous examples.

The figure details two primary analysis cases:

### (1) Detecting ‘Crossing’ Lane Marking (Observable) Discrepancy:

Algorithm Description: The first row describes using “Geometric associations to identify laterally left/right LMs [Lane Markings]”. This corresponds to the flowchart logic that explicitly checks for intersections between the vehicle path and the fetched observable lane markings, generating “Crossing LaneMarking” records. (Note: The description text mentioning “Re-use linear VPs crossing LGroups Boundary Module for RBs” appears inconsistent with the Lane Marking context and the output described, likely needing correction to refer to LMs).

Inputs: Vehicle Paths and the “Lane Marking Linear Observable” data.

Output: The analysis yields a “Vehicle Path (Fleet) Attribute with Crossing Lane Marking Discrepancy as Linear Range.” This indicates that points where the path intersects an observable lane marking are recorded as attributes, potentially defining a point or very small range along the path (e.g., shown in visualizations 1401 and 1403).

Example: The GeoJson Content sample (e.g., JSON data objects 1405 and 1407) supports this, showing records with category: “CROSSING_LANE_BOUNDARY” and contextualObject: “Observable”, linking the crossing to the observable data source.

### (2) Detecting ‘Close To’ Lane Marking (Observable) Discrepancy:

Algorithm Description: The second row uses a similar setup (“Geometric associations to identify laterally left/right LMs”) but focuses on proximity. This aligns with the flowchart sections that perform proximity checks (e.g., distance<100 cm) using R-trees against the observable lane marking points, leading to “CloseTo LaneMarking” deviation records.

Inputs: Vehicle Paths and the “Lane Marking Linear Observable” data.

Output: The result is a “Vehicle Path (Fleet) Attribute with Close to Lane Marking Discrepancy as Linear Range,” marking segments where the path violated the proximity threshold relative to an observable lane marking.

Example: The GeoJson Content sample illustrates this, showing records with category: “CLOSE_TO_LANE_BOUNDARY” and contextualObject: “Observable”.

In summary, FIG. 14 provides concrete examples of the ‘Crossing’ and ‘CloseTo’ discrepancy types specifically when the comparison is made against dynamic, observable lane markings (derived from sources like RSD), as processed by the corresponding flowcharts. It highlights the specific inputs (observable lane markings) and outputs (categorized linear ranges marked as attributes on the vehicle path) for these scenarios.

Returning to FIG. 1, as shown and discussed above, the system 100 includes the mapping platform 107 for providing behavioral discrepancy warnings. In one embodiment, the mapping platform 107 has connectivity or access to one or more databases for storing the lane transition data 109, aggregated driver geometry data 119, and planned maneuver data 121 determined according to the various embodiments described herein, and as well as a geographic database 105 for retrieving mapping data and/or related attributes for map matching (or storing attributes related to the lane transition data 109, aggregated driver geometry data 119, and planned maneuver data 121). In one embodiment, the mapping platform 107 has connectivity over a communication network 117 to the services platform 123 that provides one or more services 125. By way of example, the services 125 may be third-party services that rely on location-based services created or developed based on the lane transition data 109, aggregated driver geometry data 119, and planned maneuver data 121, etc. generated according to the various embodiments described herein. By way of example, the services 125 include, but are not limited to, autonomous/semi-autonomous vehicle operation, mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 125 uses the output of the mapping platform 107.

In one embodiment, the mapping platform 107 may be a platform with multiple interconnected components. The mapping platform 107 may include multiple servers, intelligent networking devices, computing devices, components, and corresponding software for automated detection and/or characterization of road intersections. In addition, it is noted that the mapping platform 107 may be a separate entity of the system 100, a part of the one or more services 125, a part of the services platform 123, or included within the vehicles 101 and/or UEs 113.

In one embodiment, content providers 127 may provide content or data (e.g., including geographic data, vehicle drive data, vehicle path network data, etc.) to the mapping platform 107, the services platform 123, the services 125, and/or the vehicles 101. The content provided may also include any type of content, lane level road topology data, sensor data, map content, textual content, audio content, video content, image content, etc. used for map matching. In one embodiment, the content providers 127 may also store content associated with the mapping platform 107, geographic database 105, services platform 123, services 125, and/or vehicle 101. In another embodiment, the content providers 127 may manage access to a central repository of data, and offer a consistent, standard interface to data, such as a repository of the geographic database 105.

In one optional embodiment, the vehicles 101 and/or UEs 113 are configured with various sensors 115 for generating or collecting sensor observations (e.g., for processing by the mapping platform 107), related geographic data, etc. In one embodiment, the sensed data represents sensor data associated with a geographic location or coordinates at which the sensor data was collected to provide vehicle drive data 111. By way of example, the sensors 115 may include a global positioning sensor for gathering location data (e.g., GNSS/GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road boundaries, road sign information, images of road obstructions, etc. for analysis), LiDAR, radar, an audio recorder for gathering audio data, velocity sensors mounted on steering wheels of the vehicles, switch sensors for determining whether one or more vehicle switches are engaged, and the like.

In another optional embodiment, the communication network 117 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), 5G New Radio Networks, Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 107, services platform 123, services 125, vehicle 101, UE 113, and/or content providers 127 optionally communicate with each other and other components of the system 100 using well known, new or still developing protocols. In this context, a protocol includes a set of rules defining how the network nodes within the communication network 117 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

FIG. 10 is a diagram of the geographic database 105, according to one embodiment. In one embodiment, the geographic database 105 includes geographic data 1001 used for (or configured to be compiled to be used for) mapping and/or navigation-related services, such as for video odometry based on the parametric representation of signs include, e.g., encoding and/or decoding parametric representations into object models of signs. In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 105.
“Node”—A point that terminates a link.
“Line segment”—A straight line connecting two points.
“Link” (or “edge”)—A contiguous, non-branching string of one or more line segments terminating in a node at each end.
“Shape point”—A point along a link between two nodes (e.g., used to alter a shape of the link without defining new nodes).
“Oriented link”—A link that has a starting node (referred to as the “reference node”) and an ending node (referred to as the “non reference node”).
“Simple polygon”—An interior area of an outer boundary formed by a string of oriented links that begins and ends in one node. In one embodiment, a simple polygon does not cross itself.
“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 105 follows certain conventions. For example, links do not cross themselves and do not cross each other except at a node. Also, there are no duplicated shape points, nodes, or links. Two links that connect each other have a common node. In the geographic database 105, overlapping geographic features are represented by overlapping polygons. When polygons overlap, the boundary of one polygon crosses the boundary of the other polygon. In the geographic database 105, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 105 includes node data records 1003, road segment or link data records 1005, POI data records 1007, stop data records 1009, other records 1011, and indexes 1013, for example. More, fewer, or different data records can be provided. In one embodiment, additional data records (not shown) can include cartographic (“carto”) data records, routing data, and maneuver data. In one embodiment, the indexes 1013 may improve the speed of data retrieval operations in the geographic database 105. In one embodiment, the indexes 1013 may be used to quickly locate data without having to search every row in the geographic database 105 every time it is accessed. For example, in one embodiment, the indexes 1013 can be a spatial index of the polygon points associated with stored feature polygons.

In exemplary embodiments, the road segment data records 1005 are links or segments representing roads, streets, or paths, as can be used in the calculated route or recorded route information for determination of one or more personalized routes. The node data records 1003 are end points (such as intersections) corresponding to the respective links or segments of the road segment data records 1005. The road link data records 1005 and the node data records 1003 represent a road network, such as used by vehicles, cars, and/or other entities. Alternatively, the geographic database 105 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 105 can include data about the POIs and their respective locations in the POI data records 1007. The geographic database 105 can also include data about places, such as cities, towns, or other communities, and other geographic features, such as bodies of water, mountain ranges, etc. Such place or feature data can be part of the POI data records 1007 or can be associated with POIs or POI data records 1007 (such as a data point used for displaying or representing a position of a city).

In one embodiment, the geographic database 105 can also include lane transition records 1009 for storing lane transition data 109, vehicle drive data 111, aggregated drive geometry data 119, planned maneuver data 121, and/or any related data generated or used according to the various embodiments described herein. In one embodiment, the lane transition data records 1009 can be associated with one or more of the node records 1003, road segment records 1005, and/or POI data records 1007 to associate the map matching results 119 with specific geographic locations. In this way, the map matching results 119 can also be associated with the characteristics or metadata of the corresponding records 1003, 1005, and/or 1007.

In one embodiment, the geographic database 105 can be maintained by the content provider 127 in association with the mapping platform 107 and/or services platform 123 (e.g., a map developer). The map developer can collect geographic data to generate and enhance the geographic database 105. There can be different ways used by the map developer to collect data. These ways can include obtaining data from other sources, such as municipalities or respective geographic authorities. In addition, the map developer can employ field personnel to travel by vehicle (e.g., vehicle) along roads throughout the geographic region to observe features and/or record information about them, for example. Also, remote sensing, such as aerial or satellite photography, can be used.

The geographic database 105 can be a master geographic database stored in a format that facilitates updating, maintenance, and development. For example, the master geographic database or data in the master geographic database can be in an Oracle spatial format or other spatial format, such as for development or production purposes. Map layers may be utilized. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing behavioral discrepancy warning may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular device, other network device, and/or other computing device.

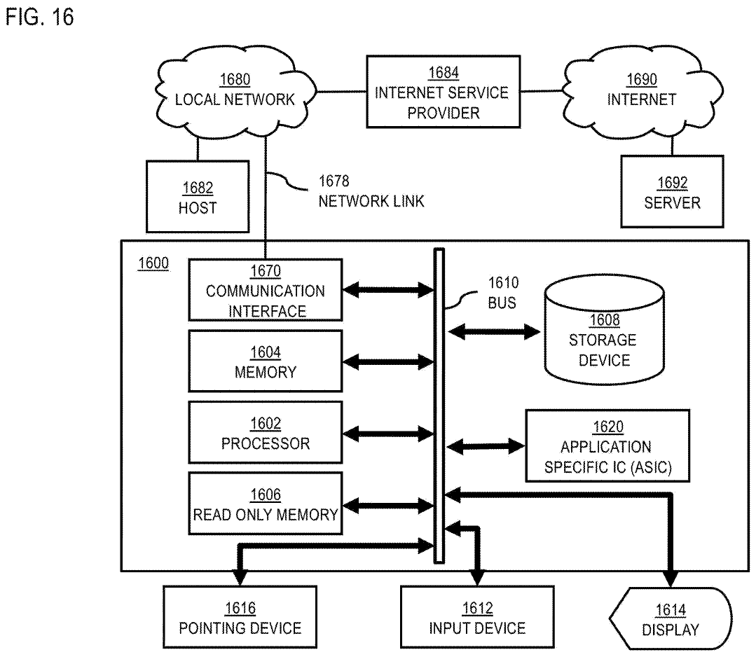

FIG. 16 illustrates a computer system 1600 upon which an embodiment of the invention may be implemented. Computer system 1600 is programmed (e.g., via computer program code or instructions) to provide behavioral discrepancy warning as described herein and includes a communication mechanism such as a bus 1610 for passing information between other internal and external components of the computer system 1600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1610 includes one or more parallel conductors of information so that information is transferred quickly among devices coupled to the bus 1610. One or more processors 1602 for processing information are coupled with the bus 1610.

A processor 1602 performs a set of operations on information as specified by computer program code related to providing behavioral discrepancy warning. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1610 and placing information on the bus 1610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1600 also includes a memory 1604 coupled to bus 1610. The memory 1604, such as a random access memory (RAM) or other dynamic storage device, stores information including processor instructions for providing behavioral discrepancy warning. Dynamic memory allows information stored therein to be changed by the computer system 1600. RAM allows a unit of information stored at a location called a memory address to be stored and retrieved independently of information at neighboring addresses. The memory 1604 is also used by the processor 1602 to store temporary values during execution of processor instructions. The computer system 1600 also includes a read only memory (ROM) 1606 or other static storage device coupled to the bus 1610 for storing static information, including instructions, that is not changed by the computer system 1600. Some memory is composed of volatile storage that loses the information stored thereon when power is lost. Also coupled to bus 1610 is a non-volatile (persistent) storage device 1608, such as a magnetic disk, optical disk or flash card, for storing information, including instructions, that persists even when the computer system 1600 is turned off or otherwise loses power.

Information, including instructions for providing behavioral discrepancy warning, is provided to the bus 1610 for use by the processor from an external input device 1612, such as a keyboard containing alphanumeric keys operated by a human user, or a sensor. A sensor detects conditions in its vicinity and transforms those detections into physical expression compatible with the measurable phenomenon used to represent information in computer system 1600. Other external devices coupled to bus 1610, used primarily for interacting with humans, include a display device 1614, such as a cathode ray tube (CRT) or a liquid crystal display (LCD), or plasma screen or printer for presenting text or images, and a pointing device 1616, such as a mouse or a trackball or cursor direction keys, or motion sensor, for controlling a position of a small cursor image presented on the display 1614 and issuing commands associated with graphical elements presented on the display 1614. In some embodiments, for example, in embodiments in which the computer system 1600 performs all functions automatically without human input, one or more of external input device 1612, display device 1614 and pointing device 1616 is omitted.

In the illustrated embodiment, special purpose hardware, such as an application specific integrated circuit (ASIC) 1620, is coupled to bus 1610. The special purpose hardware is configured to perform operations not performed by processor 1602 quickly enough for special purposes. Examples of application specific ICs include graphics accelerator cards for generating images for display 1614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1600 also includes one or more instances of a communications interface 1670 coupled to bus 1610. Communication interface 1670 provides a one-way or two-way communication coupling to a variety of external devices that operate with their own processors, such as printers, scanners and external disks. In general the coupling is with a network link 1678 that is connected to a local network 1680 to which a variety of external devices with their own processors are connected. For example, communication interface 1670 may be a parallel port or a serial port or a universal serial bus (USB) port on a personal computer. In some embodiments, communications interface 1670 is an integrated services digital network (ISDN) card or a digital subscriber line (DSL) card or a telephone modem that provides an information communication connection to a corresponding type of telephone line. In some embodiments, a communication interface 1670 is a cable modem that converts signals on bus 1610 into signals for a communication connection over a coaxial cable or into optical signals for a communication connection over a fiber optic cable. As another example, communications interface 1670 may be a local area network (LAN) card to provide a data communication connection to a compatible LAN, such as Ethernet. Wireless links may also be implemented. For wireless links, the communications interface 1670 sends or receives or both sends and receives electrical, acoustic or electromagnetic signals, including infrared and optical signals, that carry information streams, such as digital data. For example, in wireless handheld devices, such as mobile telephones like cell phones, the communications interface 1670 includes a radio band electromagnetic transmitter and receiver called a radio transceiver. In certain embodiments, the communications interface 1670 enables connection to the communication network 117 for providing behavioral discrepancy warning.

The term computer-readable medium is used herein to refer to any medium that participates in providing information to processor 1602, including instructions for execution. Such a medium may take many forms, including, but not limited to, non-volatile media, volatile media and transmission media. Non-volatile media include, for example, optical or magnetic disks, such as storage device 1608. Volatile media include, for example, dynamic memory 1604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1678 typically provides information communication using transmission media through one or more networks to other devices that use or process the information. For example, network link 1678 may provide a connection through local network 1680 to a host computer 1682 or to equipment 1684 operated by an Internet Service Provider (ISP). ISP equipment 1684 in turn provides data communication services through the public, world-wide packet-switching communication network of networks now commonly referred to as the Internet 1690.

A computer called a server host 1692 connected to the Internet hosts a process that provides a service in response to information received over the Internet. For example, server host 1692 hosts a process that provides information representing video data for presentation at display 1614. It is contemplated that the components of system can be deployed in various configurations within other computer systems, e.g., host 1682 and server 1692.

FIG. 17 illustrates a chip set 1700 upon which an embodiment of the invention may be implemented. Chip set 1700 is programmed to provide behavioral discrepancy warning as described herein and includes, for instance, the processor and memory components described with respect to FIG. 16 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1700 includes a communication mechanism such as a bus 1701 for passing information among the components of the chip set 1700. A processor 1703 has connectivity to the bus 1701 to execute instructions and process information stored in, for example, a memory 1705. The processor 1703 may include one or more processing cores with each core configured to perform independently. A multi-core processor enables multiprocessing within a single physical package. Examples of a multi-core processor include two, four, eight, or greater numbers of processing cores. Alternatively or in addition, the processor 1703 may include one or more microprocessors configured in tandem via the bus 1701 to enable independent execution of instructions, pipelining, and multithreading. The processor 1703 may also be accompanied with one or more specialized components to perform certain processing functions and tasks such as one or more digital signal processors (DSP) 1707, or one or more application-specific integrated circuits (ASIC) 1709. A DSP 1707 typically is configured to process real-world signals (e.g., sound) in real time independently of the processor 1703. Similarly, an ASIC 1709 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1703 and accompanying components have connectivity to the memory 1705 via the bus 1701. The memory 1705 includes both dynamic memory (e.g., RAM, magnetic disk, writable optical disk, etc.) and static memory (e.g., ROM, CD-ROM, etc.) for storing executable instructions that when executed perform the inventive steps described herein to provide behavioral discrepancy warning. The memory 1705 also stores the data associated with or generated by the execution of the inventive steps.

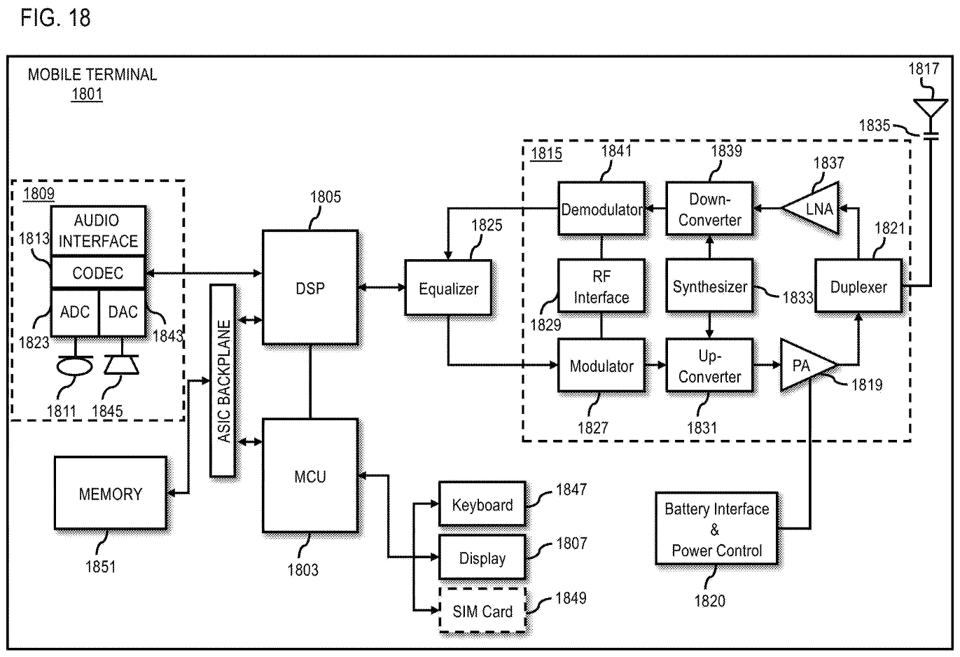

FIG. 18 is a diagram of exemplary components of a mobile terminal (e.g., vehicle, user device, and/or component thereof) capable of operating in the system of FIG. 1, according to one embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 1803, a Digital Signal Processor (DSP) 1805, and a receiver/transmitter unit including a microphone gain control unit and a speaker gain control unit. A main display unit 1807 provides a display to the user in support of various applications and mobile station functions that offer automatic contact matching. An audio function circuitry 1809 includes a microphone 1811 and microphone amplifier that amplifies the speech signal output from the microphone 1811. The amplified speech signal output from the microphone 1811 is fed to a coder/decoder (CODEC) 1813.

A radio section 1815 amplifies power and converts frequency in order to communicate with a base station, which is included in a mobile communication system, via antenna 1817. The power amplifier (PA) 1819 and the transmitter/modulation circuitry are operationally responsive to the MCU 1803, with an output from the PA 1819 coupled to the duplexer 1821 or circulator or antenna switch, as known in the art. The PA 1819 also couples to a battery interface and power control unit 1820.

In use, a user of mobile station 1801 speaks into the microphone 1811 and his or her voice along with any detected background noise is converted into an analog voltage. The analog voltage is then converted into a digital signal through the Analog to Digital Converter (ADC) 1823. The control unit 1803 routes the digital signal into the DSP 1805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1825 for compensation of any frequency-dependent impairments that occur during transmission though the air such as phase and amplitude distortion. After equalizing the bit stream, the modulator 1827 combines the signal with a RF signal generated in the RF interface 1829. The modulator 1827 generates a sine wave by way of frequency or phase modulation. In order to prepare the signal for transmission, an up-converter 1831 combines the sine wave output from the modulator 1827 with another sine wave generated by a synthesizer 1833 to achieve the desired frequency of transmission. The signal is then sent through a PA 1819 to increase the signal to an appropriate power level. In practical systems, the PA 1819 acts as a variable gain amplifier whose gain is controlled by the DSP 1805 from information received from a network base station. The signal is then filtered within the duplexer 1821 and optionally sent to an antenna coupler 1835 to match impedances to provide maximum power transfer. Finally, the signal is transmitted via antenna 1817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1801 are received via antenna 1817 and immediately amplified by a low noise amplifier (LNA) 1837. A down-converter 1839 lowers the carrier frequency while the demodulator 1841 strips away the RF leaving only a digital bit stream. The signal then goes through the equalizer 1825 and is processed by the DSP 1805. A Digital to Analog Converter (DAC) 1843 converts the signal and the resulting output is transmitted to the user through the speaker 1845, all under control of a Main Control Unit (MCU) 1803—which can be implemented as a Central Processing Unit (CPU) (not shown).

The MCU 1803 receives various signals including input signals from the keyboard 1847. The keyboard 1847 and/or the MCU 1803 in combination with other user input components (e.g., the microphone 1811) comprise a user interface circuitry for managing user input. The MCU 1803 runs a user interface software to facilitate user control of at least some functions of the mobile station 1801 to provide behavioral discrepancy warning. The MCU 1803 also delivers a display command and a switch command to the display 1807 and to the speech output switching controller, respectively. Further, the MCU 1803 exchanges information with the DSP 1805 and can access an optionally incorporated SIM card 1849 and a memory 1851. In addition, the MCU 1803 executes various control functions required of the station. The DSP 1805 may, depending upon the implementation, perform any of a variety of conventional digital processing functions on the voice signals. Additionally, DSP 1805 determines the background noise level of the local environment from the signals detected by microphone 1811 and sets the gain of microphone 1811 to a level selected to compensate for the natural tendency of the user of the mobile station 1801.

The CODEC 1813 includes the ADC 1823 and DAC 1843. The memory 1851 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1851 may be, but not limited to, a single memory, CD, DVD, ROM, RAM, EEPROM, optical storage, or any other non-volatile or non-transitory storage medium capable of storing digital data.

An optionally incorporated SIM card 1849 carries, for instance, important information, such as the cellular phone number, the carrier supplying service, subscription details, and security information. The SIM card 1849 serves primarily to identify the mobile station 1801 on a radio network. The card 1849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method comprising:
determining, for a given area, behavioral data representing aggregated driving behavior in the given area;
determining, for the given area, map data comprising one or more map objects and one or more driving constraints, permissions, conditions, or requirements associated with the one or more map objects;
detecting, based on a comparison between the behavioral data and the map data, a behavior discrepancy between the aggregated driving behavior and the one or more driving constraints, permissions, conditions, or requirements; and
generating a behavior discrepancy warning indicating the detected behavior discrepancy.

2. The method of claim 1, wherein the behavioral data comprises at least one of a behavioral drive path, a behavioral transition, a behavioral speed profile, or a behavioral stopping area.

3. The method of claim 1, wherein determining the behavioral data comprises aggregating vehicle drive data from a plurality of vehicles, the vehicle drive data comprising at least one of vehicle-path data, speed data, lane-transition data, or stopping-location data.

4. The method of claim 1, further comprising performing a relational check for at least one of a vehicle drive path, a speed profile, a stopping location, or one or more maneuvers against one or more infrastructure elements, one or more averaged behaviors, or a combination thereof.

5. The method of claim 1, wherein the behavior discrepancy is based on determining that the behavioral data indicates that a behavioral drive speed exceeds a speed limit indicated in the map data.

6. The method of claim 1, wherein the behavior discrepancy is based on determining that the behavioral data indicates a vehicle drive path that is within a proximity threshold to, or outside of, one or more of the map objects represented in the map data.

7. The method of claim 6, wherein the one or more map objects comprise a road boundary or a lane marking.

8. The method of claim 1, wherein the behavior discrepancy is based on determining that the behavioral data indicates a driving maneuver that is prohibited by the driving constraints, permissions, conditions, or requirements associated with the one or more map objects, the driving maneuver comprising at least one of a restricted turn or travel on a restricted-access road segment.

9. The method of claim 1, wherein the behavior discrepancy is based on determining that the behavioral data indicates a stopping location inconsistent with at least one of a stop line, a crosswalk, a traffic signal, a traffic sign, or intersection information represented in the map data.

10. The method of claim 1, wherein the behavior discrepancy is based on determining that the behavioral data indicates a lane transition inconsistent with at least one of a lane transition status, a lane-boundary marking style, a lane boundary, or an intersection attribute represented in the map data.

11. The method of claim 1, wherein the behavior discrepancy is based on determining that the behavioral data indicates a behavioral speed that exceeds a conditional speed limit applicable to the given area.

12. The method of claim 1, wherein the behavior discrepancy warning indicates that the behavioral data is obsolete based on at least one of an ongoing construction condition or an incoming change associated with the given area.

13. The method of claim 1, wherein generating the behavior discrepancy warning comprises storing or publishing a discrepancy attribute associated with at least one of a road segment, a lane, a lane group, or a linear range of a vehicle path.

14. The method of claim 13, wherein the discrepancy attribute identifies a start offset and an end offset of the linear range of the vehicle path associated with the detected behavior discrepancy.

15. The method of claim 1, further comprising:
precomputing the behavior discrepancy warning at a backend mapping platform; and
providing the behavior discrepancy warning to a planning module or control module for controlling operation of an autonomous vehicle,
wherein controlling the operation of the autonomous vehicle comprises at least one of selecting a level of autonomous driving, requesting a driver take manual control, or activating or deactivating a self-driving function.

16. The method of claim 1, further comprising:
generating routing data for a vehicle based on the behavior discrepancy warning,
wherein the routing data directs the vehicle to avoid the given area associated with the behavior discrepancy warning.

17. An apparatus comprising:
at least one processor; and
at least one memory including computer program code for one or more programs,
the at least one memory and the computer program code configured to, with the at least one processor, cause the apparatus to:
determine, for a given area, behavioral data representing aggregated driving behavior in the given area;
determine, for the given area, map data comprising one or more map objects and one or more driving constraints, permissions, conditions, or requirements associated with the one or more map objects;
detect, based on a comparison between the behavioral data and the map data, a behavior discrepancy between the aggregated driving behavior and the one or more driving constraints, permissions, conditions, or requirements; and
generate a behavior discrepancy warning indicating the detected behavior discrepancy.

18. The apparatus of claim 17, wherein the behavioral data comprises at least one of a behavioral drive path, a behavioral transition, a behavioral speed profile, or a behavioral stopping area.

19. A non-transitory computer-readable storage medium, carrying one or more sequences of one or more instructions which, when executed by one or more processors, cause an apparatus to perform:
determining, for a given area, behavioral data representing aggregated driving behavior in the given area;
determining, for the given area, map data comprising one or more map objects and one or more driving constraints, permissions, conditions, or requirements associated with the one or more map objects;
detecting, based on a comparison between the behavioral data and the map data, a behavior discrepancy between the aggregated driving behavior and the one or more driving constraints, permissions, conditions, or requirements; and
generating a behavior discrepancy warning indicating the detected behavior discrepancy.

20. The non-transitory computer-readable storage medium of claim 1, wherein the behavioral data comprises at least one of a behavioral drive path, a behavioral transition, a behavioral speed profile, or a behavioral stopping area.
